(19) United States
(12) Patent Application Publication
(10) Pub. No.: US 2024/0342803 A1
(43) Pub. Date: Oct. 17, 2024

(54) Build Module Associated Mechanisms and Their Use

(71) Applicant: Velo3D, Inc., Fremont, CA (US)

(72) Inventors: Pheng SIN, Livermore, CA (US); Alexander Vladimirovich VARLAKHANOV, San Carlos, CA (US); Leonard John SHARPLESS, Union City, CA (US); Gregory Adam TOLAND, San Jose, CA (US); Benyamin BULLER, Cupertino, CA (US)

(21) Appl. No.: 18/601,885

(22) Filed: Mar. 11, 2024

Related U.S. Application Data
(60) Provisional application No. 63/456,362, filed on Mar. 31, 2023.

(51) Int. Cl. B22F 12/00; B22F 10/73; B33Y 30/00; B33Y 40/00

(52) U.S. Cl. CPC B22F 12/38; B33Y 30/00; B33Y 40/00; B22F 10/73

(57) ABSTRACT

The present disclosure provides a lid assembly, a maneuvering mechanism for the lid assembly, and a casing configured facilitate storing the lid assembly and the maneuvering mechanism, e.g., in a chamber having an isolated environment. The maneuvering mechanism may facilitate maneuvering the lid assembly in the isolated environment. The lid assembly may be configured to maintain in a build module an isolated environment. The present disclosure provides systems, devices, apparatuses, methods, and non-transitory computer readable media, associated with the lid assembly, the maneuvering mechanism, the casing, and with three dimensional printing.

### PRIORITY APPLICATIONS

This application claims priority to U.S. Provisional Patent Application Ser. No. 63/456,362 filed Mar. 31, 2023, which is incorporated herein by reference in its entirety.

### BACKGROUND

Three-dimensional (3D) printing (e.g., additive manufacturing) is a process for making a three-dimensional object of any shape from a design. The design may be in the form of a data source such as an electronic data source or maybe in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, an allotrope of elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material until the entire designed three-dimensional structure (3D object) is layer-wise materialized.

3D models may be created with a computer aided design package, via a 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften the material to produce the layers that form the 3D object. Examples of 3D printing methods include selective laser melting (SLM), selective laser sintering (SLS), direct metal laser sintering (DMLS), or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

3D printing entails transforming pre-transformed material (e.g., starting material) to a transformed material. At times, pre-transformed material can violently react (e.g., ignite, flame, and/or combust), when exposed to an atmosphere comprising the reactive agent, e.g., an ambient atmosphere comprising oxygen or water. A build module containing the printed 3D object(s) may contain the pre-transformed material as a starting material for the 3D printing or as a remainder of the starting material remaining from the 3D printing. At times, it may be advantageous to store the build module, e.g., to allow it to cool down. At times, it may be advantageous to store stationarily or transport a build module for unpacking in a location different from a processing chamber of a 3D printing system, e.g., from a remainder of the starting material used to print 3D object(s) enclosed in the build module. At times, the remainder material and/or the 3D object(s) are reactive with a reactive agent present in the ambient atmosphere, e.g., in sufficient concentration. Such reaction may be harmful to a user, to the remainder material and/or to the 3D object(s). In such circumstances, it may be advantageous to isolate the interior of the build module before disengaging from the processing chamber, e.g., with a lid assembly. It may be convenient and/or safe, to store the lid in the environment of the processing chamber, e.g., white occupying minimum space in the processing chamber.

### SUMMARY

In some aspects, the present disclosure resolves the aforementioned hardships. For example, the lid assembly may be stored vertically in the environment of the processing chamber. For example, the lid assembly may be maneuverable from a vertical position to a horizontal position during its use. For example, the lid assembly may be stored in a casing. The casing may be a cavity in a (e.g., vertical) wall of the processing chamber. The cavity may be operatively coupled with the processing chamber. An opening of the cavity may remain open with respect to the processing chamber interior space, e.g., during storage and/or during the use of the lid assembly. The casing may be configured for the internal environment of the processing chamber, e.g., to the atmospheric conditions of the processing chamber such as before, during and/or after the 3D printing. The processing chamber may be equipped with portal(s) that allows a user to maneuver components in the interior space of the processing chamber (i) without exposing the user to the interior space environment and (ii) without exposing an interior space of the processing chamber to the ambient environment external to the processing chamber, the user being disposed of in the ambient environment.

In another aspect, a device for closing an opening of a build module, the device comprises: a lid base plate; a locking plate configured to at least partially rotate with respect to the lid base plate; and a central receptacle coupled with the locking plate, the central receptacle being configured to (a) reversibly engage with, and disengage from, a rotating tool for pivoting the locking plate with respect to the lid base plate, (b) reversibly engage with, and disengage from, a maneuvering mechanism, or (c) a combination of (a) and (b), the device being a lid assembly. In some embodiments, the build module comprises an interior space configured to accommodate a build platform supporting one or more three-dimensional objects. In some embodiments, the build module is configured to allow vertical translation of the build platform during three-dimensional printing of the one or more three-dimensional objects. In some embodiments, the build module comprises a floor, the opening being surrounded by one or more vertical walls of the build module extending from the opening at least to the floor surrounded by the one or more vertical walls, the opening opposing the floor. In some embodiments, the locking plate comprises, or is operatively coupled with, engagers configured to engage with the build module to close the opening of the build module. In some embodiments, the engagers are disposed on a locking ring coupled with the locking plate, the device comprising the locking ring. In some embodiments, the lid assembly is configured to seal the opening of the build module that comprises engager receptacles disposed at locations respective to the engagers of the lid assembly such that on closing the opening of build module by the lid assembly, the engagers each configured to engage with each of the engager receptacles. In some embodiments, to seal the build module, the lid assembly is configured to pivot along an uneven track of the engager receptacle. In some embodiments, pivoting of an engager of the engagers is directed by a guiding post engaged with a distal opening, the distal opening disposed closer to a circumference of the locking plate relative to the central receptacle, the guiding post extending from the lid base plate, into the distal hole, and past the distal hole. In some embodiments, pivoting the locking plate is relative to the lid base plate and relative to the guiding post. In some embodiments, each of the engagers is aligned (i) with the central receptacle, and (ii) with each distal openings comprising the distal opening. In some embodiments, the locking plate comprises skeletal rods, each skeletal rod of the skeletal rods extending from the distal opening to the central receptacle. In some embodiments, each of the distal openings is engaged with each of guiding posts comprising the guiding post. In some embodiments, to seal the build module, the lid assembly is configured to pivot along the uneven track at least in part by being configured to pivot a component comprising the engager or another protrusion from the lid assembly. In some embodiments, to seal the build module, the lid assembly is configured to pivot along an uneven track of the engager receptacle comprising a step or a ramp. In some embodiments, the uneven track comprises an uneven floor of the engager receptacle. In some embodiments, the engagement of the engagers each engaged with each of the engager receptacles is such that (i) vertical motion of the lid assembly relative to the build module is deterred and/or (ii) the lid assembly shuts the opening to control an internal environment of the build module. In some embodiments, the lid assembly is configured to shut the opening of the build module at least in part by pivoting the engagers with respect to the engager receptacles. In some embodiments, the lid assembly is configured to pivot the engagers at least in part by engaging the rotating tool with the central receptacle of the lid assembly. In some embodiments, the lid assembly is configured to shut the opening of the build module at least in part by altering a morphology of a seal comprised in the lid assembly, the seal being disposed between the locking plate and the lid base plate. In some embodiments, the lid assembly is configured to cause reversible alteration of the morphology of the seal. In some embodiments, the lid assembly is configured to cause reversible alteration of the morphology of the seal at least in part by pivoting the engagers with respect to the engager receptacles. In some embodiments, the lid assembly is configured to cause reversible alteration of the morphology of the seal at least in part by pivoting the engagers with respect to the engager receptacles to reduce a distance between the locking plate and the lid base plate. In some embodiments, the lid assembly is configured to cause reversible alteration in morphology of the seal at least in part by being configured (i) to cause compression of a portion of the seal, and (ii) to cause release of the compression of the portion of the seal. In some embodiments, the lid assembly is configured to cause reversible alteration in morphology of the seal at least in part by being configured (i) to cause expansion of the seal in a first direction and (ii) to cause contraction of the seal a second direction. In some embodiments, the lid assembly is configured to cause reversible alteration in morphology of the seal (i) to cause the seal to press onto the build module, and (ii) to cause the seal to release compression of the seal from the build module. In some embodiments, the seal is gas tight. In some embodiments, the seal is a hermetic seal. In some embodiments, the seal is configured to facilitate retaining an internal atmosphere in the build module closed by the lid assembly for a time period, the internal atmosphere being different from an ambient atmosphere external to the build module. In some embodiments, the time period is at least a same or greater value than a time period to unpack the three-dimensional objects from the build module. In some embodiments, the seal is configured to facilitate retaining for a time period (i) a positive pressure within the build module body relative to an ambient atmosphere external to the device, (ii) a reactive agent at a concentration lower than its concentration in an ambient atmosphere external to the build module, the reactive agent being configured to at least react with pre-transformed material of the three-dimensional printing during the three-dimensional printing, or (iii) a combination of (i) and (ii). In some embodiments, the time period is at least a same or greater value than a time period to unpack the three-dimensional objects from the build module. In some embodiments, (I) the lid base plate has a circular cross section, and/or the locking plate has a circular cross section. In some embodiments, the lid assembly is configured to reversibly couple with, and decouple from, the maneuvering mechanism, at least in part by using a connector, the maneuvering mechanism (i) comprising the connector or (ii) being operatively coupled with the connector. In some embodiments, the connector can reversibly alter its configuration to couple and to decouple the lid assembly and the maneuvering mechanism. In some embodiments, the connector can reversibly alter its configuration at least in part by being configured to (I) pivot in a first direction and in a second direction opposing the first direction and/or (II) compress in a third direction and release in a fourth direction opposing the first direction. In some embodiments, the connector comprises a pin, balls, or a spring. In some embodiments, the connector can reversibly alter its configuration at least in part by being configured to (i) latch to the lid assembly and (ii) be released from the lid assembly. In some embodiments, the lid assembly is configured to reversibly couple with the maneuvering mechanism at least in part by the lid assembly being configured to (i) engage with the connector and (ii) disengage from the connector. In some embodiments, the lid assembly comprises a protective cover for the central receptacle. In some embodiments, the protective cover is configured to protect the central receptacle from entrance of substances into the lid assembly, the substances associate with three-dimensional printing of one or more three-dimensional objects. In some embodiments, the protective cover is configured to protect the central receptacle from entrance of substances comprising debris or pre-transformed material. In some embodiments, the debris comprises soot, splatter, or spatter. In some embodiments, the pre-transformed material comprises powder. In some embodiments, the pre-transformed material comprises elemental metal, metal alloy, ceramic, or an allotrope of elemental carbon. In some embodiments, the pre-transformed material comprises a polymer or a resin. In some embodiments, the soot comprises elemental metal, metal alloy, ceramic, or an allotrope of elemental carbon. In some embodiments, the pre-transformed material comprises a polymer or a resin. In some embodiments, the pre-transformed comprises a starting material for a three-dimensional printing, or a remainder material of the three-dimensional printing. In some embodiments, the lid assembly is configured to close the opening of the build module in an internal environment of an enclosure, the internal environment being different from an ambient environment external to the enclosure the internal environment being different from an ambient environment by at least one environmental characteristic. In some embodiments, the at least one environmental characteristic comprises pressure, gas flow direction, gas velocity, gas composition, level of reactive agent, temperature, or gas borne debris. In some embodiments, the pressure is a positive pressure with respect to an ambient pressure of the ambient environment. In some embodiments, the temperature is an elevated temperature with respect to an ambient temperature in the ambient environment. In some embodiments, the gas velocity is an elevated gas velocity with respect to an ambient gas velocity in the ambient environment. In some embodiments, the gas composition comprises a higher level of inert gas as compared to the ambient level of the inert gas in the ambient environment. In some embodiments, the level of gas borne debris is higher in the internal environment as compared to the ambient environment. In some embodiments, the level of reactive agent is lower in the internal environment as compared to the ambient environment. In some embodiments, the reactive agent comprises oxygen or humidity. In some embodiments, the lid assembly is configured to be maneuvered by the maneuvering mechanism to close the opening of the build module in an internal environment of an enclosure. In some embodiments, the enclosure comprises a processing chamber or an unpacking chamber. In some embodiments, the enclosure is associated with three-dimensional printing. In some embodiments, the lid assembly is configured to be maneuvered by the maneuvering mechanism to close the opening at least in part by a user. In some embodiments, the build module is configured to enclosure a build platform configured to support a weight of at least about 1000 kilograms (kg). In some embodiments, the build module is configured to facilitate the three-dimensional printing by facilitating vertical translation of the build platform comprising an error in vertical positioning of the vertical translation at most about 10%, 5%, or 2% of the vertical translation of the build platform. In some embodiments, the device is configured to facilitate three-dimensional printing that comprises deposition of pre-transformed material on a target surface. In some embodiments, the target surface comprises (i) an exposed surface of a material bed or (ii) a surface of the build platform. In some embodiments, the device is associated with a three-dimensional printer comprising a remover configured to remove a second portion of the deposited pre-transformed material to generate a planar layer of pre-transformed material as part of a material bed. In some embodiments, the remover is operatively coupled with an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is configured to operatively couple to a three-dimensional printer comprising a recycling system that (i) recycles at least a fraction of a portion of the pre-transformed material removed by the remover and/or (ii) provides at least a portion of the pre-transformed material utilized by the dispenser. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is configured to operatively couple to a three-dimensional printer comprising a layer dispensing mechanism configured to facilitate deposition of pre-transformed material on the target surface at least in part by layerwise deposition. In some embodiments, the layer dispensing mechanism is configured to deposit pre-transformed material comprising powder material. In some embodiments, the layer dispensing mechanism is configured to deposit pre-transformed material comprising elemental metal, metal alloy, ceramic, or an allotrope of carbon. In some embodiments, the layer dispensing mechanism is configured to deposit pre-transformed material comprising a polymer or a resin. In some embodiments, the device is configured to operate under a positive pressure atmosphere relative to an ambient pressure of an ambient atmosphere external to the device. In some embodiments, the device is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured to facilitate printing one or more three-dimensional objects in an atmosphere maintained to be different from an ambient atmosphere by at least one characteristic, the ambient atmosphere being external to the build module engaged with a processing chamber of a three-dimensional printer. In some embodiments, the build module is configured to reversibly couple to and uncouple from the processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, a three dimensional printer comprises the device, or is operatively coupled with the device; and where during the printing, the three-dimensional printer is configured to facilitate gas flow away from one or more optical windows and in a direction towards the build platform, the one or more optical windows being of the three-dimensional printer. In some embodiments, the device is associated with a three-dimensional printer configured for three-dimensional printing comprising extruding. In some embodiments, extruding is by an extruder to facilitate printing at least one three-dimensional object. In some embodiments, the device is configured to comprise, or operatively coupled with, the extruder. In some embodiments, the device is associated with a three-dimensional printer configured for three-dimensional printing comprising laminating. In some embodiments, laminating comprises depositing by a laminator configured to deposit layerwise laminated layers to facilitate printing the at least one three-dimensional object. In some embodiments, the device is configured to comprise, or be operatively coupled with, the laminator. In some embodiments, the device is associated with a three-dimensional printer configured for three-dimensional printing comprising arc welding. In some embodiments, arc welding is by an arc welder to facilitate printing the at least one three-dimensional object comprises: generating a powder stream and focusing an energy beam on the powder stream. In some embodiments, the device is configured to comprise, or operatively coupled with, the arc welder. In some embodiments, the device is associated with a three-dimensional printer configured for three-dimensional printing comprising connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the lid assembly is configured to be maneuvered by the maneuvering mechanism to close the opening at least in part by a control system. In some embodiments, the control system is configured to control at least one other component of a three-dimensional printer.

In another aspect, a method of closing the opening of the build module, the method comprises: (a) providing any of the above devices, and (b) using the device to close the opening of the build module.

In another aspect, a method of servicing, the method comprises: (a) providing any of the above devices, and (b) servicing the device. In some embodiments, the method where servicing comprises replacing or maintaining.

In another aspect, a method of installing the device, the method comprises: providing any of the above devices, and (a) coupling the device with the casing and/or (b) coupling the device with the maneuvering mechanism. In some embodiments, the method where coupling the device with the casing comprises coupling the device with the translation mechanism coupled with the casing. In some embodiments, the method where coupling the translation mechanism comprises coupling the device with the mechanical arm coupled with the translation mechanism. In some embodiments, the casing is coupled with, or is part of, the enclosure. In some embodiments, coupling the device with the maneuvering mechanism comprises coupling the device with the translation mechanism comprised in the maneuvering mechanism. In some embodiments, coupling the translation mechanism comprises coupling the device with the mechanical arm coupled with the translation mechanism, the mechanical arm being comprised in the maneuvering mechanism. In some embodiments, the maneuvering mechanism is coupled with the casing. In some embodiments, the casing is coupled with, or is part of, the enclosure.

In another aspect, an apparatus for maneuvering the lid assembly, the apparatus comprising at least one controller configured to (i) operatively couple to any of the above devices; and control, or direct control of, one or more operations associated with the device. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control the three-dimensional printer that prints the one or more three-dimensional objects. In some embodiments, the device is a component of the three-dimensional printer, and the at least one controller is configured to (i) operatively couple to an other component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control a pressure in the three-dimensional printer to be above ambient pressure external to the three-dimensional printer; and where control comprises maintain. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions, the program instructions, when read by one or more processors operatively coupled with any of the above devices, cause the one or more processors to execute, or direct execution of, one or more operations associated with the device. In some embodiments, the program instructions are inscribed in one or more media.

In another aspect, a system for three-dimensional printing, the system comprises: any of the above devices, the device being configured to associate with the three-dimensional printing; and an energy beam configured to irradiate a planar layer of powder material to print at least a portion of the at least one three-dimensional object at least in part by using the three-dimensional printing. In some embodiments, the system further comprises a scanner configured to translate the energy beam along a target surface, and the enclosure (e.g., chamber) is operatively coupled with the scanner disposed in an optical chamber that is modular and/or translatable with respect to the target surface. In some embodiments, the scanner is configured to be translatable with respect to the target surface during the three-dimensional printing. In some embodiments, the system further comprises an energy source configured to generate the energy beam, and the enclosure (e.g., chamber) is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

In another aspect, a device configured for closure, the device comprises: a build module body of a build module, the build module body comprising (i) a floor, (ii) one or more vertical walls surrounding the floor and ending at an opening opposing the floor, the build module having an interior space configured to accommodate a translatable platform supporting one or more three-dimensional objects during and after their three-dimensional printing; the build module configured to facilitate (e.g., allow) translation of the platform during the printing of the one or more three-dimensional objects; and engager receptacles disposed at the opening of the build module, the engager receptacles being configured to (a) engage with engagers of a lid assembly to close the opening, (b) engage with the engagers to deter vertical movement of the lid assembly with respect to the build module body and allow horizontal movement upon rotation of the lid assembly with respect to the build module body, (c) shut the opening of the build module to maintain an internal atmosphere of the build module different from the ambient atmosphere external to the build module, or (d) any combination of (a), (b), (c), and (d), the engager receptacles operatively coupled with the build module body, or being part of the build module body. In some embodiments, the engager receptacles are physically coupled with the build module body. In some embodiments, an engager receptacle of the engager receptacles comprises a cavity comprising (i) a cavity floor, (ii) a cavity ceiling opposing the cavity floor, and (iii) a cavity opening opposing the cavity floor and flush with the cavity ceiling; and wherein the cavity opening is configured to accommodate an engager of the engagers. In some embodiments, the cavity comprises a track that is uneven, the track being configured to engage with the lid assembly, the track being configured to cause a structural alteration in the lid assembly upon movement of a protrusion in the lid assembly along the track. In some embodiments, the cavity is configured to require force to move the protrusion along the track. In some embodiments, the force comprises manual force. In some embodiments, the track comprises the cavity floor. In some embodiments, the track comprises a step or a ramp. In some embodiments, the engager comprises the protrusion. In some embodiments, the structural alteration in the lid assembly causes sealing of the build module body by the lid assembly. In some embodiments, sealing is using a seal comprised in the lid assembly. In some embodiments, the seal is gas tight. In some embodiments, the seal is a hermetic seal. In some embodiments, the seal is configured to facilitate retaining an internal atmosphere in the build module closed by the lid assembly for a time period, the internal atmosphere being different from an ambient atmosphere external to the build module. In some embodiments, the time period is at least a same or greater value than a time period to unpack the three-dimensional objects from the build module. In some embodiments, the seal is configured to facilitate retaining for a time period (i) a positive pressure within the build module body relative to an ambient atmosphere external to the device, (ii) a reactive agent at a concentration lower than its concentration in an ambient atmosphere external to the build module, the reactive agent being configured to at least react with pre-transformed material of the three-dimensional printing during the three-dimensional printing, or (iii) a combination of (i) and (ii). In some embodiments, the time period is at least a same or greater value than a time period to unpack the three-dimensional objects from the build module. In some embodiments, the engager receptacles are distributed along the opening in equal distances. In some embodiments, the engager receptacles are configured to allow pivoting of the engagers with respect to the engager receptacles. In some embodiments, an engager receptacle of the engager receptacles comprises opposing side walls configured to limit movement of an engager of the engager, the engager being engaged with the engager receptacle. In some embodiments, the build module, when closed with the lid assembly, is configured to maintain an internal environment different from an ambient environment external to the build module, the internal environment differing from the ambient environment by at least one environmental characteristic. In some embodiments, during the printing, the build module is configured to operate at an internal environment different from an ambient environment external to the build module, the internal environment differing from the ambient environment by at least one environmental characteristic. In some embodiments, the at least one environmental characteristic comprises pressure, gas flow direction, gas velocity, gas composition, level of reactive agent, temperature, or gas borne debris. In some embodiments, the pressure is a positive pressure with respect to an ambient pressure of the ambient environment. In some embodiments, the temperature is an elevated temperature with respect to an ambient temperature in the ambient environment. In some embodiments, the gas velocity is an elevated gas velocity with respect to an ambient gas velocity in the ambient environment. In some embodiments, the gas composition comprises a higher level of inert gas as compared to the ambient level of the inert gas in the ambient environment. In some embodiments, the level of gas borne debris is higher in the internal environment as compared to the ambient environment. In some embodiments, the level of reactive agent is lower in the internal environment as compared to the ambient environment. In some embodiments, the reactive agent comprises oxygen or humidity. In some embodiments, the build module is configured for closure by the lid assembly in an internal environment of an enclosure. In some embodiments, the enclosure comprises a processing chamber or an unpacking chamber. In some embodiments, the enclosure is associated with three-dimensional printing. In some embodiments, the build module is configured for closure of the opening at least in part by a user. In some embodiments, the build module is configured to enclosure a build platform configured to support a weight of at least about 1000 kilograms (kg). In some embodiments, the build module is configured to facilitate the three-dimensional printing by facilitating vertical translation of the build platform comprising an error in vertical positioning of the vertical translation at most about 10%, 5%, or 2% of the vertical translation of the build platform. In some embodiments, the device is configured to facilitate three-dimensional printing that comprises deposition of pre-transformed material on a target surface. In some embodiments, the target surface comprises (i) an exposed surface of a material bed or (ii) a surface of the build platform. In some embodiments, the device is associated with a three-dimensional printer comprising a remover configured to remove a second portion of the deposited pre-transformed material to generate a planar layer of pre-transformed material as part of a material bed. In some embodiments, the remover is operatively coupled with an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is configured to operatively couple to a three-dimensional printer comprising a recycling system that (i) recycles at least a fraction of a portion of the pre-transformed material removed by the remover and/or (ii) provides at least a portion of the pre-transformed material utilized by the dispenser. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is configured to operatively couple to a three-dimensional printer comprising a layer dispensing mechanism configured to facilitate deposition of pre-transformed material on the target surface at least in part by layerwise deposition. In some embodiments, the layer dispensing mechanism is configured to deposit pre-transformed material comprising powder material. In some embodiments, the layer dispensing mechanism is configured to deposit pre-transformed material comprising elemental metal, metal alloy, ceramic, or an allotrope of carbon. In some embodiments, the layer dispensing mechanism is configured to deposit pre-transformed material comprising a polymer or a resin. In some embodiments, the device is configured to operate under a positive pressure atmosphere relative to an ambient pressure of an ambient atmosphere external to the device. In some embodiments, the device is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured to facilitate printing one or more three-dimensional objects in an atmosphere maintained to be different from an ambient atmosphere by at least one characteristic, the ambient atmosphere being external to the build module engaged with a processing chamber of a three-dimensional printer. In some embodiments, the build module is configured to reversibly couple to and uncouple from the processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, a three dimensional printer comprises the device, or is operatively coupled with the device; and where during the printing, the three-dimensional printer is configured to facilitate gas flow away from one or more optical windows and in a direction towards the build platform, the one or more optical windows being of the three-dimensional printer. In some embodiments, the device is associated with a three-dimensional printer configured for three-dimensional printing comprising extruding. In some embodiments, extruding is by an extruder to facilitate printing at least one three-dimensional object. In some embodiments, the device is configured to comprise, or operatively coupled with, the extruder. In some embodiments, the device is associated with a three-dimensional printer configured for three-dimensional printing comprising laminating. In some embodiments, laminating comprises depositing by a laminator configured to deposit layerwise laminated layers to facilitate printing the at least one three-dimensional object. In some embodiments, the device is configured to comprise, or be operatively coupled with, the laminator. In some embodiments, the device is associated with a three-dimensional printer configured for three-dimensional printing comprising arc welding. In some embodiments, arc welding is by an arc welder to facilitate printing the at least one three-dimensional object comprises: generating a powder stream and focusing an energy beam on the powder stream. In some embodiments, the device is configured to comprise, or operatively coupled with, the arc welder. In some embodiments, the device is associated with a three-dimensional printer configured for three-dimensional printing comprising connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the lid assembly is configured for closure of the opening at least in part by a control system. In some embodiments, the control system is configured to control at least one other component of a three-dimensional printer.

In another aspect, a method of closing the opening of the build module, the method comprises: (a) providing any of the above devices, and (b) using the device to close the opening.

In another aspect, a method of servicing, the method comprises: (a) providing any of the above devices, and (b) servicing the device. In some embodiments, the method where servicing comprises replacing or maintaining.

In another aspect, a method of installing the device, the method comprises: providing any of the above devices, and (a) coupling the device to the chamber having the internal environment. In some embodiments, the method where coupling the device to the chamber results of the chamber and the device having the internal atmosphere different from the ambient atmosphere, the camber and the device being included in the enclosure. In some embodiments, the enclosure comprises an ancillary chamber configured to house a layer dispensing mechanism. In some embodiments, the device is coupled with a plane that couples to the chamber. In some embodiments, the plane is configured for disposition parallel, or substantially parallel, to the floor of the chamber. In some embodiments, the plane is configured for attachment to a vehicle for transportation of the device. In some embodiments, the plane is configured for attachment to a vehicle for transportation of the device closed by the lid assembly.

In another aspect, an apparatus for maneuvering the lid assembly, the apparatus comprising at least one controller configured to (i) operatively couple to any of the above devices; and control, or direct control of, one or more operations associated with the device. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control the three-dimensional printer that prints the one or more three-dimensional objects. In some embodiments, the device is a component of the three-dimensional printer, and the at least one controller is configured to (i) operatively couple to an other component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control a pressure in the three-dimensional printer to be above ambient pressure external to the three-dimensional printer; and where control comprises maintain. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions, the program instructions, when read by one or more processors operatively coupled with any of the above devices, cause the one or more processors to execute, or direct execution of, one or more operations associated with the device. In some embodiments, the program instructions are inscribed in one or more media.

In another aspect, a system for three-dimensional printing, the system comprises: any of the above devices, the device being configured to associate with the three-dimensional printing; and an energy beam configured to irradiate a planar layer of powder material to print at least a portion of the at least one three-dimensional object at least in part by using the three-dimensional printing. In some embodiments, the system further comprises a scanner configured to translate the energy beam along a target surface, and the enclosure (e.g., chamber) is operatively coupled with the scanner disposed in an optical chamber that is modular and/or translatable with respect to the target surface. In some embodiments, the scanner is configured to be translatable with respect to the target surface during the three-dimensional printing. In some embodiments, the system further comprises an energy source configured to generate the energy beam, and the enclosure (e.g., chamber) is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

In another aspect, a device for maneuvering a lid assembly, the device comprises: a mechanical arm; a first connector configured to connect to the mechanical arm to (I) reversibly pivot the mechanical arm about a first axis, and (II) reversibly pivot the mechanical arm about a second axis, the mechanical arm being configured to reversibly couple with the lid assembly using a second connector configured to reversibly couple and uncouple the mechanical arm and the lid assembly, the second connector (i) being comprised in the device, or (ii) being operatively coupled with the device; and a translation mechanism configured to operatively couple to the first connector to reversibly translate the mechanical arm along a direction. In some embodiments, the device is configured to facilitate closing an opening at least in part by engaging the lid assembly with the opening, the opening being of a build module of a three-dimensional printing system. In some embodiments, the device is configured to facilitate closing the opening in an enclosure having an isolated environment from an ambient environment external to the enclosure. In some embodiments, the enclosure comprises a processing chamber or an unpacking chamber. In some embodiments, the enclosure is associated with three-dimensional printing. In some embodiments, the three-dimensional printing comprises transforming a pre-transformed material to a transformed material to print one or more three-dimensional objects disposed in the build module. In some embodiments, the pre-transformed material comprises powder. In some embodiments, the at least one three-dimensional objects is printed in a material bed comprising the pre-transformed material. In some embodiments, the pre-transformed material comprises elemental metal, metal alloy, ceramic, or an allotrope of elemental carbon. In some embodiments, the pre-transformed material comprises a polymer or a resin. In some embodiments, the device the device is configured facilitate closing the opening of the build module with the lid assembly in the isolated environment that comprises an internal environment of the enclosure, the internal environment being different from an ambient environment external to the enclosure the internal environment being different from an ambient environment by at least one environmental characteristic. In some embodiments, the at least one environmental characteristic comprises pressure, gas flow direction, gas velocity, gas composition, level of reactive agent, temperature, or gas borne debris. In some embodiments, the pressure is a positive pressure with respect to an ambient pressure of the ambient environment. In some embodiments, the temperature is an elevated temperature with respect to an ambient temperature in the ambient environment. In some embodiments, the gas velocity is an elevated gas velocity with respect to an ambient gas velocity in the ambient environment. In some embodiments, the gas composition comprises a higher level of inert gas as compared to the ambient level of the inert gas in the ambient environment. In some embodiments, the level of gas borne debris is higher in the internal environment as compared to the ambient environment. In some embodiments, the level of reactive agent is lower in the internal environment as compared to the ambient environment. In some embodiments, the reactive agent comprises oxygen or humidity. In some embodiments, the mechanical arm comprises on or more skeletal sections. In some embodiments, the mechanical arm comprises a stopping portion to limit an extent of pivoting the mechanical arm about the first axis. In some embodiments, the stopping portion is configured to limit the extent of pivoting the mechanical arm about the first axis at least in part by being configured to contact a floor of a chamber comprises in the enclosure. In some embodiments, the stopping portion comprised one or more holes. In some embodiments, the one or more holes are configured to allow a user to (i) hold the stopping portion of the mechanical arm (ii) pivot the mechanical arm about the first axis, (iii) pivot the mechanical arm about the second axis, (iv) translate the mechanical arm along the direction, or (v) any combination of (i), (ii), (iii), and (iv). In some embodiments, the first connector is configured to pivot along the first axis and along the second axis. In some embodiments, the first connector is configured to provide resistance to the pivoting of the connector at least about the second axis. In some embodiments, the first connector is configured to generate friction to provide resistance to prevent the mechanical arm from pivoting unwantedly at least about the second axis. In some embodiments, the first connector is configured to generate friction to provide resistance to prevent the mechanical arm from pivoting unwantedly about the first axis and about the second axis. In some embodiments, the first connector comprises a hinge. In some embodiments, first connector comprises the hinge that comprises a torque hinge. In some embodiments, the first connector comprises bearing configured to facilitate pivoting the mechanical arm about the first axis. In some embodiments, the bearing comprises a circular bearing. In some embodiments, the first axis is different than the second axis. In some embodiments, the first axis is perpendicular, or substantially perpendicular, to the second axis. In some embodiments, the first connector is configured to pivot the mechanical arm about the first axis to cause the mechanical arm to translate from one position along the direction to a second position along the direction, where pivoting about the first axis results in pivoting in a plane comprising the direction, or parallel to the direction. In some embodiments, the first connector is configured to pivot the mechanical arm about the second axis to cause the mechanical arm to translate from a (e.g., substantially) vertical position towards, or to, a (e.g., substantially) horizontal position. In some embodiments, the second connector is configured to reversibly alter its configuration to couple and to decouple the lid assembly and the mechanical arm. In some embodiments, the second connector is configured to reversibly alter its configuration at least in part by being configured to (I) pivot in a first direction and in a second direction opposing the first direction and/or (II) compress in a third direction and release in a fourth direction opposing the first direction. In some embodiments, the second connector comprises a pin, balls, or a spring. In some embodiments, the second connector can reversibly alter its configuration at least in part by being configured to (i) latch to the lid assembly and (ii) be released from the lid assembly. In some embodiments, the device is configured to reversibly couple with the lid assembly at least in part by allowing the lid assembly to (i) engage with the second connector and (ii) disengage from the second connector. In some embodiments, the translation mechanism comprises a railing system, a scissor jack, a leading screw, or an encoder. In some embodiments, the translation mechanism comprises a railing system. In some embodiments, the railing system comprises a track, a sliding bar, a belt, or an actuator. In some embodiments, the translation mechanism comprises a cover. In some embodiments, the cover is configured to fasten the translation mechanism to a casing. In some embodiments, the cover comprises a retaining plate. In some embodiments, the translation mechanism in its contracted state is disposed in the casing. In some embodiments, the direction extends from an interior of the casing to an exterior of the casing, through an opening of the casing. In some embodiments, the exterior of the casing comprises a floor of a chamber. In some embodiments, the translation mechanism is configured to reversibly translate at least one component through an opening of the casing, the at least one component comprising the mechanical arm, the lid assembly, or a portion of the translation mechanism. In some embodiments, the translation mechanism is configured to reversibly translate at least one component out of the casing, and inwards towards an internal space of the casing, the at least one component comprising the mechanical arm, the lid assembly, or a portion of the translation mechanism. In some embodiments, the cover is configured to shield one or more other components of the translation mechanism from gas borne material in the environment in which the translation mechanism is configured to operate. In some embodiments, the gas borne material comprises soot or powder. In some embodiments, the gas borne material comprises debris or pre-transformed material. In some embodiments, the debris comprises soot, splatter, or spatter. In some embodiments, the pre-transformed material comprises powder. In some embodiments, the pre-transformed material comprises elemental metal, metal alloy, ceramic, or an allotrope of elemental carbon. In some embodiments, the soot comprises elemental metal, metal alloy, ceramic, or an allotrope of elemental carbon. In some embodiments, the pre-transformed material comprises a polymer or a resin. In some embodiments, the pre-transformed comprises a starting material for a three-dimensional printing, or a remainder material of the three-dimensional printing. In some embodiments, the translation mechanism is configured to operate using a force source. In some embodiments, the force source comprises an electric force source, pneumatic force source, hydraulic force source, magnetic force source, or mechanical force source. In some embodiments, the force source comprises a pneumatic force source. In some embodiments, the translation mechanism is configured to operate manually by a user disposed externally to an enclosure in which the mechanical arm is disposed. In some embodiments, the translation mechanism is configured to operate by remote control. In some embodiments, the translation mechanism is configured to be directed by one or more controllers. In some embodiments, the one or more controllers control at least one other component of a three-dimensional printer. In some embodiments, the device is configured to facilitate maneuvering the lid assembly to close an opening of a build module in an internal environment of an enclosure, the internal environment being different from an ambient environment external to the enclosure the internal environment being different from an ambient environment by at least one environmental characteristic; and where at least a portion of the device is configured to operate in the internal environment, the at least a portion of the device comprising the mechanical arm, the first connector, and at least a portion of the translation mechanism. In some embodiments, the enclosure comprises a processing chamber or an unpacking chamber. In some embodiments, the enclosure is associated with three-dimensional printing. In some embodiments, the at least one environmental characteristic comprises pressure, gas flow direction, gas velocity, gas composition, level of reactive agent, temperature, or gas borne debris. In some embodiments, the pressure is a positive pressure with respect to an ambient pressure of the ambient environment. In some embodiments, the temperature is an elevated temperature with respect to an ambient temperature in the ambient environment. In some embodiments, the gas velocity is an elevated gas velocity with respect to an ambient gas velocity in the ambient environment. In some embodiments, the gas composition comprises a higher level of inert gas as compared to the ambient level of the inert gas in the ambient environment. In some embodiments, the level of gas borne debris is higher in the internal environment as compared to the ambient environment. In some embodiments, the build module is configured to enclosure a build platform configured to support a weight of at least about 1000 kilograms (kg). In some embodiments, the build module is configured to facilitate the three-dimensional printing by facilitating vertical translation of the build platform comprising an error in vertical positioning of the vertical translation at most about 10%, 5%, or 2% of the vertical translation of the build platform. In some embodiments, the device is configured to facilitate three-dimensional printing that comprises deposition of pre-transformed material on a target surface. In some embodiments, the target surface comprises (i) an exposed surface of a material bed or (ii) a surface of the build platform. In some embodiments, the device is associated with a three-dimensional printer comprising a remover configured to remove a second portion of the deposited pre-transformed material to generate a planar layer of pre-transformed material as part of a material bed. In some embodiments, the remover is operatively coupled with an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is configured to operatively couple to a three-dimensional printer comprising a recycling system that (i) recycles at least a fraction of a portion of the pre-transformed material removed by the remover and/or (ii) provides at least a portion of the pre-transformed material utilized by the dispenser. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is configured to operatively couple to a three-dimensional printer comprising a layer dispensing mechanism configured to facilitate deposition of pre-transformed material on the target surface at least in part by layerwise deposition. In some embodiments, the layer dispensing mechanism is configured to deposit pre-transformed material comprising powder material. In some embodiments, the layer dispensing mechanism is configured to deposit pre-transformed material comprising elemental metal, metal alloy, ceramic, or an allotrope of carbon. In some embodiments, the layer dispensing mechanism is configured to deposit pre-transformed material comprising a polymer or a resin. In some embodiments, the device is configured to operate under a positive pressure atmosphere relative to an ambient pressure of an ambient atmosphere external to the device. In some embodiments, the device is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured to facilitate printing one or more three-dimensional objects in an atmosphere maintained to be different from an ambient atmosphere by at least one characteristic, the ambient atmosphere being external to the build module engaged with a processing chamber of a three-dimensional printer. In some embodiments, the build module is configured to reversibly couple to and uncouple from the processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, a three dimensional printer comprises the device, or is operatively coupled with the device; and where during the printing, the three-dimensional printer is configured to facilitate gas flow away from one or more optical windows and in a direction towards the build platform, the one or more optical windows being of the three-dimensional printer. In some embodiments, the device is associated with a three-dimensional printer configured for three-dimensional printing comprising extruding. In some embodiments, extruding is by an extruder to facilitate printing at least one three-dimensional object. In some embodiments, the device is configured to comprise, or operatively coupled with, the extruder. In some embodiments, the device is associated with a three-dimensional printer configured for three-dimensional printing comprising laminating. In some embodiments, laminating comprises depositing by a laminator configured to deposit layerwise laminated layers to facilitate printing the at least one three-dimensional object. In some embodiments, the device is configured to comprise, or be operatively coupled with, the laminator. In some embodiments, the device is associated with a three-dimensional printer configured for three-dimensional printing comprising arc welding. In some embodiments, arc welding is by an arc welder to facilitate printing the at least one three-dimensional object comprises: generating a powder stream and focusing an energy beam on the powder stream. In some embodiments, the device is configured to comprise, or operatively coupled with, the arc welder. In some embodiments, the device is associated with a three-dimensional printer configured for three-dimensional printing comprising connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the level of reactive agent is lower in the internal environment as compared to the ambient environment. In some embodiments, the reactive agent comprises oxygen or humidity.

In another aspect, a method of maneuvering the lid assembly, the method comprises: (a) providing any of the above devices, and (b) using the device to maneuver the lid assembly.

In another aspect, a method of servicing, the method comprises: (a) providing any of the above devices, and (b) servicing the device. In some embodiments, the method where servicing comprises replacing or maintaining.

In another aspect, a method of installing the device, the method comprises: providing any of the above devices, and (a) coupling the translation mechanism with the casing, and/or (b) coupling the lid assembly with the mechanical arm.

In another aspect, an apparatus for maneuvering the lid assembly, the apparatus comprising at least one controller configured to (i) operatively couple to any of the above devices; and control, or direct control of, one or more operations associated with the device. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control the three-dimensional printer that prints the one or more three-dimensional objects. In some embodiments, the device is a component of the three-dimensional printer, and the at least one controller is configured to (i) operatively couple to an other component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control a pressure in the three-dimensional printer to be above ambient pressure external to the three-dimensional printer; and where control comprises maintain. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions, the program instructions, when read by one or more processors operatively coupled with any of the above devices, cause the one or more processors to execute, or direct execution of, one or more operations associated with the device. In some embodiments, the program instructions are inscribed in one or more media.

In another aspect, a system for three-dimensional printing, the system comprises: any of the above devices, the device being configured to associate with the three-dimensional printing; and an energy beam configured to irradiate a planar layer of powder material to print at least a portion of the at least one three-dimensional object at least in part by using the three-dimensional printing. In some embodiments, the system further comprises a scanner configured to translate the energy beam along a target surface, and the enclosure (e.g., chamber) is operatively coupled with the scanner disposed in an optical chamber that is modular and/or translatable with respect to the target surface. In some embodiments, the scanner is configured to be translatable with respect to the target surface during the three-dimensional printing. In some embodiments, the system further comprises an energy source configured to generate the energy beam, and the enclosure (e.g., chamber) is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

In another aspect, a device for attachment to an enclosure, the device comprises: a casing having a first width, a first length, and a first height, the casing having an opening, the casing being configured to accommodate (a) a second width and a second height of a lid assembly, (b) a third width and a third height of a mechanical arm configured to operatively couple to the lid assembly and configured to maneuver the lid assembly, (c) a fourth width and a fourth height of at least a portion of a translation mechanism configured to reversibly translate at least one component in and out of the opening along a direction, the translation mechanism configured to couple to the mechanical arm and reversibly translate the mechanical arm along the direction, the casing being configured to couple with the translation mechanism and facilitate (e.g., allow) translation of the translation mechanism, the casing being configured to operatively couple to the enclosure, the at least one component comprising the lid assembly, the mechanical arm, or at least a portion of the translation mechanism. In some embodiments, the enclosure comprises a chamber. In some embodiments, the chamber comprises a framing, and the casing is configured to attach to the framing. In some embodiments, the chamber has a primary door on a side of the framing configured to face a user, and the casing is configured to attach to the framing such that a side of the casing is configured to face the user. In some embodiments, the casing is configured to attach to the framing on a first side of the primary door, on a second side of the primary door opposing the first side, on a top side of the primary door closer to a ceiling of the chamber, or on a bottom side of the primary door closer to a floor of the chamber. In some embodiments, the first side of the primary door comprises a hinge of the door. In some embodiments, the first side of the primary door comprises a hinge of the door. In some embodiments, the second side of the primary door comprises a latch of the door. In some embodiments, the chamber comprises a first floor, and the casing has a second floor flush with the first floor. In some embodiments, the chamber is associated with a three-dimensional printer. In some embodiments, the chamber comprises a processing chamber or an unpacking chamber. In some embodiments, the enclosure is of a three-dimensional printer. In some embodiments, the casing is configured to attach to a wall of the enclosure configured to face a user. In some embodiments, the casing is configured for disposition adjacent to a primary door of the enclosure configured to face a user. In some embodiments, adjacent to the primary door comprises contacting the primary door. In some embodiments, adjacent to the primary door comprises residing on a plane facing the user. In some embodiments, adjacent to the primary door comprises immediately adjacent to the primary door. In some embodiments, the casing is configured to attach to the enclosure such that a side of the casing is configured to face the user. In some embodiments, the casing is configured to attach to the framing on a first side of the primary door, on a second side of the primary door opposing the first side, on a top side of the primary door closer to a ceiling of the enclosure, or on a bottom side of the primary door closer to a floor of the enclosure. In some embodiments, the first side of the primary door comprises a hinge of the door. In some embodiments, the second side of the primary door comprises a latch of the door. In some embodiments, the casing is configured to reversibly attach and detach from the enclosure. In some embodiments, the opening is a first opening disposed on a first side of the casing, and the casing comprises a second opening disposed on a second side of the casing, the second side contacting the first side. In some embodiments, a length of the second side is the first length, and where a width of the first side is the first width. In some embodiments, a height of the first side is the first height, and where a height of second first side is of the first height. In some embodiments, the first opening is devoid of a cover, and the second opening is closed by the cover during operation. In some embodiments, the cover comprises an opaque portion, or is entirely opaque. In some embodiments, the cover comprises a transparent portion to allow a user to view an interior of the casing. In some embodiments, the cover is configured for reversible removal to allow a user to handle the at least one component when disposed at least in part in an interior space of the casing. In some embodiments, the enclosure is configured to enclose a first internal environment different than the ambient environment external to the enclosure; the casing is configure to enclosure a second internal environment; and the casing is configured to attach to the enclosure such that the first internal environment and the second internal environment join to a third internal environment different from the ambient environment by at least one environmental characteristic. In some embodiments, the at least one environmental characteristic comprises pressure, gas flow direction, gas velocity, gas composition, level of reactive agent, temperature, or gas borne debris. In some embodiments, the pressure is a positive pressure with respect to an ambient pressure of the ambient environment. In some embodiments, the temperature is an elevated temperature with respect to an ambient temperature in the ambient environment. In some embodiments, the gas velocity is an elevated gas velocity with respect to an ambient gas velocity in the ambient environment. In some embodiments, the gas composition comprises a higher level of inert gas as compared to the ambient level of the inert gas in the ambient environment. In some embodiments, the level of gas borne debris is higher in the internal environment as compared to the ambient environment. In some embodiments, the level of reactive agent is lower in the internal environment as compared to the ambient environment. In some embodiments, the reactive agent comprises oxygen or humidity. In some embodiments, the casing comprises, or is operatively coupled with, an actuator configured to actuate the translation mechanism. In some embodiments, the translation mechanism comprises a railing system, a scissor jack, a leading screw, or an encoder. In some embodiments, the translation mechanism comprises a railing system. In some embodiments, the railing system comprises a track, a sliding bar, a belt, or an actuator. In some embodiments, the translation mechanism comprises a cover. In some embodiments, the casing is configured to fasten the cover to the casing such that at least a portion of the translation mechanism is affixed with the casing. In some embodiments, the cover comprises a retaining plate. In some embodiments, the casing is configured to house the translation mechanism in the casing when the translation mechanism is in its contracted state. In some embodiments, the direction extends from an interior of the casing to an exterior of the casing, through the opening of the casing. In some embodiments, the exterior of the casing comprises a floor of a chamber comprised in the enclosure. In some embodiments, the casing is configured to facilitate reversible translation of the at least one component out of the casing, and inwards towards an internal space of the casing, the translation utilizing the translation mechanism. In some embodiments, the casing is configured to operate in an internal environment comprising gas borne material. In some embodiments, the gas borne material comprises soot or powder. In some embodiments, the gas borne material comprises debris or pre-transformed material. In some embodiments, the debris comprises soot, splatter, or spatter. In some embodiments, the pre-transformed material comprises powder. In some embodiments, the pre-transformed material comprises elemental metal, metal alloy, ceramic, or an allotrope of elemental carbon. In some embodiments, the soot comprises elemental metal, metal alloy, ceramic, or an allotrope of elemental carbon. In some embodiments, the pre-transformed material comprises a polymer or a resin. In some embodiments, the pre-transformed comprises a starting material for a three-dimensional printing, or a remainder material of the three-dimensional printing. In some embodiments, the casing is configured to facilitate operating the translation mechanism using a force source. In some embodiments, the force source comprises an electric force source, pneumatic force source, hydraulic force source, magnetic force source, or mechanical force source. In some embodiments, the force source comprises a pneumatic force source. In some embodiments, the casing comprises at least one connection to the force source to operate the translation mechanism. In some embodiments, the casing is configured to allow operation of the translation mechanism manually by a user disposed externally to the casing and external to the enclosure. In some embodiments, the casing is configured to allow operation of the translation mechanism by remote control. In some embodiments, the casing is configured to allow operation of the translation mechanism using one or more controllers. In some embodiments, the one or more controllers are configured to control at least one other component of a three-dimensional printer. In some embodiments, the lid assembly is configured to close a build module housing one or more three-dimensional objects. In some embodiments, the build module is configured to house the one or more three-dimensional objects during and after their three-dimensional printing. In some embodiments, the opening is configured to accommodate (b) the third width and the third height of the mechanical arm and (c) the fourth width and the fourth height of the at least the portion of the translation mechanism. In some embodiments, the mechanical arm is configured to couple and with the translation mechanism using a first connector. In some embodiments, the opening is configured to accommodate (b) the third width and the third height of the mechanical arm and (c) the fourth width and the fourth height of the at least the portion of the translation mechanism, as the mechanical arm is connected with the translation mechanism by the first connector. In some embodiments, the first connector is configured to maneuver the mechanical arm about a first axis and about a second axis different from the first axis. In some embodiments, the first axis is perpendicular, or substantially perpendicular, to the second axis. In some embodiments, maneuvering about the first axis comprises pivoting about the first axis. In some embodiments, maneuvering about the first axis comprises translation along the direction. In some embodiments, maneuvering about the second axis comprises pivoting about the second axis. In some embodiments, the first connector is configured to pivot along the first axis and along the second axis. In some embodiments, the first connector is configured to provide resistance to the pivoting of the connector at least about the second axis. In some embodiments, the first connector is configured to generate friction to provide resistance to prevent the mechanical arm from pivoting unwantedly at least about the second axis. In some embodiments, the first connector is configured to generate friction to provide resistance to prevent the mechanical arm from pivoting unwantedly about the first axis and about the second axis. In some embodiments, the first connector comprises a hinge. In some embodiments, first connector comprises the hinge that comprises a torque hinge. In some embodiments, the first connector comprises bearing configured to facilitate pivoting the mechanical arm about the first axis. In some embodiments, the bearing comprises a circular bearing. In some embodiments, the first connector is configured to pivot the mechanical arm about the first axis to cause the mechanical arm to translate from one position along the direction to a second position along the direction, where pivoting about the first axis results in pivoting in a plane comprising the direction, or parallel to the direction. In some embodiments, the first connector is configured to pivot the mechanical arm about the second axis to cause the mechanical arm to translate from a (e.g., substantially) vertical position towards, or to, a (e.g., substantially) horizontal position. In some embodiments, the opening is configured to accommodate (a) the second width and the second height of the lid assembly and (b) the third width and the third height of a mechanical arm. In some embodiments, the mechanical arm is configured to reversibly couple and uncouple with the lid assembly using a second connector. In some embodiments, the opening is configured to accommodate (a) the second width and the second height of the lid assembly and (b) the third width and the third height of a mechanical arm, as the mechanical arm is connected with the lid assembly by the second connector. In some embodiments, the second connector is configured to reversibly alter its configuration to couple and to decouple the lid assembly and the mechanical arm. In some embodiments, the second connector is configured to reversibly alter its configuration at least in part by being configured to (I) pivot in a first direction and in a second direction opposing the first direction and/or (II) compress in a third direction and release in a fourth direction opposing the first direction. In some embodiments, the second connector comprises a pin, balls, or a spring. In some embodiments, the build module is configured to enclosure a build platform configured to support a weight of at least about 1000 kilograms (kg). In some embodiments, the build module is configured to facilitate the three-dimensional printing by facilitating vertical translation of the build platform comprising an error in vertical positioning of the vertical translation at most about 10%, 5%, or 2% of the vertical translation of the build platform. In some embodiments, the device is configured to facilitate three-dimensional printing that comprises deposition of pre-transformed material on a target surface. In some embodiments, the target surface comprises (i) an exposed surface of a material bed or (ii) a surface of the build platform. In some embodiments, the device is associated with a three-dimensional printer comprising a remover configured to remove a second portion of the deposited pre-transformed material to generate a planar layer of pre-transformed material as part of a material bed. In some embodiments, the remover is operatively coupled with an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is configured to operatively couple to a three-dimensional printer comprising a recycling system that (i) recycles at least a fraction of a portion of the pre-transformed material removed by the remover and/or (ii) provides at least a portion of the pre-transformed material utilized by the dispenser. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is configured to operatively couple to a three-dimensional printer comprising a layer dispensing mechanism configured to facilitate deposition of pre-transformed material on the target surface at least in part by layerwise deposition. In some embodiments, the layer dispensing mechanism is configured to deposit pre-transformed material comprising powder material. In some embodiments, the layer dispensing mechanism is configured to deposit pre-transformed material comprising elemental metal, metal alloy, ceramic, or an allotrope of carbon. In some embodiments, the layer dispensing mechanism is configured to deposit pre-transformed material comprising a polymer or a resin. In some embodiments, the device is configured to operate under a positive pressure atmosphere relative to an ambient pressure of an ambient atmosphere external to the device. In some embodiments, the device is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured be associated with printing one or more three-dimensional objects in an atmosphere maintained to be different from an ambient atmosphere by at least one characteristic, the ambient atmosphere being external to the build module engaged with a processing chamber of a three-dimensional printer. In some embodiments, the build module is configured to reversibly couple to and uncouple from the processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, a three dimensional printer comprises the device, or is operatively coupled with the device; and where during the printing, the three-dimensional printer is configured to facilitate gas flow away from one or more optical windows and in a direction towards the build platform, the one or more optical windows being of the three-dimensional printer. In some embodiments, the device is associated with a three-dimensional printer configured for three-dimensional printing comprising extruding. In some embodiments, extruding is by an extruder to facilitate printing at least one three-dimensional object. In some embodiments, the device is configured to comprise, or operatively coupled with, the extruder. In some embodiments, the device is associated with a three-dimensional printer configured for three-dimensional printing comprising laminating. In some embodiments, laminating comprises depositing by a laminator configured to deposit layerwise laminated layers to facilitate printing the at least one three-dimensional object. In some embodiments, the device is configured to comprise, or be operatively coupled with, the laminator. In some embodiments, the device is associated with a three-dimensional printer configured for three-dimensional printing comprising arc welding. In some embodiments, arc welding is by an arc welder to facilitate printing the at least one three-dimensional object comprises: generating a powder stream and focusing an energy beam on the powder stream. In some embodiments, the device is configured to comprise, or operatively coupled with, the arc welder. In some embodiments, the device is associated with a three-dimensional printer configured for three-dimensional printing comprising connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the second connector can reversibly alter its configuration at least in part by being configured to (i) latch to the lid assembly and (ii) be released from the lid assembly.

In another aspect, a method of attaching the casing to an enclosure, the method comprises: (a) providing any of the above devices, and (b) using the device to attach the casing to the enclosure.

In another aspect, a method of servicing the at least one component associated with the casing, the method comprises: (a) providing any of the above devices, and (b) servicing the one or more component. In some embodiments, the method where servicing comprises replacing or maintaining. In some embodiments, the method where servicing comprises opening the second opening of the casing.

In another aspect, a method of installing the at least one component associated with the casing, the method comprises: providing any of the above devices, and (a) coupling the translation mechanism to the casing and/or (b) coupling the lid assembly with the mechanical arm.

In another aspect, an apparatus for three-dimensional printing, the apparatus comprising at least one controller configured to (i) operatively couple to any of the above devices; and control, or direct control of, one or more operations associated with the device. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control the three-dimensional printer that prints the one or more three-dimensional objects. In some embodiments, the device is a component of the three-dimensional printer, and the at least one controller is configured to (i) operatively couple to an other component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control a pressure in the three-dimensional printer to be above ambient pressure external to the three-dimensional printer; and where control comprises maintain. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions, the program instructions, when read by one or more processors operatively coupled with any of the above devices, cause the one or more processors to execute, or direct execution of, one or more operations associated with the device. In some embodiments, the program instructions are inscribed in one or more media.

In another aspect, a system for three-dimensional printing, the system comprises: the device any of the above devices, the device being configured to associate with the three-dimensional printing; and an energy beam configured to irradiate a planar layer of powder material to print at least a portion of the at least one three-dimensional object at least in part by using the three-dimensional printing. In some embodiments, the system further comprises a scanner configured to translate the energy beam along a target surface, and the enclosure (e.g., chamber) is operatively coupled with the scanner disposed in an optical chamber that is modular and/or translatable with respect to the target surface. In some embodiments, the scanner is configured to be translatable with respect to the target surface during the three-dimensional printing. In some embodiments, the system further comprises an energy source configured to generate the energy beam, and the enclosure (e.g., chamber) is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system. In another aspect, a system for effectuating the methods, operations of an apparatus, and/or operations inscribed by non-transitory computer readable program instructions (e.g., inscribed on a media/medium), is disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In another aspect, a system for effectuating the methods, operations of the device, operations of the apparatus, and/or operations inscribed by non-transitory computer readable program instructions (e.g., inscribed on a media/medium), disclosed herein.

In other aspects, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions are inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions are inscribed on at least one medium (e.g., on a medium or on media).

Another aspect of the present disclosure provides methods, systems, apparatuses (e.g., controller(s)), and/or non-transitory computer-readable program instructions (e.g., software) that implement any operation associated with any of the devices disclosed herein. In some embodiments, the program instructions are inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, at least one controller comprises or is operatively coupled with a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, at least one controller implements any of the methods, processes, and/or operations disclosed herein. In some embodiments, at least a portion of one or more processors is part of a 3D printer, outside of the 3D printer, in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled with the apparatus. In some embodiments, the apparatus includes any apparatus or device disclosed herein. In some embodiments, at least one controller implements, or direct implementation of, any of the methods disclosed herein. In some embodiments, at least one controller directs any apparatus (or component thereof) disclosed herein.

In some embodiments, at least two operations of the apparatus are directed by the same controller. In some embodiments, at least two of the operations of the apparatus are directed by different controllers.

In some embodiments, at least operations (e.g., instructions) are carried out by the same processor and/or by the same sub-computer software product. In some embodiments, at least two operations (e.g., instructions) are carried out by different processors and/or sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with the mechanism. In some embodiments, the mechanism comprises an apparatus or an apparatus component.

In another aspect, non-transitory computer-readable medium/media comprising machine-executable code that, upon execution by one or more computer processors, implements any of the methods and/or operations disclosed herein.

In another aspect, non-transitory computer-readable medium/media comprising machine-executable code that, upon execution by one or more computer processors, effectuates directions of the controller(s) (e.g., as disclosed herein).

In another aspect, a computer system comprising one or more computer processors and non-transitory computer-readable medium/media coupled thereto. In some embodiments, the non-transitory computer-readable medium comprises machine-executable code that, upon execution by one or more computer processors, implements any of the methods disclosed herein and/or effectuates directions of the controller(s) disclosed herein.

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively coupled with the device, and (ii) direct executes one or more operations associated with at least one configuration of the device(s) disclosed herein.

In another aspect, at least one controller is associated with the methods, devices, and software disclosed herein. In some embodiments, at least one controller comprises at least one connector configured to connect to a power source. In some embodiments, at least one controller is configured to be operatively coupled with a power source at least in part by (I) having a power socket and/or (II) being configured for wireless power transfer using inductive charging. In some embodiments, at least one controller is included in or comprises, a hierarchical control system. In some embodiments, the hierarchical control system comprises at least three hierarchical control levels. In some embodiments, at least one controller is included in a control system configured to control a three-dimensional printer that prints one or more three-dimensional objects. In some embodiments, at least one controller is configured to control at least one other component of a 3D printing system. In some embodiments, the device disclosed herein is a component of a three-dimensional printing system, wherein at least one controller is configured to (i) operatively couple to another component of the three-dimensional printing system and (ii) direct operation of the other component. In some embodiments, at least one controller is configured to direct the operation of the other component at least in part for the participation of the other component in three-dimensional printing. In some embodiments, at least one controller is operatively coupled with at least about 900 sensors or 1000 sensors operatively coupled with the three-dimensional printer. In some embodiments, at least one controller is configured to control a pressure in the three-dimensional printer to be above ambient pressure external to the three-dimensional printer. In some embodiments, at least one controller is configured to control an internal atmosphere of the three-dimensional printer to be depleted of a reactive agent relative to its concentration in an ambient atmosphere external to the device, the reactive agent is configured to react with a starting material of the three-dimensional printing at least during the three-dimensional printing.

In another aspect, non-transitory computer readable program instructions for three-dimensional printing, the non-transitory computer readable program instructions, when read by one or more processors operatively coupled to the device, cause the one or more processors to direct execute one or more operations associated with at least one configuration of the device(s) disclosed herein.

In some embodiments, the program instructions are of a computer product.

In another aspect, a system for three-dimensional printing, the system comprising: any of the devices above; and an energy beam configured to irradiate powder material (e.g., a planar layer of powder material) to print at least a portion of at least one three-dimensional object at least in part by using three-dimensional printing. In some embodiments, the system further comprises a scanner configured to translate the energy beam along a target surface, wherein the device is operatively coupled with the scanner disposed of in an optical chamber. In some embodiments, the system further comprises an energy source configured to generate the energy beam, wherein the device is operatively coupled with the energy source. In some embodiments, the energy source comprises a laser source or an electron beam source. In some embodiments, the system further comprises at least one controller that (i) is operatively coupled with the device and (ii) directs one or more operations associated with the device. In some embodiments, the system is configured to operatively couple to at least one controller configured to (i) operatively couple to the system and (ii) direct one or more operations associated with the system.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” herein), of which:

FIG. 1 schematically illustrates a side view of a three-dimensional (3D) printing system and its components;

FIG. 2 schematically illustrates a perspective view of a 3D printing system;

FIG. 3 illustrates a path;

FIG. 4 schematically illustrates a computer control system that is programmed or otherwise configured to facilitate the formation of one or more 3D objects;

FIG. 5 schematically illustrates a side view of a 3D printing system and its components;

FIG. 6 shows a schematic perspective view of a 3D printing system and its components;

FIG. 7 shows schematic views of a 3D printing system and its components;

FIG. 8 schematically illustrates a vertical cross section of a 3D printing system portion and its components;

FIG. 9 schematically illustrates a vertical cross section of a 3D object unpacking system portion;

FIG. 10 schematically illustrates various views of 3D object unpacking system portions;

FIG. 11 schematically illustrates a perspective view of a 3D printing system and related components;

FIG. 12 schematically illustrates a perspective view of a portion of a 3D printing system;

FIG. 13 schematically illustrates various views of 3D printing system portions;

FIG. 14 schematically illustrates various views of processing chamber portions;

FIG. 15 schematically illustrates various views of build module portions and associated components;

FIG. 16 schematically illustrates various views of lid assembly portions;

FIG. 17 schematically illustrates various views of lid assembly portions and associated components;

FIG. 18 schematically illustrates various views of processing chamber portions and associated components;

FIG. 19 schematically illustrates various views of processing chamber portions and associated components;

FIG. 20 schematically illustrates various views of processing chamber portions and associated components;

FIG. 21 schematically illustrates various views of lid assembly portions and associated components, e.g., various portions of the lock pin and mechanical arm;

FIG. 22 schematically illustrates various views of casing portions and associated components;

FIG. 23 schematically illustrates various views of processing chamber portions associated components; and

FIG. 24 schematically illustrates various views of processing chamber portions and associated components.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a,” “an” and “the” are not intended to refer to only a singular entity but include the general class of which a specific example may be used for illustration. The terminology herein is used to describe specific embodiments in the present disclosure, but their usage does not delimit the specific embodiments of the present disclosure. The term “includes” means includes but not limited to, the term “including” means including, but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims—is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

A central tendency as understood herein comprises mean, median, or mode. The mean may comprise a geometric mean.

“Real time” as understood herein may be during at least part of the printing of a 3D object. Real time may be during a print operation. Real time may be during a print cycle. Real time may comprise: during the formation of (i) a 3D object, (ii) a layer of hardened material as part of the 3D object, (iii) a hatch line, or (iv) a melt pool.

Performing a reversible first operation is understood herein to mean performing the first operation and being capable of performing the opposite of that first operation (e.g., which is a second operation). For example, when a controller directs reversibly opening a lid assembly, that lid assembly can also close, and the controller can optionally direct closure of that lid assembly. For example, when a recoater reversibly translates in a first direction, that recoater can also translate in a second direction opposite to the first direction. For example, when a controller directs reversibly translating a recoater in a first direction, that recoater can translate in the first direction and can also translate in a second direction opposite to the first direction, e.g., when the controller directs the recoater to translate in the second direction.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

In another aspect disclosed herein is a maneuvering mechanism for a lid, e.g., for a lid assembly. The maneuvering mechanism for the lid may be referred to herein as a “lid maneuvering mechanism.” The lid maneuvering mechanism can translate the lid in different cartesian directions, e.g., in a controllable manner. For example, the maneuvering mechanism can translate the lid along a first plane. The maneuvering mechanism can translate the lid from the first plane to a second plane. The second plane may form an angle with the first plane. The angle can be at least about 30°, 45°, 75°, or 90°. For example, the second plane is (e.g., substantially) normal to the first plane. The maneuvering mechanism may comprise a mechanical arm and a translation mechanism. The translation mechanism may facilitate translation of the mechanical arm along the first plane. The translation mechanism may facilitate translation of the mechanical arm along an axis. The translation mechanism may comprise a scissor jack, a lead screw, or a railing system. The translation mechanism may comprise an encoder, a leading screw, an actuator, a bearing, a shaft, or bellow. The translation mechanism may comprise an encoder, bearing, or a scissor jack. The encoder may comprise an optical encoder or a magnetic encoder. The bearing may comprise a gas bearing or a magnetic bearing. The actuator may comprise a motor such as a servomotor. The motor may be a linear motor. The mechanical arm may be coupled with the translation mechanism using a coupler. The coupler may comprise a hinge, e.g., a torque hinge. The mechanical arm may comprise, or be operatively coupled with a bearing, e.g., a circular bearing. The bearing may be configured to facilitate pivoting of the mechanical arm about an axis, e.g., along the first plane. The bearing may be part of, or operatively coupled with, the coupler that couples the translation mechanism and the mechanical arm. The coupler may facilitate translating the mechanical arm from the first plane to the second plane, e.g., by pivoting along an axis such as the hinge axis. The translation mechanism may facilitate translating the mechanical arm from one position to another. One position may be at least partially secluded in a casing, the other position may be exposed from the casing. The casing may be configured to at least partially encase (i) the maneuvering mechanism, (ii) the mechanical arm, (iii) the lid, (iv) the maneuvering mechanism and the lid, (v) the mechanical arm and the lid, or (vi) the maneuvering mechanism coupled with the lid. The translation mechanism may be configured to be disposed of in the casing in its most contracted state, and extend at least partially out of the casing in its most expanded state. The maneuvering mechanism may be configured to operate in an internal environment that differs from the ambient environment by at least one environmental characteristic. At least one environmental characteristic may comprise gas makeup, gas pressure, gas temperature, gas flow velocity, gas flow direction, gas flow acceleration, debris concentration, or concentration of a reactive agent. at least one environmental characteristic may be any of the one(se) disclosed herein. The mechanical arm may comprise supportive skeleton portion(s), e.g., configured for its stiffness and/or durability over use.

In some embodiments, the mechanical arm is coupled with the translation mechanism using a coupler. The coupler may comprise a hinge, e.g., a torque hinge. The torque hinger may be referred to as a friction control hinge, or a position control hinge. The hinge may be configured to provide resistance to the pivoting motion of the hinge. The hinge may comprise mechanism that generates friction, e.g., to provide resistance. The resistance may hinder movement of unwanted movement of at least one component coupled with the hinge. The at leas one component may comprise the mechanical arm or the lid assembly.

In some embodiments, the translation mechanism comprises a railing system. The railing system may comprise a sliding bar, e.g., slidable along tracks. The coupler may couple to a sliding bar of the railing system. The railing system may comprise tracks along which the sliding bar slides. Sliding of the bar along the tracks may be accomplished manually, partially manually, or automatically such as using at least one controller. At least one controller may be any controller disclosed herein, e.g., a control system of a 3D printer and/or of an unpacking station. Sliding of the bar may comprise using an actuator, e.g., comprising gear. Rotation of the gear may cause a belt to move, e.g., at least in part by engaging the teeth of the belt with the gear and actuating the gear. The gear can be actuated (e.g., rotated) manually, partially manually, or automatically such as by using the controller(s). The railing may be actuated using a force (e.g., push). The force may comprise hydraulic (e.g., gas) force, pneumatic force, magnetic force, or electric force. Initiation of the force may be done manually, partially manually, or automatically such as by using the controller(s). at least a portion of the railing system (e.g., the track(s)) may be affixed to the casing, e.g., to the interior of the casing. The railing system may comprise at least one retaining plate. The retaining plate may cover the tracks, e.g., to protect the track(s) from debris. The retaining plate may facilitate affixing the track(s) to the casing. The retaining plate may be included in a labyrinth cover system, e.g., to protect the tracks from debris. A sliding bar may (e.g., reversibly) slide along the track. Balls may be disposed of between the sliding bar and the track, e.g., to minimize friction. The track may have an upward-pointed cross section similar to an arrowhead, and the bar may be configured to contact the track at two contact points, e.g., to minimize friction.

In another aspect disclosed herein is a lid assembly configured to seal a top opening. The top opening may be of a container. In some embodiments, the top opening is of a build module. The lid assembly may be configured to (e.g., reversibly) (a) couple to the opening such that a vertical translation is prevented with respect to the opening, (b) couple to the opening such that a lateral translation is prevented (outside of a pre-determined pivoting range), (c) couple with the maneuvering mechanism, (d) seal the build module, (e) decouple from the opening such that a vertical translation is allowed with respect to the opening, (f) decouple from the opening such that a lateral translation is allowed (regardless of a pre-determined pivoting range), (g) decouple from the maneuvering mechanism, (d) unseal the build module, (h) handled with handles, (i) stored while being at least partially disposed of in an interior space casing, or (j) any combination thereof. The lid assembly may comprise one or more portions. The lid assembly may comprise a plate, a ring, or a seal. The lid assembly may comprise a lid opening. For example, the lid assembly may comprise a first type of lid opening and a second type of lid opening. The lid opening may run through a portion of the thickness of the lid assembly, e.g., and not through the entire thickness of the lid assembly. For example, the lid opening may be in the first plate of the lid assembly, and absent in the second plate of the lid assembly. The lid opening may be configured to facilitate rotation (e.g., partial rotation, or pivoting) of the first plate relative to the second plate. The handles of the lid assembly may facilitate placement of the lid assembly on the top opening, e.g., to engage the lid assembly with the top opening and cover the top opening, e.g., build module opening. The handles of the lid assembly may facilitate rotation (e.g., partial rotation) of the lid assembly relative to the top opening. At times, engagement with the first opening (e.g., central opening) of the lid assembly may facilitate partial rotation (e.g., first pivoting motion) of the lid assembly relative to the top opening, e.g., to hinder the vertical movement of the lid assembly with respect to the top opening. At times, engagement with the first opening (e.g., central opening) of the lid assembly may facilitate another partial rotation (e.g., second pivoting) of the first plate of the lid assembly relative to the second plate of the lid assembly, e.g., to compress a seal and seal the top opening. The engagement with the first opening may be with a pivoting tool such as a drive spinner or a ratchet. At times, the second pivoting motion may take place (e.g., substantially) after, or at least partially contemporaneous with, the first pivoting motion. The second pivoting may be initiated after the first pivoting motion is initiated. The second pivoting may be initiated once the first pivoting motion (e.g., substantially) ended. The second pivoting may translate an engager engaged with an engager receptacle's cavity, further into a distal portion of the engager receptacle's cavity that has a ceiling. The distal portion of the cavity may have a floor disposed at a different vertical location as compared to the portion of the cavity closer to the top opening of the cavity. The distal portion of the cavity may be narrower, e.g., having a lower height. The change in the height of the cavity may be gradual or abrupt. The change in the vertical floor position of the cavity, may be gradual or abrupt. Translation of the engager to the distal portion of the engager receptacle's cavity may cause the seal to compress.

In another aspect disclosed herein is the maneuvering mechanics of the lid assembly. The maneuvering mechanism may be (e.g., reversibly) coupled with the lid assembly, e.g., using a lock pin. The lock pin may transition between a first position and a second position. Transitioning between the first and second positions of the lock pin may be manual and/or automatic. For example, a user may rotate (e.g., partially rotate, or pivot) the lock pin to secure the maneuvering mechanism to the lid assembly in the first position. For example, a user may rotate (e.g., partially rotate, or pivot) the lock pin to release the maneuvering mechanism from the lid assembly in the first position in a first direction. The user may rotate (e.g., partially rotate, or pivot) the lock pin to couple the maneuvering mechanism and the lid assembly in the first position in a direction opposing the first direction. For example, the first direction may be clockwise, and the opposing direction may be counter clockwise. The rotation may be about the central axis of the pin's length. In some examples, the reversible release and secure of the lid assembly using the lock pin may be with respect to the mechanical arm of the maneuvering mechanism. The maneuvering mechanism may translate the lid mechanism into space. For example, the maneuvering mechanism may translate the lid and/or lid assembly in a first plate. Maneuvering in the first plate may comprise at least one maneuver type. In some examples, maneuvering in the first plate may comprise at least two maneuver types. At least one maneuver type in the first plate may comprise translation and pivoting. The translation may be along a first axis disposed of in the first plane. The pivoting may cause the lid assembly to translate from one position contacting the first axis to another position on the first axis, the pivoting is about a second axis normal to the first axis. The mechanical arm may have a stopping portion to restrict partial rotation of the lid assembly (and of the mechanical arm) to the extent of the pivoting motion in one pivoting direction. A second portion of the mechanical arm may restrict its partial rotation in a second pivoting direction opposing the one pivoting direction. For example, the second portion of the mechanical arm may be configured to contract the coupler (e.g., torque hinge) and/or the sliding bar. The maneuvering mechanism may be configured to facilitate the movement of the mechanical arm and/or of the lid assembly from the first plane to a second plane. The second plane may form an angle with the first plane. The angle can be at least about 30°, 45°, 75°, or 90°. For example, the second plane is (e.g., substantially) normal to the first plane. The movement may be a partial rotation, e.g., a pivoting movement. The pivoting movement may be along a third axis. The third axis may be (e.g., substantially) parallel to the first axis. The third axis may be along, or parallel to, the direction of translation of a translation mechanism translating the lid assembly and/or the mechanical arm.

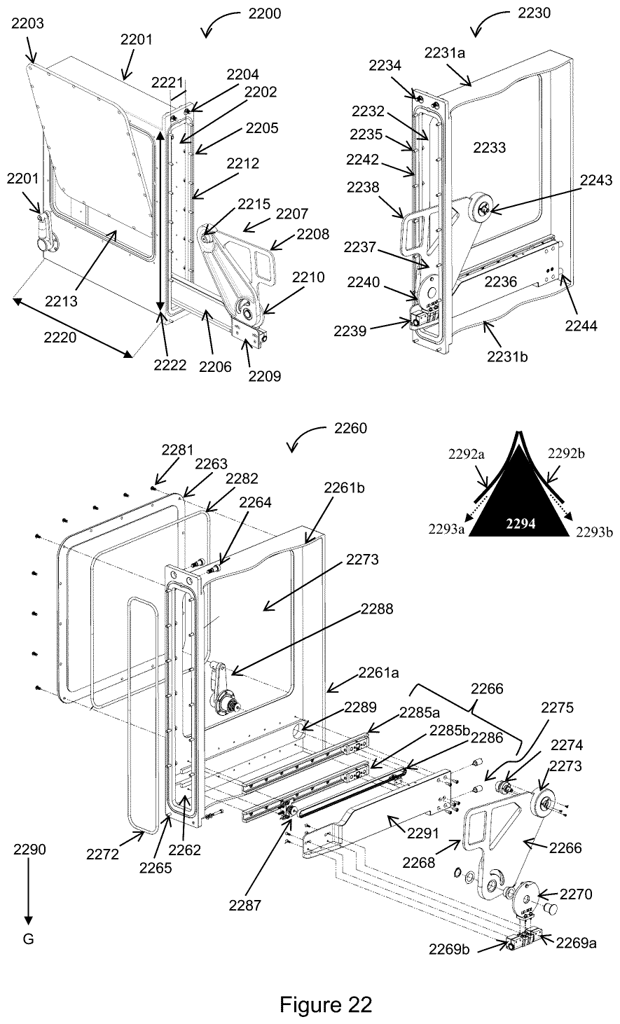

In another aspect disclosed herein is a casing. The casing can have one or more openings. The casing can have an interior space having a first opening configured to accommodate: the maneuvering mechanism of the lid (e.g., lid assembly), the lid assembly, or the maneuvering mechanism and the lid assembly. The casing can have an interior space configured to enclosure a height (e.g., FIG. 22, 2222) of, and an opening having a height configured to accommodate a height of: the maneuvering mechanism of the lid (e.g., lid assembly), the lid assembly, or the maneuvering mechanism and the lid assembly. The casing can have an interior space configured to enclosure a width of, and an opening having a width (e.g., FIG. 22, 2221) configured to accommodate a width of: the maneuvering mechanism of the lid (e.g., lid assembly), the lid assembly, or the maneuvering mechanism and the lid assembly. The casing can have an interior space configured to enclosure a length (e.g., FIG. 22, 2220) of: the maneuvering mechanism of the lid (e.g., lid assembly), the lid assembly, or the maneuvering mechanism and the lid assembly. The lid can be configured to operatively couple (e.g., connect to) a translation mechanism, e.g., as disclosed herein. The translation mechanism can comprise a scissor jack, a railing system, an encoder, a lead (e.g., guiding) screw, an actuator, or any other translation mechanism disclosed herein. The casing may comprise a first opening and a second opening. The first opening may be devoid of closure. The second opening may comprise a closure. The closure may be affixed to the second opening, e.g., using fastener(s) (e.g., screws, nails, or snap fit). The closure may be any closure of the casing opening disclosed herein. The closure may be (e.g., reversibly) removable, e.g., during installation and/or maintenance. A seal may be disposed between the closure and the casing. The seal may be compressible. The seal may be any seal disclosed herein, e.g., comprising O-ring. The seal may include a porous material, a compressible material, and/or an elastic material. The casing may be configured to enclose and control (e.g., maintain) an internal environment different from an ambient environment, e.g., during operation. The casing may be configured to facilitate the translation of the maneuvering mechanism. In an example, the casing is configured to facilitate translation of the translation mechanism, the mechanical arm, and/or the lid assembly. The translation can be toward the interior of the casing. The translation can be to a position outside of the casing. The casing may be operatively (e.g., physically) coupled with a force source that actuates translation of the translation mechanism. The Force source may comprise hydraulic (e.g., gas) force, pneumatic force, magnetic force, or electric force. Initiation of the force may be manually, partially manually, or automatically such as by using the controller(s). at least a portion of the railing system (e.g., the track(s)) may be affixed to the casing, e.g., to the interior of the casing. The casing may facilitate manual control of the translation, e.g., by being coupled with a manual translation initiator. The manual translation initiator may comprise a handle or an input device. The handle may be rotatable, e.g., manually rotatable. The handle may be operatively coupled with an actuator, e.g., a gear. Rotation of the handle may cause translation of the translation mechanism, e.g., as described herein. The input device may be operatively coupled with an actuator, e.g., a gear. The input may cause translation of the translation mechanism, e.g., as described herein. The input device may comprise a button. The button may be a toggle button, e.g., an on/off button. The input device may comprise audio, visual, or tactile input. The input device may comprise a keyboard, touchscreen, a microphone. The casing may be configured to physically connect to a chamber. The chamber may comprise a processing chamber or an unpacking chamber. The chamber may be used in 3D printing, e.g., for printing and/or for unpacking printed object(s). The casing may be configured to store a lid assembly configured to close (e.g., and shut) a build module. The build module may house pre-transformed material and/or 3D objects(s).

In some embodiments, the build module houses pre-transformed material and/or 3D objects(s). The pre-transformed material may be a starting material for a 3D printing process or a remainder of the starting material that did not generate the 3D object(s). The pre-transformed material may be a powder material. The housed pre-transformed material and/or 3D object(s) may be reactive under normal operating conditions with active agent(s) in the ambient environment (e.g., atmosphere). Exposure of the housed pre-transformed material and/or 3D object(s) to the ambient environment may cause harm to the pre-transformed material, to the 3D object(s), and/or to the user. For example, the pre-transformed material may undergo a violent reaction such as a combustive and/or explosive reaction. For example, the pre-transformed material may undergo passivation. For example, interior and/or exterior portions of the 3D object(s) may undergo passivation. For example, interior and/or exterior portions of the 3D object(s) may experience cracking and/or dislocations. The passivation may comprise oxidation. The pre-transformed material may comprise elemental metal, metal alloy, an allotrope of elemental carbon, a ceramic, a polymer, or a resin. In some embodiments, the pre-transformed material may comprise elemental metal or metal alloy.

In some embodiments, the build module is sealed with the lid assembly, e.g., facilitating adherence to safety standards prevailing in the jurisdiction. Adhering to the safety standards may comprise deterring a harmful event (e.g., a violent reaction). Adhering to the safety standards may be done at least in part by limiting the oxidizing gas and/or humidity concentration in the build module (e.g., during storage). The limit may be based at least in part on the standard in the jurisdiction. Example standards may include combustion and/or ignition related standards, fire related standards (e.g., American Society for Testing and Materials International (ASTM), Occupational Safety and Health Administration (OSHA), Hazard Communication Standard (HCS), Material Safety Data Sheet (MSDS), and/or National Fire Protection Association (NFPA)). The harmful event may comprise combustion, ignition, flaring, fuming, burning, bursting, explosion, eruption, smelting, flaming, or explosion. The violent reaction may be exothermic. The violent reaction may be difficult to contain and/or control once it initiates. The violent reaction may be thermogenic. The violent reaction may exert heat. The violent reaction may comprise oxidation. The build module may be configured for purging. Purging may comprise the evacuation of a gas (e.g., comprising the reactive agent) from the build module. In some embodiments, the closed build module is not purged. In some embodiments, the closed build module comprises a relief valve.

The present disclosure provides three-dimensional (3D) printing apparatuses, systems, software, and methods for forming a 3D object. For example, a 3D object may be formed by the sequential addition of material or joining of starting material (e.g., pre-transformed material or source material) to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid phase.

The 3D printing process may comprise printing one or more layers of hardened material in a building cycle, e.g., in a printing cycle. A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single material bed). One or more 3D object(s) may or may not be physically anchored to the platform (e.g., a build platform) above which it/they are printed.

Pre-transformed material (also referred to herein as “starting material”), as understood herein, is material before it has been transformed (e.g., once transformed) by an energy beam during an upcoming 3D printing process, e.g., it is a starting material for an upcoming 3D printing process. The pre-transformed material may be a material that was or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may have been transformed by a 3D printer process prior to the upcoming 3D printing process. For example, in the first 3D printing process (having a first build cycle), powder material was used to form a 3D object. The remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

In some embodiments, in a 3D printing process, the deposited pre-transformed material may be fused (e.g., sintered or melted), bound, or otherwise connected to form at least a portion of the requested 3D object. Fusing, binding, or otherwise connecting the material is collectively referred to herein as “transforming” the material. Fusing the material may refer to melting, smelting, or sintering a pre-transformed material.

In some embodiments, melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object but may be utilized to generate one or more 3D objects simultaneously (e.g., in parallel) or separately (e.g., sequentially). The plurality of 3D objects may be formed in one or more material beds (e.g., powder bed). In some embodiments, a plurality of 3D objects is formed in one material bed.

In some examples, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), arc welding (e.g., powder based arc welding), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In an aspect provided herein is a system for generating a 3D object comprising: an enclosure for accommodating at least one planar layer of pre-transformed material (e.g., powder); at least one energy (e.g., energy beam) capable of transforming the pre-transformed material to form a transformed material; and at least one controller (e.g., as part of a control system) that directs the energy beam(s) to impinge on the exposed surface of the layer of pre-transformed material and translate along a path (e.g., as described herein). The transformed material may be capable of hardening to form at least a portion of a 3D object. The system may comprise at least one energy source generating the energy beam(s), at least one optical system, a layer dispensing mechanism such as a recoater, gas source(s), pump(s), nozzle(s), valve(s), sensor(s), display(s), chamber(s), processor(s) comprising or software inscribed on a computer-readable media/medium. The control system may be configured to control attributes including temperature, pressure, gas flow, optics, actuator(s), energy source(s), energy beam(s), and/or atmosphere(s). The chamber may comprise a base (e.g., build platform) and a substrate. The substrate may comprise a piston. The system for generating at least one 3D object (e.g., in a printing cycle) and its components may be any 3D printing system. Examples of 3D printers, their components, and associated methods, software, systems, devices, and apparatuses, can be found in International Patent Application Ser. No. PCT/US17/60035, filed Nov. 3, 2017; and in International Patent Application Ser. No. PCT/US22/16550, filed Feb. 26, 2022; each of which is entirely incorporated herein by reference.

In some embodiments, the deposited pre-transformed material within the enclosure is a liquid material, semi-solid material (e.g., gel), or solid material (e.g., powder). The deposited pre-transformed material within the enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, amorphous carbon, carbon fiber, carbon nanotube, diamond, or fullerene. The fullerene may be selected from the group consisting of spherical, elliptical, linear, and tubular fullerene. The fullerene may comprise a buckyball or a carbon nanotube. The ceramic material may comprise cement. The ceramic material may comprise alumina, zirconia, or carbide (e.g., silicon carbide, or tungsten carbide). The ceramic material may include high-performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, a silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., a single material type) or a plurality of materials (e.g., a plurality of material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with a metal alloy. The material may comprise blends excluding (e.g., without) elemental metal or including (e.g., with) metal alloy. The material may comprise stainless steel. The material may comprise a titanium alloy, aluminum alloy, and/or nickel alloy.

In some cases, a layer within the 3D object comprises a single type of material. In some examples, a layer of the 3D object may comprise a single elemental metal type or a single alloy type. In some examples, a layer within the 3D object may comprise several types of material (e.g., an elemental metal and an alloy, an alloy and a ceramic, and an alloy and an elemental carbon). In certain embodiments, each type of material comprises only a single member of that type. For example, a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than one member of a type of material.

In some examples, the material bed, and/or 3D printing system (or any component thereof such as a build platform) may comprise any material disclosed herein. The material may comprise a material type in which constituents (e.g., atoms) readily lose their outer shell electrons, resulting in a free-flowing cloud of electrons within their otherwise solid arrangement. The material bed may comprise a particulate material (e.g., powder). In some examples, the material (e.g., powder, and/or 3D printer component) may comprise a material characterized by having high electrical conductivity (e.g., at least about 1*10⁵ Siemens per meter (S/m)), low electrical resistivity (e.g., at most about 1*10⁻⁵ ohm times meter (Ω*m)), high thermal conductivity (e.g., at least about 10 Watts per meter times Kelvin (W/mK)), or high density (e.g., at least about 1.5 grams per cubic centimeter (g/cm³)). The density can be measured at ambient temperature (e.g., at R.T., or 20° C.) and at ambient atmospheric pressure (e.g., at 1 atmosphere).

In some embodiments, the elemental metal is an alkali metal, an alkaline earth metal, a transition metal, a rare-earth element metal, a precious metal, or another elemental metal. The elemental metal may comprise Titanium, Copper, Platinum, Gold, Aluminum, or Silver.

In some embodiments, the metal alloy comprises iron-based alloy, nickel-based alloy, cobalt-based alloy, chrome-based alloy, cobalt chrome-based alloy, titanium-based alloy, magnesium-based alloy, or copper-based alloy. The alloy may comprise an oxidation or corrosion-resistant alloy. The alloy may comprise a super alloy (e.g., Inconel, In718, Ti64, F357, Haynes282, GRCop-42, C22, CA6NM, Hastelloy-X). The alloy may comprise an alloy used for aerospace applications, automotive applications, surgical applications, or implant applications. The metal may include a metal used for aerospace applications, automotive applications, or implant applications.

In some embodiments, metal alloys are refractory alloys. Refractory metals and alloys may be used for heat coils, heat exchangers, furnace components, or welding electrodes. The refractory alloys may comprise high melting points, low coefficient of expansion, the mechanically strong, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sports gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one excellent mechanical strength, resistance to thermal creep deformation, good surface stability, resistance to corrosion, and resistance to oxidation. The alloy may include a face-centered cubic austenitic crystal structure. Examples of materials, 3D printers, and associated methods, software, systems, devices, materials (e.g., alloys), and apparatuses, can be found in International Patent Application Ser. No. PCT/US17/60035, filed Nov. 3, 2017; and in International Patent Application Ser. No. PCT/US22/16550, filed Feb. 26, 2022; each of which is entirely incorporated herein by reference.

In some embodiments, the material comprises powder material (also referred to herein as a “pulverous material”). The powder material may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The central tendency of the fundamental length scale (abbreviated herein as “FLS”) of the particles can be from about 5 micrometers (μm) to about 100 μm, from about 10 μm to about 70 μm, or from about 50 μm to about 100 μm. The particles can have a central tendency of the FLS of at most about 75 μm, 65 μm, 50 μm, 30 μm, 25 μm or less. The particles can have a central tendency of the FLS of at least 10 μm, 25 μm, 30 μm, 50 μm, 70 μm, or more. A central tendency of the distribution of an FLS of the particles (e.g., range of an FLS of the particles between largest particles and smallest particles) can be about at least about 5 μm, 10 μm, 20 μm, 30 μm, 40 μm, 53 μm, 60 μm, or 75 μm. The particles can have a central tendency of the FLS of at most about 65 μm. In some cases, the powder particles may have a central tendency of the FLS between any of the afore-mentioned FLSs.

In some embodiments, the powder comprises a particle mixture, in which the particle comprises a shape. The powder can be composed of a homogenously shaped particle mixture such that all the particles have substantially the same shape and FLS magnitude within at most about 1%, 5%, 8%, 10%, 15%, 20%, 25%, 30%, 35%, or 40% distribution of FLS.

In some embodiments, during at least a portion of the 3D printing process, the atmospheres of the build module and processing chamber may be separate. The build plate and/or substrate may be separated from one or more walls (e.g., side walls) of the build module by a seal. The seal may be permeable to at least one gas, and impermeable to the pre-transformed (e.g., and to the transformed) material. The seal may not allow a solid material (e.g., a pre-transformed material and/or a transformed material) to pass through.

At times, a plurality of build modules may be situated in an enclosure comprising the processing chamber. At times, the build module may be connected to or may comprise an autonomous guided vehicle (AGV). The AGV may have at least one of the following: a movement mechanism (e.g., wheels), positional (e.g., optical) sensor, and controller. The controller may enable self-docking (e.g., to a docking station) and/or self-driving of the AGV. The self-docking and/or self-driving may be to and from the processing chamber. The build module may reversibly engage with (e.g., couple to) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent.

In some embodiments, the pre-transformed material (e.g., starting material for the 3D printing) is deposited in an enclosure, e.g., a build module. The build module container can contain the pre-transformed material (e.g., without spillage). Material may be placed in or inserted into the container. The material may be deposited in, pushed to, sucked into, or lifted into a container. The material may be layered (e.g., spread) in the enclosure such as by using a layer dispensing mechanism. The build module container may be configured to enclosure a substrate (e.g., an elevator piston). The substrate may be situated adjacent to the bottom of the build module container. The bottom may be relative to the gravitational field along the gravitational vector pointing towards the gravitational center, or relative to the position of the footprint of the energy beam on the layer of pre-transformed material as part of a material bed. The build module container may comprise a platform comprising a base (e.g., a build plate). The platform may comprise a substrate or a base. The base may reside adjacent to the substrate. For example, the base may (e.g., reversibly) connect to the substrate. The pre-transformed material may be layer-wise deposited adjacent to a side of the build module container, e.g., above and/or on the bottom of the build module container. The pre-transformed material may be layered adjacent to the substrate and/or adjacent to the base. Adjacent to may be above. Adjacent to may be directly above, or directly on. The substrate may have one or more seals that enclose the material in a selected area within the build module container. One or more seals may be flexible or non-flexible. The seal may be a hermetic seal such as a gas-tight seal. One or more seals may comprise a polymer or a resin. The build module container may comprise the base. The base may be situated within the build module container. The build module container may comprise the platform, which may be situated within the build module container. The enclosure, processing chamber, and/or building module container may comprise (I) a window (e.g., an optical window and/or a viewing window) or (II) an optical system. The optical window may allow the energy beam to pass through without (e.g., substantial) energetic loss. During the 3D printing, a ventilator and/or gas flow may prevent debris (e.g., spatter) from accumulating on the surface of the optical window that is disposed of within the enclosure (e.g., within the processing chamber). A portion of the enclosure that is occupied by the energy beam (e.g., during the 3D printing) can define a processing cone (e.g., a truncated processing cone). The 3D printing may comprise the entire 3D printing. The processing cone can be the space that is occupied by a non-reflected energy beam during the (e.g., entire) 3D printing. The processing cone can be the space that is occupied by an energy beam that is directed towards the material bed during the (e.g., entire) 3D printing. 3D printing may comprise during printing of a layer of hardened material.

In some embodiments, the 3D printer comprises a gas conveyance system. The gas conveyance system may be in fluidic contact with one or more enclosures of the 3D printer. For example, the gas conveyance system may be in fluidic contact with (i) a processing chamber, (ii) a build module, (iii) an optical enclosure, or (iv) any combination thereof. The gas conveyance system may be in fluidic contact with a processing chamber and/or a build module. The gas conveyance system may be in fluid communication with the optical enclosure. At times, a gas flow assembly may be in fluid communication with the optical enclosure. The gas flow assembly may be configured to flow gas into and out of the optical enclosure. The gas flow assembly may be separate from the gas conveyance system. For example, the gas conveyance system and the gas flow assembly may be isolated (e.g., fluidically separate) from each other. The gas conveyance system may be configured to flow gas into and out of the processing chamber.

At times, the methods described herein are performed in the enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled pressure. The enclosure may have a predetermined and/or controlled atmosphere. The control may be manual or via a control system. The atmosphere may comprise at least one gas.

In some embodiments, the 3D printer comprises a layer dispensing mechanism. The pre-transformed material may be deposited in the enclosure by a layer dispensing mechanism (also referred to herein as a “layer dispenser,” “layer forming apparatus,” or “layer dispensing mechanism”). The layer dispensing mechanism may comprise a recoater. In some embodiments, the layer dispensing mechanism includes one or more material dispensers (also referred to herein as “dispensers” and “material dispensing mechanism”), and/or at least one powder removal mechanism (also referred to herein as material “remover” or “material remover”) to form a layer of pre-transformed material (e.g., starting material) within the enclosure. The deposited starting material may be leveled by a leveling operation. The leveling operation may comprise using a powder removal mechanism that does not contact the exposed surface of the material bed. The material (e.g., powder) dispensing mechanism may comprise one or more dispensers. The material dispensing mechanism may comprise at least one material (e.g., bulk) reservoir. The material may be deposited by a layer dispensing mechanism (e.g., recoater). The layer dispensing mechanism, or a component thereof, may level the dispensed material without contacting the material bed (e.g., the top surface of the powder bed). The layer dispensing mechanism and energy beam can translate and form the 3D object adjacent to the platform, while the platform gradually lowers its vertical position to facilitate the layer-wise formation of the 3D object. The layer dispensing mechanism and energy beam can translate and form the 3D object within the material bed (e.g., as described herein), while the platform gradually lowers its vertical position to facilitate layer-wise formation of the 3D object. The layer dispensing mechanism can be used to form at least a portion of the material bed. The layer dispensing mechanism can dispense material, remove material, and/or shape the material bed, e.g., shape an exposed surface of a layer of material of the material bed. The material can comprise a pre-transformed material or debris. Shaping the material bed may comprise altering the shape of the exposed surface of the material bed, e.g., planarizing the exposed surface of the material bed. The layer dispensing mechanism can be in a layer-forming mode when dispensing the material and/or shaping the material bed. The layer dispensing mechanism can be in a parked mode when the layer dispensing mechanism is in an idle position such as a parked position. The material dispensing mechanism (e.g., the dispenser) can comprise a reservoir configured to retain a volume of pre-transformed material. The volume of pre-transformed material may be equivalent to about the volume of pre-transformed material sufficient for at least one or more dispensed layers above the platform. For example, the volume of pre-transformed material may be equivalent to the volume of starting material sufficient for at least an integer number of dispensed layers above the platform. For example, the volume of pre-transformed material retained within the reservoir can be at least about 2 cubic centimeters (cc), 15 cc, 20 cc, 50 cc, 100 cc, 250 cc, 1500 cc, 2000 cc, or 2500 cc. The material dispensing mechanism can comprise a reservoir configured to retain a volume of pre-transformed material that can be between any of the afore-mentioned amounts, for example, from about 2 cc to about 2500 cc. The material dispensing mechanism can dispense material at a dispensing rate (e.g., flow rate from the material dispensing mechanism) of at least 0.2 cubic centimeters per second (cm³/sec) or (cc/sec), 0.5 cc/sec, 2 cc/sec, 2.5 cc/sec, 3.5 cc/sec, 5 cc/sec, 10 cc/sec, 30 cc/sec, 50 cc/sec, 75 cc/sec, 90 cc/sec, 100 cc/sec, 110 cc/sec, 125 cc/sec, or 150 cc/sec. The dispensing rate can be between any of the afore-mentioned dispensing rates (e.g., from about 2 cc/sec to about 150 cc/sec). The layer dispensing mechanism may include components comprising a material dispensing mechanism, material leveling mechanism, material removal mechanism, or any combination or permutation thereof.

In some embodiments, the layer dispensing mechanism includes a leveler to planarize (e.g., smooth, such as substantially planarize) an exposed surface of a material bed within the enclosure. In some embodiments, the layer dispensing mechanism is devoid of a leveler to planarize (e.g., smooth, such as substantially planarize) an exposed surface of a material bed within the enclosure. The layer dispensing mechanism and energy beam can translate (e.g., in a coordinated manner) to print the 3D object adjacent to the build platform, e.g., while the build platform gradually lowers its vertical position to facilitate layer-wise formation of the 3D object. The layer dispensing mechanism and energy beam can translate to print the 3D object in the material bed (e.g., as described herein), e.g., while the build platform gradually lowers its vertical position to facilitate layer-wise formation of the 3D object and expansion of the material bed. from the material bed, and/or shape the material bed, e.g., shape an exposed surface of a layer of material of the material bed. The material can comprise a pre-transformed material or debris. Examples of 3D printing systems, apparatuses, devices, and components (e.g., material dispensing mechanisms and material removal mechanisms), controllers, software, and 3D printing processes can be found in Patent Application serial number PCT/US15/36802 filed on Jun. 19, 2015; in U.S. patent application Ser. No. 17/881,797, filed Aug. 5, 2022; or in International Patent Application serial number PCT/US16/66000 filed on Dec. 9, 2016; each of which is incorporated herein in its entirety.

In some embodiments, the layer dispensing mechanism may reside within an ancillary chamber. The layer dispenser may be physically secluded from the processing chamber when residing in the ancillary chamber. The ancillary chamber may be connected (e.g., reversibly) to the processing chamber. The ancillary chamber may be connected (e.g., reversibly) to the build module. The ancillary chamber may convey the layer dispensing mechanism adjacent to a platform (e.g., that is disposed within the build module). The layer dispensing mechanism may be retracted into the ancillary chamber (e.g., when the layer dispensing mechanism does not perform dispensing). Examples of 3D printing systems, apparatuses, devices, and components (e.g., material dispensing mechanisms and material removal mechanisms), controllers, software, and 3D printing processes can be found in Patent Application serial number PCT/US15/36802 filed on Jun. 19, 2015; in Provisional Patent Application Ser. No. 62/317,070 filed Apr. 1, 2016; in International Patent Application serial number PCT/US16/66000 filed on Dec. 9, 2016; in International Patent Application Ser. No. 62/265,817, filed Dec. 10, 2015; or in Provisional Patent Application Ser. No. 63/357,901, filed on Jul. 1, 2022; each of which is incorporated herein in its entirety

In some embodiments, the 3D object(s) are printed from a material bed. At least one FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m or 5 m. At least one FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, an FLS of the material bed is in the direction of the gas flow. In some embodiments, the build platform has the at least one FLS of the material bed. In some embodiments, the build module has the at least one FLS of the material bed, or greater.

In some embodiments, the 3D printer has the capacity to complete at least 1, 2, 3, 4, or 5 printing cycles before requiring human intervention. Human intervention may be required for refilling the pre-transformed (e.g., powder) material, unloading the build modules, unpacking the 3D object, removing the debris byproduct of the 3D printing, or any combination thereof. The 3D printer operator may condition the 3D printer at any time during the operation of the 3D printing system (e.g., during the 3D printing process). Conditioning of the 3D printer may comprise refilling the pre-transformed material that is used by the 3D printer, replacing the gas sources, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some examples, the 3D printing system requires the operation of a maximum of one operator during a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some embodiments, the enclosure and/or processing chamber of the 3D printing system may be opened to the ambient environment sparingly. In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer. In some embodiments, the 3D printer has a capacity of 1, 2, 3, 4, or 5 full prints in terms of pre-transformed material (e.g., starting material such as powder) reservoir capacity. The 3D printer may have the capacity to print a plurality of 3D objects in parallel, e.g., in one material bed. For example, the 3D printer may be able to print at least 2, 3, 4, 5, 6, 7, 8, 9, or 10 3D objects in parallel.

In some embodiments, the printed 3D object is retrieved after terminating the last transformation operation as part of the 3D printing. After terminating may be at most about 60 days, 30 days, 30 days, 7 days, 5 days, 1 day, 12 hours, 6 hours, 3 hours, 2 hours, 1 hour, 30 minutes, 15 minutes, 5 minutes, 240 seconds (sec), 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after terminating may be between any of the afore-mentioned time values (e.g., from about 1 s to about 60 days, from about 10 days to about 60 days, from about 1 day to about 10 days, from about 1 s to about 1 hour, from about 30 minutes to about 1 day, from about 20 s to about 240 s).

At times, the 3D object(s) are at an elevated temperature once the 3D printing of a print cycle ends. When the 3D object(s) are printed in a material bed, the material bed may be at an elevated temperature once the 3D printing ends. The elevated temperature may hinder the unpacking of the 3D object from the build module. The elevated temperature may be too hot for handling, e.g., by an operator and/or machinery. The elevated temperature may cause the 3D object(s) to be vulnerable to change. The change may comprise a structural change or a material change. The elevated temperature may cause the 3D object(s) to be malleable. At times, it may be requested to cool the build module until the 3D object(s) and/or material bed reaches a handling temperature. At times, it may be logistically advantageous to store the build module for unpacking the 3D object(s). The 3D object(s) stored in the build module may comprise the remainder of the starting material. The remainder of the starting material may be reactive. The reactivity of the starting material may be enhanced at elevated temperatures. For example, the remainder of starting material disposed of in the build module once the 3D printing ends may comprise powdered titanium at a temperature of hundreds of degrees Celsius. Such powder may be highly reactive with the ambient atmosphere, e.g., with oxygen and/or water in the ambient atmosphere. At times, it may be advantageous to unpack the 3D object(s) from the build module in a controlled environment, e.g., due to reactivity of the remainder material and/or of the 3D object such as an exposed surface of the 3D object. The controlled environment may have at least one atmospheric characteristic that is different from that of the ambient atmosphere. At least one atmospheric characteristic may be any of the ones disclosed herein. At least one atmospheric characteristic may comprise pressure, temperature, gas makeup, or a concentration of the reactive agent. The build module may be closed with a lid assembly that facilitates controlling (e.g., maintaining) the internal environment of the build module during storage. For example, the lid assembly may hermetically seal the top opening of the build module. The lid assembly may be (i) disposed in the internal environment of the chamber during processing, and (ii) close the top opening of the build module in the internal environment of the chamber during idle time. In some embodiments, the processing time comprises 3D printing, and idle time comprises a lack of 3D printing. For example, in the processing chamber: the lid assembly is stored during printing and is retrieved from its storage position after the printing to close the build module. In some embodiments, the processing time comprises active unpacking, and idle time comprises a lack of unpacking. For example, in the unpacking chamber: the lid assembly is taken off the build module to open the top of the build module, and the lid assembly is placed in a storage position.

In some embodiments, the build module is designed to maintain the 3D object within an atmosphere suitable for transport and/or stationary storage. The stationary storage may be in a waiting station, e.g., an individual waiting station for a build module. The waiting station can be a collective waiting station, which can accommodate a plurality of individual waiting stations. The build module can comprise a boundary (e.g., comprising one or more walls) that defines an internal volume configured to store the 3D object in an internal environment, e.g., atmosphere. During storage, the build module may be resting (e.g., kept in one location), or be in transit (e.g., from one location to another). The build module may be stored at ambient temperature (e.g., room temperature). The build module can comprise an opening within the boundary (e.g., within at least one of the walls) that is designed to couple with the processing chamber and have a shape and size suitable for passing the 3D object therethrough. The build module can comprise the lid assembly that is configured to close the top opening. The lid assembly may form a seal between the internal environment of the build module and an ambient atmosphere outside of the build module. The lid assembly and/or material of the build module may deter atmospheric exchange between the internal volume of the build module and the ambient environment. The internal environment may comprise a pressure different (e.g., higher) than the one in the ambient pressure. In some embodiments, the internal environment comprises a pressure above ambient pressure. The internal volume of the build module may comprise a gas that has a reduced reactivity with the pre-transformed material, e.g., before, after, and/or during the printing. The build module (e.g., closed build module) may comprise an atmosphere that has a reduced reactivity with a remainder of starting material that did not form the 3D object(s) during the 3D printing. The build module internal atmosphere can be (a) above ambient pressure, (b) inert, (c) different from the ambient atmosphere, (d) has a reduced level of reactivity with the pre-transformed material and/or 3D object(s) such as during the 3D printing, (e) comprises a reactive agent below a threshold value, or (f) any combination thereof. The 3D object, remainder material, and/or starting material, may be stored in the closed build module for a period. For example, contents within the internal volume of the closed build module can be stored in any of atmospheres (a), (b), (c), (d), (e), or (f) supra for a period between processing operations. The processing operations may take place after printing the 3D object(s) and before removing the 3D object(s) from the build module, e.g., when the build module is decoupled (e.g., detached) from the processing chamber. In some cases, the storage period may be at least about 0.5 day, 1 day, 2 days, 3 days, 4 days, 5 days, 6 days, 7 days, 10 days, 30 days, or 60 days. The period may be any period between the afore-mentioned periods (e.g., from about 0.5 day to about 60 days, from about 0.5 day to about 4 days, from about 1 day to about 10 days, or from about 10 days to about 60 days). The storage period may be limited by the reduction rate of the pressure in the closed build module, and/or the leakage rate of a relative agent in the ambient environment into the build module. The reactive agent may comprise oxygen, water, or hydrogen sulfide. The concentration of reactive species (e.g., reactive agent) in the closed build module may be controlled. The control may be to maintain a level below a threshold value. The threshold value may correspond to a detectable degree of a reaction product of the reactive agent with the pre-transformed material. The threshold value may correspond to a detectable degree of a reaction product of the reactive agent with the pre-transformed material that causes at least one detectable defect in the material properties and/or structural properties of the pre-transformed material and/or 3D object. The reaction product may be generated on the surface of the 3D object and/or of the pre-transformed material, e.g., on the surface of the particles of the particulate material. The reaction may occur following an engagement of the build module with the chamber, e.g., processing chamber or unpacking chamber. The reaction may occur during the release of the internal atmosphere of the build module into the processing chamber (e.g., followed by 3D printing). The reaction may occur during the 3D printing. The reaction may cause defects in the material properties (e.g., cracking) and/or structural properties (e.g., warping) of the 3D object. The threshold may correspond to the threshold of the depleted or reduced level of the reactive agent. The threshold value may correspond to the reactive agent in the internal volume of the build module. The reactive agent may comprise water (e.g., humidity) or oxygen. The threshold value of oxygen may be at most about 5 ppm, 10 ppm, 50 ppm, 100 ppm, 150 ppm, 300 ppm, or 500 ppm. The threshold value of oxygen may be between any of the afore-mentioned values (e.g., from about 5 ppm to about 500 ppm, from about 5 ppm to about 300 ppm, or from about 5 ppm to about 100 ppm). The build module may be configured to accommodate at least about 5 liters, 15 liters, 25 liters, or 30 liters of starting material. The platform may be configured to support at least about 5 liters, 15 liters, 25 liters, or 30 liters of starting material. The build module (in its closed configuration) may be configured to permit accumulation (in the internal volume of the build module) of water weight per liter of pre-transformed material for a prolonged period. The closed build module may be configured to permit accumulation (in the internal volume of the build module) of water weight of at most about 10 micrograms (μgr), 50 μgr, 100 μgr, 500 μgr, or 1000 μgr, per liter of starting material (e.g., powder), for the duration of the storage period. The build module in a closed state may be configured to permit the accumulation of water weight between any of the aforementioned values (e.g., from about 10 μgr to about 1000 μgr, from about 10 μgr to about 500 μgr, or from about 100 μgr to about 1000 μgr), per liter of starting material, for the duration of the storage period. The closed build module may be configured to limit an ingress (e.g., leakage or flow) of water into the internal volume of the build module. For example, the water may penetrate the internal volume of the build module from an external water source such as a water source that contacts the build module, e.g., contacting the sealing area, seal material, material of the lid assembly and/or build module boundary material. For example, water may penetrate the internal volume of the build module from the ambient environment. The ingress of water into the internal volume of the build module may be at a rate of at most about 10 micrograms per day (μgr/d), 50 μgr/d, 100 μgr/d, 500 μgr/d, or 1000 μgr/d. The ingress of water into the internal volume of the build module may be at a rate between any of the afore-mentioned rates (e.g., from about 10 μgr/d, to about 1000 μgr/d, from about 10 μgr/d, to about 500 μgr/d, or from about 10 μgr/d to about 100 μgr/d). The internal environment of the build module may be controlled to be (e.g., substantially) the same as the internal environment in the processing chamber during printing, e.g., as disclosed herein. The internal environment of the build module may be controlled to be (e.g., substantially) the same as the internal environment in the unpacking chamber during unpacking, e.g., as disclosed herein. For example, the gas composition of the chamber can contain a level of humidity that corresponds to a dew point of at most about −10° C., −15° C., −20° C., −25° C., −30° C., −35° C., −40° C., −50° C., −60° C., or −70° C. For example, the atmospheric pressure may have a pressure of at least about 10 kilopascals (kPa), about 12 kPa, about 14 kPa, about 16 kPa, about 18 kPa, and about 20 kPa above ambient pressure external to the build module. Maintaining a reduced level of reactive agent (e.g., such as by keeping a positive pressure of inert gas in the build module for a prolonged amount of time) can allow the contents of the build module to be kept in any of the atmospheres (a), (b), (c), (d), (e), or (f) supra, for example, with minimal (e.g., without) exposure to an external environment such as ambient air. In some cases, the build module is transported using a transit system, which may comprise movement by vehicle, car, train, boat, or aircraft such as a drone. The transit system may comprise a forklift. The build module can be robotically and/or manually transported. The transportation may comprise transit between locations in a facility, or locations between facilities. Transportation may comprise transit between neighborhoods, municipalities, states, countries, continents, or global hemispheres. The build module may comprise and/or may be operatively coupled with at least one sensor for detecting certain qualities of the internal atmosphere within the internal volume (e.g., pressure, temperature, types of reactive agent, and/or amounts of reactive agent). The build module may comprise at least one controller that controls (e.g., regulates, maintains, and/or modulates) (i) a level of the reactive agent in the build module, (ii) a pressure level in the build module, (iii) a temperature in the build module, or (iv) any combination thereof. The build module may be configured to allow cooling or heating of the internal volume. A controller may control a temperature alteration of the build module (e.g., internal volume thereof), e.g., to reach a threshold value, e.g., at a certain rate. The rate may be predetermined. The rate may comprise a temperature alteration function (e.g., linear, or non-linear). For example, the build module (e.g., its internal volume) may be cooled to a handling temperature. For example, the build module may be heated to a temperature at which water parts (e.g., separates) from the starting material. For example, the build module may be heated to a pyrolytic temperature. The sensor and controller may be separate units or part of a single detector-controller unit. The build module may comprise at least one opening port configured to allow gas to pass to and/or from the internal volume. The opening port can be operatively coupled with a valve, a secondary pressurized gas source (e.g., gas cylinder or valve), or any combination thereof. The build module can comprise mechanisms and/or (e.g., structural) features that facilitate engagement with the chamber (e.g., through a load lock). The chamber may comprise the processing chamber or the unpacking chamber. The build module can comprise mechanisms and/or (e.g., structural) features that facilitate 3D printing, e.g., a vertically translatable platform. For example, the build module can comprise a lifting mechanism (e.g., an actuator configured to vertically translate the platform) configured to move the 3D object within the internal volume. The lifting mechanism can be configured to move the 3D object in accordance with a vertical axis, e.g., as described herein.

Ambient refers to a condition to which people are generally accustomed. For example, ambient pressure may be about 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in non-confined space. For example, “room temperature” can be measured in a room, an office, a facility (e.g., factory), a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. The term “room temperature” may denote 20° C., 25° C., or any value from about 20° C. to about 25° C.

In some embodiments, a time lapse between the end of printing in a first material bed, and the beginning of printing in a second material bed is at most about 60 minutes (min), 40 min, 30 min, 20 min, 15 min, 10 min, or 5 min. The time lapse between the end of printing in a first material bed, and the beginning of printing in a second material bed may be between any of the afore-mentioned times (e.g., from about 60 min to about 5 min, from about 60 min to about 30 min, from about 30 min to about 5 min, from about 20 min to about 5 min, from about 20 min to about 10 min, or from about 15 min to about 5 min). The speed during which the 3D printing process proceeds is disclosed in Patent Application serial number PCT/US15/36802 which is incorporated herein in its entirety.

In some embodiments, the 3D printing system requires the operation of a maximum of a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day). In some embodiments, the 3D printing system requires the operation of a maximum of a single standard work week shift. The 3D printing system may require operation by a human operator working at most of about 50 h, 40 h, 30 h, 20 h, 10 h, 5 h, or 1 h a week. The 3D printing system may require operation by a human operator working between any of the afore-mentioned time frames (e.g., from about 40 h to about 1 h, from about 40 h to about 20 h, from about 30 h to about 10 h, from about 20 h to about 1 h, or from about 10 h to about 1 h a week). A single operator may support during his daily and/or weekly shift at least 1, 2, 3, 4, 5, 6, 7, 8, 9, or 10 3D printers (e.g., 3D printing systems).

In some embodiments, at least one (e.g., each) energy source of the 3D printing system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. At least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr.). At times, 3D printing increases in efficiency when a plurality of energy beams is used for the 3D printing. For example, the time for 3D printing may be shortened when at least two of the plurality of energy beams operate simultaneously at least in part (e.g., in parallel). For example, the time for 3D printing may be shortened by at least about 25%, 50%, 75% or 95% when at least two of the plurality of energy beams operate simultaneously at least in part. The time for 3D printing may be shortened by any value of the afore-mentioned values (e.g., by from about 25% to about 95%, about 25% to about 50%, or about 50% to about 95%) when at least two of the plurality of energy beams operate simultaneously at least in part. A shortened time may be relative to a 3D printing system that does not use a plurality of energy beams (e.g., uses only a single energy beam). Examples of 3D printing systems, apparatuses, devices, components, controllers, software, and 3D printing processes (e.g., speed of printing, throughput of printing) can be found in International Patent Application Ser. No. PCT/US15/36802, and in International Patent Application Ser. No. PCT/US19/226364, filed on May 16, 2019, each of which is incorporated herein by reference in its entirety.

In some embodiments, at least one 3D object is removed from the material bed after the completion of the 3D printing process. For example, the 3D object(s) may be removed from the material bed when the transformed material that formed the 3D object hardens. For example, the 3D object may be removed from the material bed when the transformed material that formed the 3D object is no longer susceptible to deformation under standard handling operations (e.g., human and/or machine handling).

At times, the generated 3D object requires little or no further processing after its retrieval. Further processing may be post-printing processing. Further processing may comprise trimming, annealing, curing, or polishing, e.g., as disclosed herein. Further processing may comprise polishing such as sanding. In some cases, the generated 3D object can be retrieved and finalized without the removal of transformed material and/or auxiliary support features.

In some examples, the generated 3D object adheres (e.g., substantially) to a requested model of the 3D object. Substantially may be with relation to the intended purpose of the 3D object. The 3D object (e.g., solidified material) that is generated can be formed with high fidelity, e.g., having a high fidelity (e.g., high accuracy) of one or more characteristics (e.g., dimensions) of the generated 3D object when compared to a model or simulation of the intended 3D object. For example, have an average deviation percentage from intended dimensions that are at most about 5%, 2%, 1%, 0.5%, 0.25%, 0.1%, 0.05%, or less. For example, the 3D object that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dᵥ+L/K_{dv}, wherein Dᵥ is a deviation value, L is the length of the 3D object in a specific direction, and K_{dv} is a constant. Dᵥ can have a value of at most about 300 μm, 200 μm, 100 μm, 50 μm, 40 μm, 30 μm, 20 μm, 10 μm, 5 μm, 1 μm, or 0.5 μm. Dᵥ can have a value of at least about 0.5 μm, 1 μm, 3 μm, 5 μm, 10 μm, 20 μm, 30 μm, 50 μm, 70 μm, 100 μm, 300 μm or less. Dᵥ can have any value between the afore-mentioned values. For example, Dᵥ can have a value that is from about 0.5 μm to about 300 μm, from about 10 μm to about 50 μm, from about 15 μm to about 85 μm, from about 5 μm to about 45 μm, or from about 15 μm to about 35 μm. K_{dv} can have a value of at most about 3000, 2500, 2000, 1500, 1000, or 500. K_{dv} can have a value of at least about 500, 1000, 1500, 2000, 2500, or 3000. K_{dv} can have any value between the afore-mentioned values. For example, K_{dv} can have a value that is from about 3000 to about 500, from about 1000 to about 2500, from about 500 to about 2000, from about 1000 to about 3000, or from about 1000 to about 2500.

At times, the generated 3D object (i.e., the printed 3D object) does not require further processing following its generation by a method described herein. The printed 3D object may require a reduced amount of processing after its generation by a method described herein. For example, the printed 3D object may not require the removal of auxiliary support (e.g., since the printed 3D object was generated as a 3D object devoid of auxiliary support). The printed 3D object may not require smoothing, flattening, polishing, or leveling. The printed 3D object may not require further machining. In some examples, the printed 3D object may require one or more treatment operations following its generation (e.g., post-generation treatment, or post-printing treatment). The further treatment step(s) may comprise surface scraping, machining, polishing, grinding, blasting (e.g., sand blasting, bead blasting, shot blasting, or dry ice blasting), annealing, or chemical treatment. Examples of 3D printing systems, apparatuses, devices, components, controllers, software, and 3D printing processes (e.g., post-processing, post-generation treatment, and post-printing treatment) can be found in U.S. patent application Ser. No. 15/634,727, filed on Jun. 27, 2017, in International Patent Application Ser. No. PCT/US22/52588, filed Dec. 12, 2022; and in International Patent Application Ser. No. PCT/US22/52902 filed Dec. 14, 2022; each of which is entirely incorporated herein by reference.

At times, the methods described herein are performed in the enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled (e.g., maintained) pressure. The enclosure may have a predetermined and/or controlled atmosphere, e.g., during the 3D printing. The control may be manual or via a control system.

In some embodiments, the 3D printer comprises a chamber having an interior space. The chamber may be referred to herein as a “processing chamber.” The processing chamber may facilitate (e.g., allow) ingress of at least one energy beam into the processing chamber. The energy beam(s) may be directed towards a target surface, e.g., an exposed surface of a material bed. The 3D printer may comprise one or more modules, e.g., build modules. At times, at least one build module may be situated in the enclosure and coupled with the processing chamber. At times, at least one build module engages with the processing chamber to expand an interior volume of the processing chamber, e.g., to form at least a portion of the chamber.

In some embodiments, the 3D printing system comprises a build module. The build module may be mobile or stationary. The build module may comprise an elevation mechanism, e.g., comprising a build platform assembly. The build module may comprise a build platform (e.g., a base) that may be coupled with the build platform assembly. The build platform may be disposed of within the build module. The build platform may reside adjacent to a substrate, e.g., above the substrate relative to a gravitational center of the environment (e.g., Earth). The elevation mechanism may be reversibly connected to (and disconnected from) at least a portion of the build platform. The elevation mechanism may comprise a portion that vertically translates the build platform with respect to a gravitational center (e.g., a gravitational center of the Earth). The build platform may be disposed of on the substrate. The build platform and the substrate may be operatively coupled (e.g., physically connect). A material bed may be disposed of above the build platform. The build platform may support the material bed. The build platform may comprise, or be configured to operatively couple to an engagement mechanism. The substrate may comprise, or be configured to operatively couple to an engagement mechanism. The engagement mechanism may facilitate engagement and/or dis-engagement between a base (e.g., of the build platform) and the substrate. The build platform may be configured to support one or more layers of pre-transformed material (e.g., as part of the material bed). The build platform may be configured to support at least a portion of the 3D object (e.g., during forming of the 3D object). The substrate and/or the base (e.g., build platform) may be removable or non-removable (e.g., from the 3D printing system and/or relative to each other). The substrate and/or base may be fastened (I) to the build module and/or (II) to each other. The build platform and/or substrate may be translatable. The translation of the build platform may be controlled and/or regulated by at least one controller (e.g., by a control system). The translation of the substrate may be controlled and/or regulated by at least one controller (e.g., by a control system). The build platform and/or substrate may be translatable horizontally, vertically, or at an angle (e.g., planar or compound angle). The control system may be any control system disclosed herein, e.g., a control system of the 3D printer such as the one controlling an energy beam. The substrate may comprise a piston. At times, the 3D printing system may comprise more than one substrate. At times, the 3D printing system may comprise more than one piston. The disclosure herein relating to the substrate may apply to the substrates.

In some embodiments, the build module, processing chamber, and/or enclosure comprises one or more seals. The seal may be a sliding seal or a stationary (e.g., top) seal. For example, the build module and/or processing chamber may comprise a sliding seal that meets with the exterior of the build module upon engagement of the build module with the processing chamber. At least a portion of the 3D printing process, the atmospheres of the build module and processing chamber may be separate. For example, the processing chamber may comprise a top seal that faces the build module and is pushed upon engagement of the processing chamber with the build module. For example, the build module may comprise a top seal that faces the processing chamber and is pushed upon engagement of the processing chamber with the build module. The seal may be a face seal or compression seal. The seal may comprise an O-ring. For example, the build module and the processing chamber may be separated by a load lock. The seal may be (e.g., substantially and/or measurably) impermeable to gas. The seal may be permeable to gas. The seal may be impermeable to the pre-transformed (e.g., and to the transformed) material. The seal may be flexible. The seal may be elastic. The seal may be bendable. The seal may be compressible. The seal may include a material comprising rubber (e.g., latex), Teflon, plastic, or silicon. The seal may comprise a mesh, membrane, sieve, paper (e.g., filter paper), cloth such as felt (e.g., Aramid felt, or another high temperature felt or fiber), or a brush. The mesh, membrane, paper, and/or cloth may comprise randomly or non-randomly arranged fibers. The paper may comprise a HEPA filter. The seal may be permeable to at least one gas. The seal may be impermeable to the pre-transformed (e.g., and to the transformed) material. The seal may not allow a pre-transformed (e.g., and to the transformed) material to pass through.

In some embodiments, the substrate is separated from the base (e.g., build platform) assembly by a seal. The base and/or the substrate may be separated from the internal surface of the build module by one or more seals. The seal may be attached to the moving build platform and/or substrate (e.g., while the walls of the build module are devoid of a seal). The seal may be attached to the (e.g., vertical) walls of the build module (e.g., while the build platform and/or substrate is devoid of a seal). In some embodiments, both the build platform and/or substrate and the walls of the build module comprise a seal. The seal may be placed laterally (e.g., horizontally) between one or more walls (e.g., side walls) of the build module. The seal may be connected to the bottom plane of the build platform and/or substrate. The seal may be connected to a side (e.g., circumference) of the build platform and/or substrate. The seal may be permeable to gas. The seal may be impermeable to particulate material (e.g., powder). The seal may not allow the permeation of particulate material into the build platform assembly and/or piston assembly. The build platform assembly may comprise a piston and a build platform. The piston assembly may comprise a piston. The seal may be flexible. The seal may be elastic. The seal may be bendable. The seal may be compressible. The seal may include a material comprising a polymeric material (e.g., nylon, polyurethane), Teflon, plastic, rubber (e.g., latex), or silicon. The seal may comprise a mesh, membrane, sieve, paper (e.g., filter paper), cloth (e.g., felt, or wool), or brush. The mesh, membrane, paper, and/or cloth may comprise randomly and/or non-randomly arranged fibers. The paper may comprise a HEPA filter.

In some embodiments, the build platform is translated, e.g., before, during, and/or after printing one or more 3D objects in a print cycle. The translation may be in both directions (e.g., back and forth such as up and down relative to a gravitational vector). The translation may be vertical. The translation may be effectuated by a build platform assembly and/or an actuator (e.g., controlled by a control system). The build platform assembly may be configured to provide a high-precision platform for building one or more 3D objects in a printing cycle with high fidelity. The build module may accommodate a material bed having at least one (e.g., two or more) FLS (e.g., diameter, width, and/or height) of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 2500 mm, 3000 mm, 3500 mm, 4000 mm, or 4500 mm. The FLS of the material bed accommodated by the build module may have a FLS value between any of the aforementioned values (e.g., from about 100 mm to about 4500 mm, from about 100 mm to about 2000 mm, from about 100 mm to about 700 mm, or from about 300 mm to about 4000 mm). In addition to the material bed, the build module may be configured to accommodate a base (e.g., build platform) and at least one substrate (e.g., piston). The build module may accommodate a build platform having an FLS (e.g., diameter or width) of at least about 100 millimeters (mm), 200 mm, 300 mm, 400 mm, 500 mm, 600 mm, 700 mm, 800 mm, 900 mm, 1000 mm, 1500 mm, or 2000 mm, 2500 mm, 3000 mm, 3500 mm, or 4000 mm. The build module may accommodate a build platform having at least one FLS (e.g., diameter, height, and/or width), the FLS being of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 4000 mm, or 4500 mm. The FLS of the build platform accommodated by the build module may have a FLS value between any of the aforementioned values (e.g., from about 100 mm to about 4500 mm, from about 100 mm to about 1200 mm, from about 100 mm to about 1500 mm, or from about 300 mm to about 2000 mm). The build platform assembly may be able to translate in a continuous and/or discrete manner. The build platform assembly may be able to translate in discrete increments of at most about 5 micrometers (μm), 20 μm, 30 μm, 40 μm, 50 μm, 60 μm, 70 μm, or 80 μm. The build platform assembly may be able to translate in discrete increments having a value between any of the aforementioned values (e.g., from about 5 μm to about 80 μm, from about 10 μm to about 60 μm, or from about 40 μm to about 80 μm). The build platform assembly may have a precision (e.g., error+/−) of at most about 0.25 μm, 0.5 μm, 1 μm, 1.5 μm, 2 μm, 2.5 μm, 3 μm, 4 μm, or 5 μm. The build platform assembly may have a precision value between any of the aforementioned precision values (e.g., from about 0.25 μm to about 5 μm, from about 0.25 μm to about 2.5 μm, or from about 1.5 μm to about 5 μm). The build platform assembly may have a precision (e.g., error+/−) of at most about 0.5%, 1%, 2%, 3%, 4%, 5%, 6%, 8%, or 10% of its incremental movement. The build platform assembly may have a precision value between any of the aforementioned precision values relative to its incremental movement (e.g., from about 0.5% to about 10%, from about 0.5% to about 5%, or from about 1% to about 10%). The weight of the material bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the material bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The build platform assembly may be configured to translate the build module at a speed of at most 3 millimeters per second (mm/sec), 5 mm/sec, 10 mm/sec, 20 mm/sec, 30 mm/sec, or 50 mm/sec. The build platform assembly may be configured to translate the build module at a speed of at least 1 mm/sec, 3 mm/sec, 5 mm/sec, 10 mm/sec, 20 mm/sec, 30 mm/sec, or 40 mm/sec. The build platform assembly may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The build platform assembly may be configured to translate the build module at a speed of at most 1 millimeter per second squared (mm/sec²), 2.5 mm/sec², 5 mm/sec², 7.5 mm/sec², 10 mm/sec², or 20 mm/sec². The build platform assembly may be configured to translate the build module at an acceleration of at least 0.5 mm/sec², 1 mm/sec², 2 mm/sec², 3 mm/sec², 5 mm/sec², 10 mm/sec², or 15 mm/sec². The build platform assembly may be configured to translate the build module at a speed between any of the aforementioned speeds (e.g., from about 0.5 mm/sec² to about 20 mm/sec², from about 0.5 mm/sec² to about 10 mm/sec², or from about 4 mm/sec² to about 20 mm/sec²). The build platform assembly may be configured such that the time to complete a translation of the first portion of the build platform assembly relative to a second portion of the build platform assembly (e.g., to perform a block movement) is at most about 120 seconds (sec), 60 sec, 50 sec, 45 sec, 40 sec, 35 sec, 30 sec, 25 sec, 20 sec, 15 sec, or less. The build platform assembly may be configured such that the time to complete a translation of the first portion of the build platform assembly relative to a second portion of the build platform assembly is any value between the aforementioned values, for example, from about 120 sec to 40 sec, from about 60 sec to 25 sec, or from about 35 sec to 15 sec.

In some embodiments, the pre-transformed material (e.g., starting material for the 3D printing) is deposited in an enclosure to form a material bed. The enclosure may comprise a build module. Material may be placed in or inserted (e.g., deposited) into the build module. The material may be deposited in, pushed to, sucked into, or lifted to the build module. The pre-transformed material may be deposited by a layer dispensing mechanism. The platform may be configured to support one or more layers of pre-transformed material (e.g., as part of the material bed). The platform may be configured to support at least a portion of the 3D object (e.g., during forming of the 3D object). The pre-transformed material may be layer-wise deposited adjacent to a side of the build module, e.g., above and/or on the bottom of the build module. The pre-transformed material may be layered on a target surface, e.g., on an exposed surface of a material or on a surface of the build platform. The deposited layer of pre-transformed material may be substantially planar. For example, the deposited layer may have a central tendency of planarity (e.g., a surface roughness Rₐ) that is from about 15% to about 65% of a second central tendency of thickness of the deposited layer. The second central tendency of thickness of the deposited layer may be about equal to a discrete increment of vertical translation of the platform. The second central tendency of thickness of the deposited layer may be about equal to any discrete increment of vertical translation of the build platform assembly, e.g., as disclosed herein.

In some embodiments, the 3D printer comprises an energy source that generates an energy beam. The energy beam may project energy to the material bed. The apparatuses, systems, and/or methods described herein can comprise at least one energy beam. In some cases, the 3D printing system can comprise at least two, three, four, five, eight, twelve, sixteen, twenty-four, thirty-two, or more energy beams. The energy beam may include radiation comprising electromagnetic, electron, positron, proton, plasma, or ionic radiation. The electromagnetic beam may comprise microwave, infrared, ultraviolet, or visible radiation. The ion beam may include a cation or an anion. The electromagnetic beam may comprise a laser beam. The energy beam may derive from a laser source. in some embodiments, the energy source is an energy beam source. The energy source may be a laser source. The laser may comprise a fiber laser, a solid-state laser, or a diode laser (e.g., diode pumped fiber laser).

In some embodiments, the energy source is a laser source. The laser source may comprise a Nd:YAG, Neodymium (e.g., neodymium-glass), or an Ytterbium laser. The laser beam may comprise a corona laser beam, e.g., a laser beam having a footprint similar to a doughnut shape. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro-laser sintering. Examples of 3D printing systems, apparatuses, devices, and components (e.g., energy beams), controllers, software, and 3D printing processes can be found in International Patent Application Ser. No. PCT/US17/60035, filed Nov. 3, 2017; and in International Patent Application Ser. No. PCT/US22/16550, filed Feb. 26, 2022; each of which is entirely incorporated herein by reference.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process. In some embodiments, the energy beam (e.g., laser) has a power of at least about 150 Watt (W), 200 W, 250 W, 350 W, 500 W, 750 W, 1000 W, or 1500 W. The energy source may have a power between any of the afore-mentioned energy beam power values (e.g., from about 150 W to about 1000 W, or from about 1000 W to about 1500 W). The energy beam may derive from an electron gun.

In some embodiments, the beam profile of the energy beam is altered, e.g., during printing. Any of the 3D printing methodologies disclosed herein can include altering the beam profile. Alteration of the beam profile can be done using a physical component and/or a computational scheme (e.g., algorithm). Alteration of the beam profile can comprise manual and/or automatic methods. The automatic methods may comprise the usage of at least one controller directing the beam profile alteration. The beam profile may be altered during the 3D printing, e.g., during the printing of a layer of transformed material that forms at least a portion of the 3D object. Alteration of the beam profile can comprise alteration of a type of energy profile utilized. The type of beam profile comprises a gaussian beam profile, a top hat beam profile, or a doughnut (e.g., corona) beam profile. For example, the energy beam may print the first portion of the 3D object using a gaussian beam profile, and then print a second portion of the 3D object using a doughnut-shaped beam profile.

In some embodiments, an energy beam is utilized for 3D printing. The energy beam(s) can translate vertically, horizontally, or in an angle (e.g., planar or compound angle). The energy beam(s) can be modulated. The energy beam(s) emitted by the energy source(s) can be modulated.

In some embodiments, the energy beam is moveable with respect to a material bed and/or 3D printing system. The energy beam can be moveable such that it can translate relative to the material bed. The energy beam can be moved by an optical system (e.g., comprising a scanner). The movement of the energy beam can comprise the utilization of a scanner. In some embodiments, the energy source is stationary. In some embodiments, the energy beam (e.g., laser beam) impinges onto an exposed surface of a material bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply. The optical system may be configured to direct at least one energy beam from at least one energy source to a position on a target surface such as an exposed surface of a material bed within the enclosure, e.g., to a predetermined position on the target surface. The 3D printing system may comprise a processor (e.g., a central processing unit). The processor can be programmed to control a trajectory of at least one energy beam and/or energy source with the aid of the optical system. The systems and/or the apparatus described herein can comprise a control system in communication with at least one energy source and/or energy beam. The control system can regulate a supply of energy from at least one energy source to the material in the container. The control system may control the various components of the optical system. The various components of the optical system may include optical components comprising a mirror(s), a lens (e.g., concave, or convex), a fiber, a beam guide, a rotating polygon, or a prism.

In some embodiments, the 3D printer comprises a power supply. The power supply to any of the components described herein can be supplied by a grid, generator, local, or any combination thereof. The power supply can be from renewable or non-renewable sources. Renewable sources may comprise solar, wind, hydroelectric, or biofuel. The power supply can comprise rechargeable batteries.

In some embodiments, the 3D printing system can comprise two, three, four, five, eight, ten, sixteen, eighteen, twenty, twenty-four, thirty-two, thirty-six, or more energy sources that each generate an energy beam (e.g., a laser beam). An energy source can be a source configured to deliver energy to an area (e.g., a confined area). An energy source can deliver energy to a confined area through radiative heat transfer. The energy source may comprise a laser source or an electron beam source.

In some embodiments, the 3D printing system can comprise at least one (e.g., a plurality of) optical windows. The optical window(s) may be arranged on the roof of the processing chamber. The optical window(s) may be arranged on a side wall of the processing chamber. The optical window(s) may be arranged with respect to the processing chamber to allow the transmittance of energy beam(s) directed by the array of optical assemblies into the processing chamber. The optical window(s) may be arranged with respect to the processing chamber to allow transmittance of energy beam(s) directed by the array of optical assemblies into the processing chamber and incident on the target surface supported by the build platform. During the 3D printing, a ventilator and/or gas flow may deter (e.g., measurably and/or substantially prevent) debris from accumulating on the surface optical window(s) that are disposed of within the enclosure (e.g., within the processing chamber). The debris may comprise soot, spatter, or splatter. The optical window may be supported by (or supportive of) a nozzle that directs debris away from the optical window, e.g., towards the material bed. The processing cone may assume a shape of a truncated cone within the processing chamber.

In some embodiments, the 3D printing system comprises one or more sensors. One or more sensors may be at least about 500, 600, 900, or 1000 sensors. At least two of the sensors may be of the same type. At least two of the sensors may be of different types. The 3D printing system includes at least one enclosure. In some embodiments, the 3D printing system (e.g., its enclosure) comprises one or more sensors (alternatively referred to herein as one or more sensors). The enclosure described herein may comprise at least one sensor. The enclosure may comprise, or be operatively coupled with, the build module, the filtering mechanism, the gas recycling system, the processing chamber, or the ancillary chamber. The sensor may be connected and/or controlled by the control system (e.g., computer control system, or controller(s)). The control system may be able to receive signals from at least one sensor. The control system, e.g., through a control scheme, may act upon at least one signal received from at least one sensor. The control scheme may comprise a feedback and/or feed-forward control scheme, e.g., that has been pre-programmed. The feedback and/or feed-forward control may rely on input from at least one sensor that is connected to the controller(s).

In some embodiments, the 3D printing system comprises one or more sensors. One or more sensors can comprise a pressure sensor, a temperature sensor, a gas flow sensor, or an optical density sensor. The pressure sensor may measure the pressure of the chamber (e.g., pressure of the chamber atmosphere). The pressure sensor can be coupled with the control system. The pressure can be electronically and/or manually controlled. The controller may regulate the pressure (e.g., with the aid of one or more vacuum pumps) according to input from at least one pressure sensor. The sensor may comprise a light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise a measurement sensor (e.g., height, length, width, depth, angle, and/or volume). The metrology sensor may comprise a magnetic, acceleration, orientation, or optical sensor. The optical sensor may comprise a camera. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may measure the temperature without contacting the material bed (e.g., non-contact measurements). The weight of the enclosure (e.g., container), or any components within the enclosure can be monitored by at least one weight sensor in or adjacent to the material. One or more position sensors (e.g., height sensors) can measure the height of the material bed relative to the substrate. The position sensors can be optical sensors. The position sensors can determine the distance between one or more energy sources and the surface of the material bed. The exposed surface of the material bed can be the upper surface of the material bed relative to the gravitational center of the environment. Examples of 3D printing systems, apparatuses, devices, material beds, and components (e.g., sensors), controllers, software, and 3D printing processes can be found in International Patent Application Ser. No. PCT/US17/60035, filed Nov. 3, 2017; and in International Patent Application Ser. No. PCT/US22/16550, filed Feb. 26, 2022; each of which is entirely incorporated herein by reference.

In some embodiments, the 3D printer comprises one or more valves. The methods, systems, and/or apparatus described herein may comprise at least one valve. The valve may be shut or opened according to input from at least one sensor, or manually. The degree of valve opening or shutting may be regulated by the control system, for example, according to at least one input from at least one sensor. The systems and/or the apparatus described herein can include one or more valves, such as throttle valves. The valve may or may not comprise a sensor sensing the open/shut position of the valve. The valve may be a component of a gas conveyance system, e.g., operable to control the flow of gas in the gas conveyance system. A valve may be a component of gas flow assembly, e.g., operable to control a flow of gas of the gas flow assembly.

In some embodiments, the 3D printer comprises one or more actuators such as motors. The motor may be controlled by the controller(s) (e.g., by the control system) and/or manually. The motor may alter (e.g., the position of) the substrate and/or to the base. The motor may alter (e.g., the position of) the build platform assembly. The actuator may facilitate translation (e.g., propagation) of the layer dispenser, e.g., the actuator may facilitate reversible translation of the layer dispenser. The motor may alter an opening of the enclosure (e.g., its opening or closure). The motor may be a step motor or a servomotor. The actuator (e.g., motor) may alter (e.g., a position of) one or more optical components, e.g., mirrors, lenses, prisms, and the like. The servomotors may comprise actuated linear lead screw drive motors. The motors may comprise belt drive motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt-driven actuators. The motors may comprise lead screw-driven actuators. The actuators may comprise linear actuators.

In some embodiments, the 3D printer (e.g., its components) comprises one or more nozzles. The systems and/or the apparatus described herein may comprise at least one nozzle. For example, the material remover may comprise a nozzle. The nozzle may be regulated according to at least one input from at least one sensor. The nozzle may be controlled automatically or manually. The controller(s) may control the nozzle. The controller(s) may be any controller(s) disclosed herein, e.g., as part of the control system of the 3D printer. The nozzle may include a jet (e.g., gas jet) nozzle, high-velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., towards the material bed. The nozzle may comprise a venturi nozzle.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. One or more pumps may comprise a positive displacement pump. The positive displacement pump may comprise a rotary-type positive displacement pump, reciprocating-type positive displacement pump, or linear-type positive displacement pump.

In some embodiments, the 3D printer comprises at least one filter. The filter may be a ventilation filter. The ventilation filter may capture debris and/or other gas-borne material (e.g., fine powder) from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas-borne pre-transformed material, or gas-borne transformed material. The debris may result from the 3D printing process. The ventilator may direct the debris in a requested direction (e.g., by using positive or negative gas pressure). For example, the ventilator may use a vacuum. For example, the ventilator may use gas flow.

In some embodiments, the 3D printer comprises a communication technology. The communication may comprise wired or wireless communication. For example, the systems, apparatuses, and/or parts thereof may comprise Bluetooth, wi-fi, a global positioning system (GPS), or radiofrequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (e.g., USB). The systems, apparatuses, and/or parts thereof may comprise USB ports. The USB can be micro or mini-USB. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

In some embodiments, the 3D printer comprises a controller, e.g., at least one controller as part of a control system. The controller may monitor and/or direct (e.g., physical) alteration of the operating conditions of the apparatuses, software, and/or methods described herein. The controller may be configured to control comprising regulate, monitor, restrict, limit, govern, restrain, supervise, direct, guide, manipulate, or modulate. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may be part of a control system comprising multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open-loop control or closed-loop control. The controller may comprise closed-loop control. The controller may comprise open-loop control. The controller may utilize one or more wired and/or wireless networks for communication, e.g., with other controllers or devices, apparatuses, or systems of the 3D printing system and its components. For example, wired ethernet technologies, e.g., local area network (LAN). For example, wireless communication technologies, e.g., a wireless local area network (WLAN). The controller may utilize one or more control protocols for communication, for example, with other controller(s) or one or more devices, apparatuses, or systems of the 3D printing system or any of its components. Control protocols can comprise one or more protocols of an internet protocol suite, e.g., transmission control protocol (TCP) or transmission control protocol/internet protocol (TCP/IP). Control protocols can comprise one or more serial communication protocols. Control protocols can comprise one or more controller area networks or another message-based protocol, e.g., for communication with microcontrollers and devices. Control protocols can interface with one or more serial bus interfaces for communication with the 3D printing system and its components. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of the controller, control protocols, control systems, 3D printing systems, apparatuses, devices, and any of their components, and 3D printing processes can be found in International Patent Application Ser. No. PCT/US17/18191, filed Feb. 16, 2017, which is incorporated herein by reference in its entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, devices, software, and/or apparatuses described herein comprise a control system. The control system can be in communication with one or more components of the 3D printing system. The control system can be in communication with one or more components facilitating the 3D printing methodologies. The control system can be in communication with one or more energy sources, optical systems, gas flow systems, material flow systems, energy (e.g., energy beams), build platform assembly, and/or with any other component of the 3D printing system.

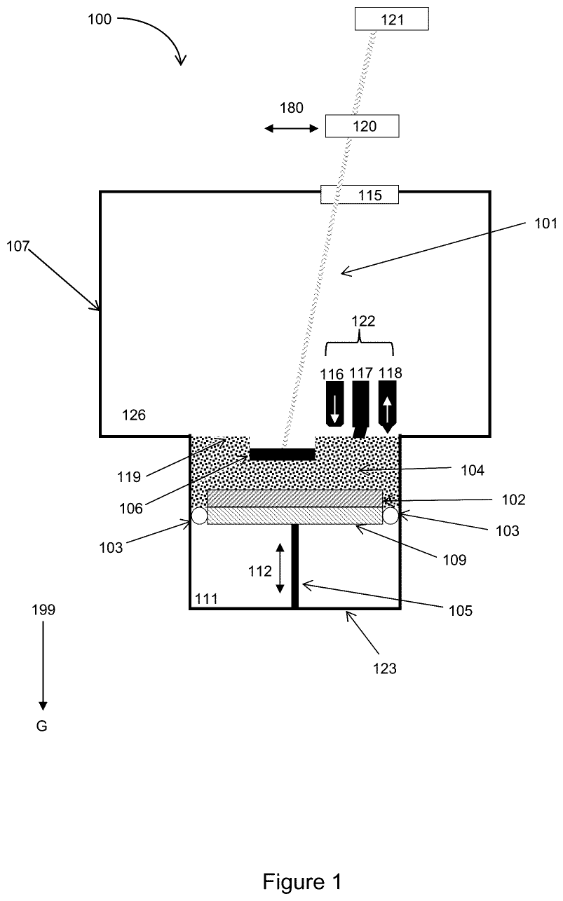

FIG. 1 shows an example of a 3D printing system 100 having a processing chamber 107 coupled with a build module 123. The build module comprises an elevation mechanism 105 (e.g., as part of a build platform assembly) that vertically translates a substrate 109 (e.g., piston) along arrow 112. A build platform 102 is disposed on substrate 109 (e.g., piston). Material bed 104 is disposed of above build platform 102 (e.g., also referred to herein as “base”, or “build plate”). The 3D printing system 100 comprises an optical assembly 120 (e.g., a guidance system) for energy beam 101 (e.g., a galvanometer scanner). The optical assembly 120 can be translatable along axis 180, e.g., translatable along an axis perpendicular to gravitational vector 199. The energy source (e.g., laser source) 121 generates energy beam 101 that traverses through the optical assembly 120 (e.g., comprising a scanner) and through an optical window 115 into the processing chamber 107 enclosing interior space 126 that can include an atmosphere. The optical window 115 is configured to allow the energy beam to pass through without (e.g., substantial) energetic loss. The processing chamber 107 can include an optional temperature adjustment device (e.g., cooling plate), not shown. Seal 103 encircles the substrate and/or base, e.g., to deter (e.g., prevent) migration of material of the material bed from reaching elevation mechanism 105. Energy beam 101 impinges upon an exposed surface 119 of material bed 104, to form at least a portion of a 3D object 106. FIG. 1 shows an example of a build module 123. Build module 123 can contain the pre-transformed (e.g., starting) material in a material bed 104. As depicted in FIG. 1, the 3D printer comprises a layer dispensing mechanism 122. The layer dispensing mechanism 122 includes a material dispenser 116 and a powder removal mechanism 118 to form a layer of pre-transformed material (e.g., starting material) within the enclosure. Layer dispensing mechanism 122 includes a leveler 117. The material may be layered (e.g., spread) in the enclosure such as by using the layer dispensing mechanism 122. Build module 123 is configured to enclose a substrate 109 and arranged adjacent to bottom 111 of build module 123. Bottom 111 is defined relative to the gravitational field along gravitational vector 199 pointing towards gravitational center G, or relative to the position of the footprint of the energy beam 101 on the layer of pre-transformed material as part of a material bed 104. Build module 123 comprises a build platform 102. The substrate is coupled with one or more seals 103 that enclose the material in a selected area within the build module to form material bed 104. One or more components of 3D printing system 100 are controlled by a control system (not shown in FIG. 1).

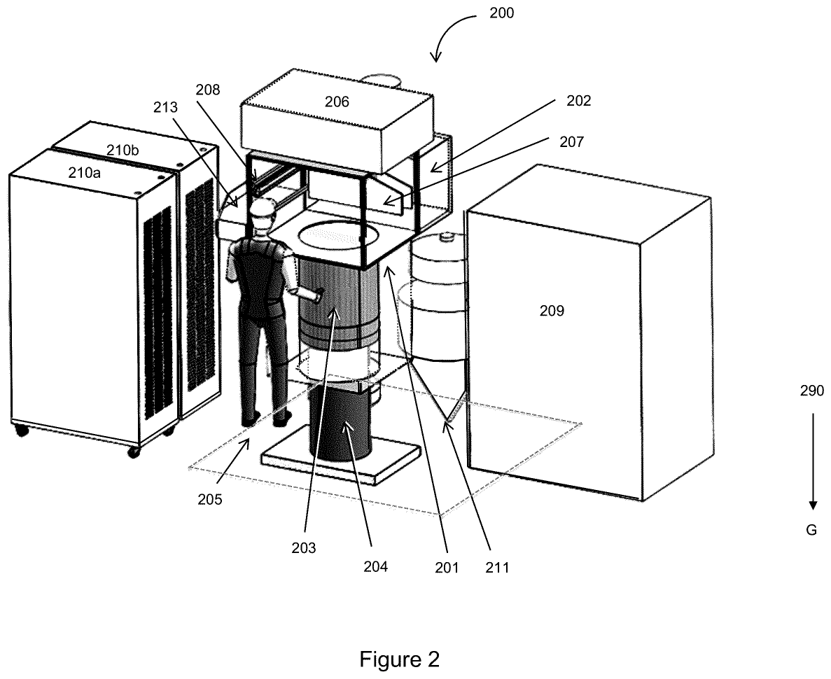

FIG. 2 shows an example of a 3D printing system 200 disposed of in relation to gravitational vector 290 directed towards gravitational center G. The 3D printing system comprises processing chamber 201 coupled with an ancillary chamber (e.g., garage) 202 configured to accommodate a layer dispensing mechanism (e.g., recoater), e.g., in its resting (e.g., idle) position. The processing chamber is coupled with a build module 203 that extends 204 under a plane (e.g., floor) at which user 205 stands (e.g., can extend under-grounds). The processing chamber may comprise a door (not shown) facing user 205. 3D printing system 200 comprises enclosure 206 which can comprise an energy beam alignment system (e.g., an optical system) and/or an energy beam directing system (e.g., scanner)—not shown. A layer dispensing mechanism (not shown) may be coupled with a framing 207 as part of a movement system that facilitates movement of the layer dispensing mechanism along the material bed and garage (e.g., in a reversible back-and-forth movement). The movement system comprises a translation inducer system (e.g., comprising a belt or a chain 208). 3D printing system 200 comprises a filter unit 209, heat exchangers 210a and 210b, pre-transformed material reservoir 211, and a gas conveyance system (e.g., comprising gas inlets and gas inlet portions) disposed of in enclosure 213. The filtering system may filter gas and/or pre-transformed (e.g., powder) material. The filtering system may be configured to filter debris (e.g., comprising byproduct(s) of the 3D printing).

In some embodiments, the formation of the 3D object includes transforming (e.g., fusing, binding, and/or connecting) the pre-transformed material (e.g., 3D printing starting material such as a powder material) using an energy beam. The energy beam may be projected on to the starting material (e.g., disposed of in the material bed), thus causing the pre-transformed material to transform (e.g., fuse). The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise the coagulation of the material, the cohesion of the material, or the accumulation of the material. Transformation of the material may comprise connecting disconnected starting materials. For example, connecting various powder particles. The connection may comprise phase transfer or chemical bonding. The connection may comprise fusing the starting material, e.g., sintering or melting the starting material.

In some embodiments, the methods described herein comprise repeating the operations of material deposition and material transformation operations to produce (e.g., print) a 3D object (or a portion thereof) by at least one 3D printing (e.g., additive manufacturing) method. For example, the methods described herein may comprise repeating the operations of depositing a layer of pre-transformed material and transforming at least a portion of the pre-transformed material to connect to the previously formed 3D object portion (e.g., repeating the 3D printing cycle), thus forming at least a portion of a 3D object. The transforming operation may comprise utilizing energy beam(s) to transform the material. In some instances, the energy beam is utilized to transform at least a portion of the material bed.

In some embodiments, the term “auxiliary support,” as used herein, generally refers to at least one feature that is part of a printed 3D object, but not part of the requested, intended, designed, ordered, and/or final 3D object. Auxiliary support may provide structural support during and/or after the formation of the 3D object. The auxiliary support may be anchored to the enclosure. For example, auxiliary support may be anchored to the build platform (e.g., build platform such as a build plate), to the side walls of the material bed, to a wall of the enclosure, to an object (e.g., stationary, or semi-stationary) within the enclosure, or any combination thereof. The auxiliary support may be the build platform or the bottom of the enclosure. The auxiliary support may enable the removal or energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, build platform, or another stabilization feature. In some instances, the auxiliary support may be mounted, clamped, or situated on the build platform. The auxiliary support can be anchored to the build platform, to the sides (e.g., walls) of the build platform, to the enclosure, to an object (stationary or semi-stationary) within the enclosure, or any combination thereof.

In some examples, the generated 3D object(s) can be printed without auxiliary support in a material bed in which it/they are formed. In some examples, low-hanging overhanging features an/or hollow cavities of the generated 3D object can be printed without (e.g., without any) auxiliary support. The low overhanging features may be shallow overhanging features with respect to an exposed surface of the material bed. The low overhanging features may form an angle of at most about 40 degrees (°), 35°, or 25° with the exposed surface of the material bed (or a plane parallel thereto). The printed 3D object can be devoid of auxiliary supports. The printed 3D object may be suspended (e.g., float anchorlessly) in the material bed (e.g., powder bed). The term “anchorlessly,” as used herein, generally refers to without, or in the absence of, an auxiliary anchor. In some examples, an object is suspended in a material bed anchorlessly without attachment to a support. For example, the object floats in the material bed. A portion of the printed 3D object can be devoid of auxiliary supports. The portion of the 3D object may be suspended over a volume of the material bed. For example, a portion of the object defines an enclosed cavity that may be temporarily filled with powder material during a build process. The generated 3D object may be suspended in the layer of pre-transformed material (e.g., powder material). The pre-transformed material can offer support to the printed 3D object (or the object during its generation). Sometimes, the generated 3D object may comprise one or more auxiliary supports. The auxiliary support may be suspended in the pre-transformed material (e.g., powder material). The auxiliary support may provide weight or stabilizer. The auxiliary support can be suspended in the material bed such as within the layer of pre-transformed material in which the 3D object (or a portion thereof) has been formed. The auxiliary support may touch the build platform. The auxiliary support may be suspended in the material bed and not touch (e.g., contact) the build platform. The auxiliary support may be anchored to the build platform.

In some examples, at least 3D object may be generated above a build platform, in which at least one 3D object comprises one or more auxiliary supports. In some examples, the auxiliary support(s) adhere to the upper surface of the build platform. In some examples, the auxiliary supports of the printed 3D object may touch the build platform (e.g., the bottom of the enclosure, the substrate, or the base). Sometimes, the auxiliary support may adhere to the build platform. In some embodiments, the auxiliary supports are an integral part of the build platform. At times, auxiliary support(s) of the printed 3D object, do not touch the build platform. In any of the methods described herein, the printed 3D object may be supported only by the pre-transformed material within the material bed. Any auxiliary support(s) of the printed 3D object, if present, may be suspended adjacent to the build platform. Occasionally, the build platform may have a pre-hardened (e.g., pre-solidified) amount of material. Such pre-solidified material may provide support to the printed 3D object. At times, the build platform may provide adherence to the material. At times, the build platform does not provide adherence to the material. The build platform may comprise elemental metal, metal alloy, elemental carbon, or ceramic. The build platform may comprise a composite material (e.g., as disclosed herein). The build platform may comprise glass, stone, zeolite, or a polymeric material. The polymeric material may include a hydrocarbon or fluorocarbon. The build platform (e.g., base) may include Teflon. The build platform may include compartments for printing small objects. Small may be relative to the size of the enclosure. The compartments may form a smaller compartment within the enclosure, which may accommodate a layer of pre-transformed material.

In some examples, when the energy source is in operation, the material bed reaches a certain (e.g., average) temperature. The average temperature of the material bed can be an ambient temperature or “room temperature.” The average temperature of the material bed can have an average temperature during the operation of the energy (e.g., beam(s)). The average temperature of the material bed can be the average temperature during the formation of the transformed material, the formation of the hardened material, or the generation of the 3D object. The average temperature can be below or just below the transforming temperature of the material. Just below can refer to a temperature that is by at most about 1° C., 2° C., 3° C., 4° C., 5° C., 6° C., 7° C., 8° C., 9° C., 10 C, 15° C., or 20° C. below the transforming temperature. The average temperature of the material bed (e.g., pre-transformed material) can be by at most about 25° C. (degrees Celsius), 50° C., 100° C., 150° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 20° C., 25° C., 50° C., 100° C., 150° C., 200° C., 250° C., 300° C., 400° C., 500° C., 600° C., 700° C., 800° C., 900° C., 1000° C., 1200° C., 1400° C., 1600° C., or 1800° C. The average temperature of the material bed (e.g., of the pre-transformed material therein) can be any temperature between the afore-mentioned material average temperatures. The temperature of the material bed can be conditioned (e.g., heated or cooled) before, during, or after forming (e.g., printing) the 3D object (e.g., hardened material). The material bed temperature can be a controller (e.g., substantially maintained) at a predetermined value. The temperature of the material bed can be monitored. The material temperature can be controlled manually and/or by a control system (e.g., as any control system disclosed herein).

At times, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave.

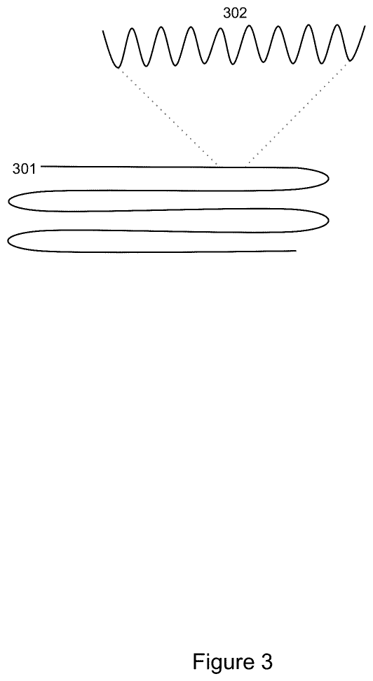

At times, the energy (e.g., energy beam) travels in a path. The path may comprise a hatch, e.g., path 301 of FIG. 3. The path of the energy beam may comprise repeating a path. For example, the first energy may repeat its own path. The second energy may repeat its own path or the path of the first energy. The repetition may comprise a repetition of 1, 2, 3, 4, 5, 6, 7, 8, 9, 10 times or more. The energy may follow a path comprising parallel lines. The lines may be hatch-lines. The distance between each of the parallel lines or hatch lines may be at least about 1 μm, 5 μm, 10 μm, 20 μm, 30 μm, 40 μm, 50 μm, 60 μm, 70 μm, 80 μm, 90 μm, or more. The distance between each of the parallel lines or hatch lines may be at most about 1 μm, 5 μm, 10 μm, 20 μm, 30 μm, 40 μm, 50 μm, 60 μm, 70 μm, 80 μm, 90 μm, or less. The distance between each of the parallel lines or hatch lines may be any value between any of the afore-mentioned distance values (e.g., from about 1 μm to about 90 μm, from about 1 μm to about 50 μm, or from about 40 μm to about 90 μm). The distance between the parallel or parallel lines or hatch lines may be substantially the same in every layer (e.g., plane) of transformed material. The distance between the parallel lines or hatch lines in one layer (e.g., plane) of transformed material may be different than the distance between the parallel lines or hatch lines respectively in another layer (e.g., plane) of transformed material within the 3D object. The distance between the parallel lines or hatch lines portions within a layer (e.g., plane) of transformed material may be substantially constant. The distance between the parallel lines or hatch lines within a layer (e.g., plane) of transformed material may be varied. The distance between a first pair of parallel lines or hatch lines within a layer (e.g., plane) of transformed material may be different than the distance between a second pair of parallel lines or hatch lines within a layer (e.g., plane) of transformed material, respectively. The first energy beam may follow a path comprising two hatch lines or paths that cross at least one point. FIG. 3 shows an example of path 301 of an energy beam comprising a zigzag sub-pattern (e.g., energy beam 302 shown as an expansion (e.g., blow-up) of a portion of path 301). The sub-path of the energy beam may comprise a wave (e.g., sine or cosine wave) pattern. The sub-path may be a small path that forms the large path. The sub-path may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof. The hatch lines or paths may be straight or curved. The hatch lines or paths may be winding. At times, the path comprises successive lines. The successive lines may touch each other. The successive lines may overlap each other at least one point. The successive lines may substantially overlap each other. The successive lines may be spaced by a first distance (e.g., hatch spacing). Examples of 3D printing systems, apparatuses, devices, and any component thereof; controllers, software, and 3D printing processes (e.g., hatch spacings) can be found in International Patent Application Serial No PCT/US16/34857 filed on May 27, 2016, which is entirely incorporated herein by reference.

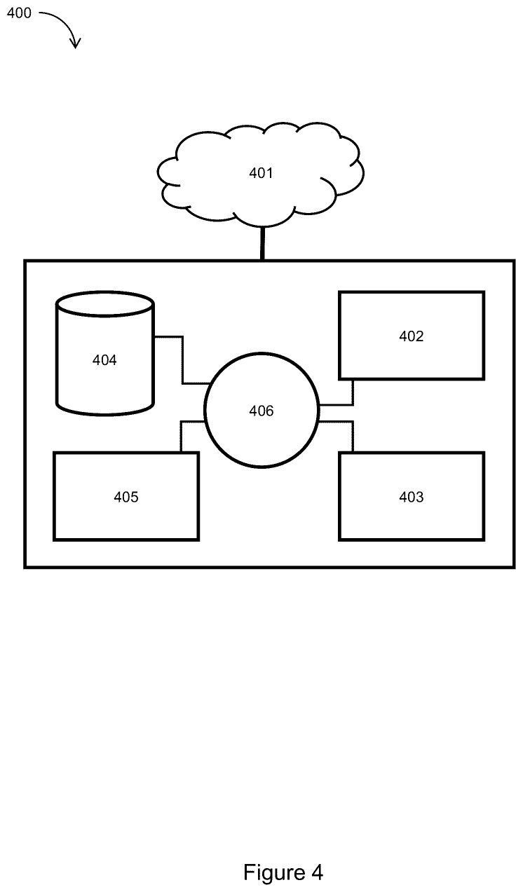

In some embodiments, the 3D printing system comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of disclosure. The processor (e.g., 3D printer processor) may be programmed to implement methods of disclosure. The controller may control at least one component of the systems and/or apparatuses disclosed herein. FIG. 4 is a schematic example of a computer system 400 that is programmed or otherwise configured to facilitate the formation of a 3D object according to the methods provided herein. The computer system 400 can control (e.g., direct, monitor, and/or regulate) various features of printing methods, apparatuses, and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 401 can be part of, or be in communication with, a 3D printing system or apparatus. The computer may be coupled with one or more mechanisms disclosed herein, and/or any parts thereof. For example, the computer may be coupled with one or more sensors, valves, switches, motors, pumps, scanners, optical components, or any combination thereof. The computer system 400 can include a processing unit 406 (also “processor,” “computer” and “computer processor” used herein). The computer system may include memory or memory location 402 (e.g., random-access memory, read-only memory, flash memory), the electronic storage unit 404 (e.g., hard disk), communication interface 403 (e.g., network adapter) for communicating with one or more other systems, and peripheral devices 405, such as cache, other memory, data storage and/or electronic display adapters. The memory 402, the storage unit 404, interface 403, and peripheral devices 405 are in communication with the processing unit 406 through a communication bus (solid lines), such as a motherboard. The storage unit can be a data storage unit (or data repository) for storing data. The computer system can be operatively coupled with a computer network (“network”) 401, e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server. The processing unit can execute a sequence of machine-readable instructions, which can be embodied in a program or software. The instructions may be stored in a memory location, such as the memory 402. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application-specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 400 can be included in the circuit.

In some embodiments, the storage unit 404 stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet. The processor may be configured to process control protocols, e.g., communicate with one or more components of the 3D printer system using the control protocols. Control protocols can be one or more of the internet protocol suite, e.g., transmission control protocol (TCP) or transmission control protocol/internet protocol (TCP/IP). Control protocols can be one or more serial communication protocols. Control protocols can be one or more controller area networks or another message-based protocol, e.g., for communication with microcontrollers and devices. Control protocols can interface with one or more serial bus interfaces for communication with the 3D printing system and its components. The control protocol can be any control protocol disclosed herein.

In some embodiments, the 3D printer comprises communicating through a network. The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some embodiments, the computer system utilizes program instructions to execute, or direct execution of, operation(s). The program instructions can be inscribed in a machine-executable code. Methods, as described herein, can be implemented by way of machine (e.g., computer processor) executable code stored on an electronic storage location of the computer system, such as, for example, on the memory 402 or electronic storage unit 404. The machine executable or machine-readable code can be provided in the form of software. During use, processor 406 can execute the code. In some cases, the code can be retrieved from the storage unit and stored in the memory for ready access by the processor. In some situations, the electronic storage unit can be precluded, and machine-executable instructions are stored in the memory. The code can be pre-compiled and configured for use with a machine have a processer adapted to execute the code or can be compiled during runtime. The code can be supplied in a programming language that can be selected to enable the code to execute in a pre-compiled or as-compiled fashion.

At times, the methods described herein are performed in an enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled pressure. The enclosure may have a predetermined and/or controlled atmosphere. The control may be manual or via a control system.

In some embodiments, the enclosure comprises an atmosphere having an ambient pressure (e.g., 1 atmosphere), or positive pressure. The atmosphere may have a negative pressure (i.e., vacuum). Different portions of the enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum), or positive pressure. The different portions of the enclosure may comprise the processing chamber, build module, or enclosure volume excluding the processing chamber and/or build module. The vacuum may comprise pressure below 1 bar, or below 1 atmosphere. The positively pressurized environment may comprise pressure above 1 bar or above 1 atmosphere. In some cases, the chamber pressure can be standard atmospheric pressure. The pressure may be measured at an ambient temperature (e.g., room temperatures such as 20° C., or 25° C.).

In some embodiments, the enclosure comprises an atmosphere. The atmosphere within the enclosure may comprise a positive pressure. The atmosphere within the enclosure may be different that the atmosphere outside the enclosure. At times, a differential atmosphere (e.g., a difference in atmospheres between the inside of the enclosure and the outside of the enclosure) depends in part on the processing conditions of the three-dimensional printing. Processing conditions can include, for example, (i) composition of the pre-transformed material, (ii) the internal temperature of the material bed during the three-dimensional processing, (iii) the number of energy beams (e.g., an average number of energy beams) transforming (e.g., incident on) the target surface during the three-dimensional processing, (iv) an amount of contamination by debris during the three-dimensional processing, (v) temperature in the material bed during 3D printing, (vi) temperature in the processing chamber during the printing, (vii) amount of energy supplied by the energy beams to the material bed, or (vii) any combination thereof. For example, a differential atmosphere between the interior of the enclosure (e.g., within the processing chamber) and an ambient environment external to the enclosure may depend at least in part on an average number of energy beams utilized during the three-dimensional process.

In some embodiments, the enclosure includes an atmosphere that is greater than (e.g., at a positive pressure with respect to) an ambient atmosphere external to the enclosure. The atmosphere within the enclosure may comprise a positive pressure of at least about 20 Kilo Pascal (KPa), 18 KPa, 16 KPa, 14 KPa, 12 KPa, 10 KPa, or 5 KPa above atmospheric pressure, e.g., above 101 KPa. The pressure in the enclosure can be at a range between any of the afore-mentioned pressure values above atmospheric pressure, e.g., from about 5 KPa to about 20 KPa, the values representing a pressure difference above atmospheric pressure, e.g., above 101 KPa. The pressure can be measured by a pressure gauge. The pressure can be measured at ambient temperature (e.g., room temperature (R.T.)). In some cases, the chamber pressure can be standard atmospheric pressure. The pressure may be measured at an ambient temperature (e.g., room temperatures such as about 2000, or about 25° C.). The composition of the atmosphere within the enclosure may comprise any one or more of the gases described herein, for example, clean dry air (CDA), argon, and/or nitrogen. The enclosure may comprise a gas flow, e.g., before, after, and/or during three-dimensional printing. The gas flow within the enclosure may comprise at least about 150 liters per minute (LPM), 200 LPM, 250 LPM, 300 LPM, 350 LPM, 400 LPM, 450 LPM, 500 LPM, 550 LPM, 600 LPM, 650 LPM, 700 LPM, 750 LPM, 800 LPM, 900 LPM, 1000 LPM, or 1200 LPM. The gas flow within the enclosure may comprise any value between the aforementioned values, for example, from about 150 LPM to about 500 LPM, from about 450 LPM to about 750 LPM, or from about 700 LPM to about 1200 LPM. The composition of the gas may comprise any one or more of the gases described herein, for example, clean dry air (CDA), argon, or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of the reactive agent (gas) between the aforementioned percentages of hydrogen gas.

In some embodiments, the enclosure includes an atmosphere. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 0.1 parts per million (ppm), 1 ppm, 3 ppm, 10 ppm, 50 ppm, 100 ppm, 500 ppm, 1000 ppm, 3000 ppm, or 5000 ppm volume by volume (v/v). The level of the depleted or reduced level gas may be at least about 1 ppm, 10 ppm, 50 ppm, 100 ppm, 500 ppm, 1000 ppm, or 5000 ppm (v/v). The level of the oxygen gas may be at most about 1 ppm, 10 ppm, 50 ppm, 100 ppm, 500 ppm, 1000 ppm, or 2000 ppm (v/v). The level of the water vapor may be at most about 1 ppm, 10 ppm, 50 ppm, 100 ppm, 500 ppm, 700 ppm, 800 ppm, 900 ppm, or 1000 ppm, (v/v). The level of the gas (e.g., depleted level gas, reduced level gas, oxygen, or water) may be between any of the afore-mentioned levels of gas. The atmosphere may comprise air. The atmosphere may be inert. The atmosphere in the enclosure (e.g., processing chamber) may have reduced reactivity (e.g., non-reactive) as compared to the ambient atmosphere external to the processing chamber and/or external to the printing system. The atmosphere may have reduced reactivity with the material (e.g., the pre-transformed material deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the pre-transformed material within the layer of pre-transformed material before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be about one (1) atmosphere.

In some embodiments, material utilized in the 3D printing undergoes passivation, e.g., using a passivation system. A passivation system may comprise (A) an in-situ passivation system, (B) an ex-situ passivation system, or (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, humidity levels and/or oxygen levels in at least a portion of the enclosure, (e.g., processing chamber, ancillary chamber, and/or build module) can be regulated such that an oxygenation and/or humidification of pre-transformed material (e.g., powder) in the material conveyance system is controlled. For example, oxygenation and/or humidification levels of recycled pre-transformed material (e.g., recycled powder material) can be about 5 parts per million (ppm) to about 1500 ppm. For example, the gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 1500 ppm to about 500 ppm, or from 500 ppm to about 50 ppm). For example, oxygenation and/or humidification levels of pre-transformed material can be about zero ppm. For example, oxygen content in pre-transformed material can be about 0 weight percent (wt %), 0.1 wt %, 0.25 wt %, 0.3 wt %, 0.5 wt %, 0.75 wt %, 1.0 wt %, or more. At times, atmospheric conditions can, in part, influence the flowability of pre-transformed material (e.g., powder material) from the layer dispensing mechanism. A dew point of an internal atmosphere of an enclosure (e.g., of the processing chamber) can be (I) below a level in which the powder particles absorb water such that they become reactive under the condition of the 3D printing process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder material and/or on processing condition(s) of the 3D printing process(es). For example, the gas composition of the chamber can contain a level of humidity that corresponds to a dew point of at most about −10° C., −15° C., −20° C., −25° C., −30° C., −35° C., −40° C., −50° C., −60° C., or −70° C. The gas composition of the chamber can contain a level of humidity that corresponds to a dew point between any of the aforementioned values, e.g., from about −70° C. to about −10° C., −60° C. to about −10° C. or from about −30° C. to about −20° C. For example, a dew point of an internal atmosphere of the enclosure (e.g., of the processing chamber) can be from about −80° C. to about −30° C., from about −65° C. to about −40° C., or from about −55° C. to about −45° C., at atmospheric pressure of at least about 10 kilo-Pascals (kPa), about 12 kPa, about 14 kPa, about 16 kPa, about 18 kPa, about 20 kPa above ambient pressure external to the enclosure. For example, a dew point of an internal atmosphere of the enclosure can be any value within or including the afore-mentioned values. The 3D printing system may comprise an in-situ passivation system, e.g., to passivate filtered debris and/or any other gas-borne material before their disposal. Examples of gas conveyance systems and components (including control components), in-situ passivation systems, controlled oxidation methods and systems, 3D printing systems, control systems, software, and related processes, can be found in International Patent Application Ser. No. PCT/US17/60035 filed Nov. 3, 2017; and in International Patent Application Ser. No. PCT/US21/35350 filed Jun. 2, 2021; each of which is incorporated herein by reference in its entirety.

In some embodiments, a 3D printing system includes or is operationally coupled with one or more gas recycling systems. The gas recycling system can be at least a portion of the gas conveyance system. The processing chamber may include gas inlet(s) and gas outlet(s). The gas recycling system can be configured to recirculate the flow of gas from the gas outlet(s) back into the processing chamber via the gas inlet(s). Gas flow through a channel exiting a gas outlet can include solid and/or gaseous contaminants such as debris (e.g., soot). A filtration system can be configured to filter out at least some of the solid and/or gaseous contaminants, thereby providing a clean gas (e.g., cleaner than gas flow through the channel exiting the gas outlet). The filtration system can include one or more filters. The filters may comprise physical filters or chemical filters. The clean gas exiting the filtering mechanism (also herein “filtration system”) can be under lower pressure relative to the incoming gas pressure into the filtering mechanism. The lower pressure and the pressure of the incoming gas pressure may be above the ambient pressure external to the 3D printing system. The clean gas can be directed through a pump to regulate (e.g., increase) its relative pressure prior to entry into the processing chamber. Clean gas with a regulated pressure that exits the pump can be directed through one or more sensors. One or more sensors may comprise a flow meter, which can measure the flow (e.g., pressure) of the pressurized clean gas. One or more sensors may comprise temperature, humidity, oxygen sensors, or any other sensor disclosed herein. In some cases, the clean gas can have an ambient pressure or higher. The higher pressure may provide a positive pressure within the processing chamber (see example values of positive pressure described herein). A first portion of the clean gas can be directed through at least one inlet of a gas inlet portion of the enclosure, while a second portion of the clean gas can be directed to first and/or second window holders that provide gas purging of optical window areas, as described herein. That is, the gas recycling system can provide clean gas to provide a primary gas flow for the 3D printing system, as well as a secondary gas flow (e.g., optical window and/or optical system purging). In some embodiments, the pressurized clean gas is (e.g., further) filtered through a filter prior to reaching one or both of the window holders. In some embodiments, one or more filters (e.g., as part of one or more filters and/or a filtration system) are configured to filter out debris. The debris may comprise soot. The debris may comprise particles having a nanometer-scale diameter, e.g., from about 10 nm to about 500 nm diameters. In some embodiments, the gas recycling system may provide clean gas to a recessed portion of the enclosure, e.g., to the garage housing a layer dispensing mechanism. In some embodiments, gas flow from the recessed portion of the enclosure can be directed through the gas recycling system. In some embodiments, gas flow from the recessed portion can be directed through one or more filters of a filtration system. In some embodiments, the gas recycling system provides clean gas to one or more optical window holders. In some embodiments, the gas recycling system provides clean gas to an optical chamber housing the optical system.

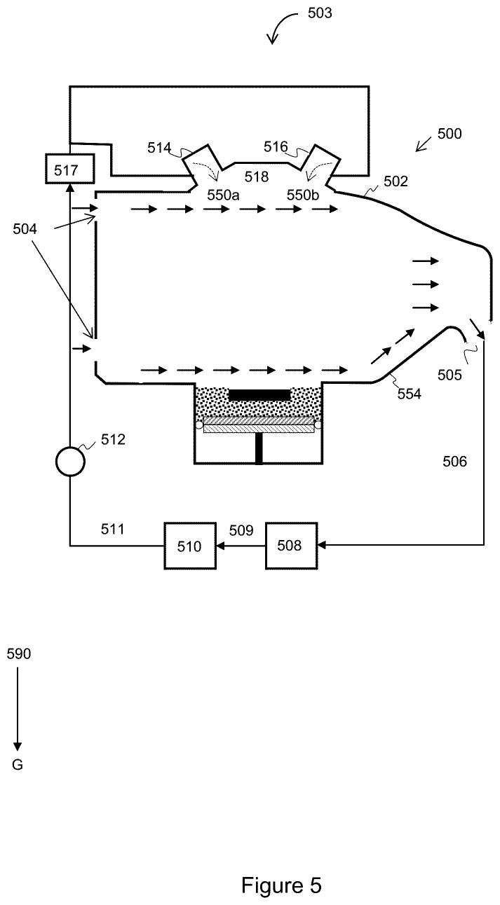

FIG. 5 shows a schematic side view of an example 3D printing system 500 that is coupled with a gas recycling system 503 in accordance with some embodiments. 3D printing system 500 includes a processing chamber 502, which includes gas inlets 504 and gas outlet 505. The gas recycling system 503 is configured to recirculate the flow of gas from gas outlet 505 back into the processing chamber 502 via gas inlets 504. Filtration system 508 is configured to filter out at least some of the solid and/or gaseous contaminants, thereby providing a clean gas 509 (e.g., cleaner than gas flow through channel 506). The clean gas 509 exiting the filtering mechanism (also herein “filtration system”) can be under lower pressure relative to the incoming gas pressure into the filtering mechanism. The clean gas is directed through a pump 510 to regulate (e.g., increase) its relative pressure prior to entry to the processing chamber. Clean gas 511 with a regulated pressure that exits the pump is directed through one or more sensors 512, e.g., a flow meter, temperature sensors, humidity sensors, oxygen sensors, or any other sensor disclosed herein. A first portion of the clean gas is directed through at least one inlet(s) 504 of a gas inlet portion of the enclosure, while a second portion of the clean gas is directed to first and/or second window holders 514 and 516 that provide gas purging of optical window areas, as described herein. In some embodiments, the pressurized clean gas is further filtered through a filter e.g., 517 prior to reaching one or both of the window holders. In some embodiments, one or more filters 517 and/or filtration system 508 are configured to filter out particles having nanometer-scale (e.g., about 10 nm to about 500 nm) diameters. In some embodiments, the gas recycling system provides clean gas to a recessed portion 518 of the enclosure. In some embodiments, gas flow 550a and 550b from the recessed portion 518 of the enclosure is directed through the gas recycling system of the 3D printer 503 shown with respect to gravitational vector 590 pointing to the gravitational center of the ambient environment external to the 3D printer. In some embodiments, gas flow from the recessed portion is directed through one or more filters of a filtration system. In some embodiments, the gas recycling system provides clean gas directed to first and/or second window holders 514 and 516. In some embodiments, the processing chamber comprises an upward slope 554 to direct a flow of gas through gas outlet 505. In some embodiments, the processing chamber does not include (e.g., is devoid of) an upward slope 554, e.g., has a (substantially) flat (e.g., planar) plane guiding flow of gas across the build platform and through gas outlet 505.

In some embodiments, a 3D printing system comprises a pre-transformed material conveyor system (e.g., also referred to as a “material conveyance system”). The pre-transformed material may be a starting material such as powder. The pre-transformed material conveyor system may be coupled with a processing chamber having a layer dispensing mechanism (e.g., recoater). Pre-transformed material (e.g., powder) from a reservoir (e.g., hopper) can be introduced into the layer dispensing mechanism and disposed of in the processing chamber. Once the layer dispensing mechanism dispenses a layer of pre-transformed material to layerwise form a material bed utilized for the three-dimensional printing, excess pre-transformed material may be attracted away from the material bed. In this process, excess pre-transformed material may be attracted away from the material bed using a layer dispensing mechanism and introduced into a separator (e.g., cyclone), and optionally to an overflow separator (e.g., cyclone). The pre-transformed material may undergo separation (e.g., cyclonic separation) in the separator(s), and may be introduced into a sieve(s), followed by gravitational flow into a lower reservoir (e.g., hopper). The separated and sieved pre-transformed material can be then delivered into a separator(s), and into a reservoir that can deliver the pre-transformed material back into the layer dispensing mechanism. The separator may be coupled with sieve(s) instead of to the reservoir. The pre-transformed conveyor system may comprise pumps (e.g., displacement pump and/or compressor pumps), and a temperature regulator (e.g., heater or radiator such as a radiant plane). The pre-transformed conveyor system may comprise a venturi nozzle, for example, to facilitate the suction of the pre-transformed material from the reservoir into a separator(s). The conveyance system can include a condensed gas source (e.g., a blower or a cylinder of condensed gas). The conveyance system may include a heat exchanger. The conveyance system may include one or more filters. The conveyance system may operate at a positive pressure above ambient pressure external to the conveyance system (e.g., above about one atmosphere). The gas circulating system may be configured to circulate (e.g., and recirculate) gas also in the processing chamber. The gas circulating system may sweep debris (e.g., soot) away from the process area in which the 3D object is being printed. At times, a pressure differential is required to convey pre-transformed material from one compartment of the 3D printer to another. The pressure differential may be established via pressurizing or vacuuming one or more compartments. For example, pre-transformed material from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

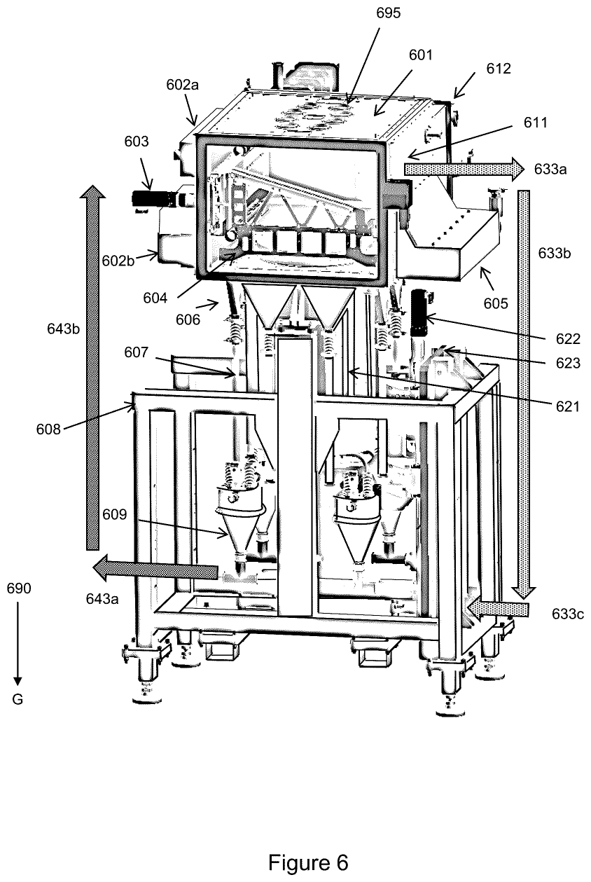

FIG. 6 shows a perspective view example of a portion of a 3D printing system including a processing chamber having a roof 601 in which optical windows are disposed to facilitate penetration of an energy beam into the processing chamber interior space, side wall 611 having a gas exit port covering 605 coupled thereto. The processing chamber has two gas entrance port coverings 602a and 602b coupled with an opposing wall-to-side wall 611. The opposing wall is coupled with an actuator 603 configured to facilitate translation of a layer dispensing mechanism mounted on a framing 604 above a base disposed of adjacent to a floor of the processing chamber, which framing is configured to translate back and forth in the processing chamber along railings. The processing chamber floor has slots through which the remainder material can flow downwards towards gravitational center G of the environment along gravitational vector 690. The slots are coupled with funnels such as 606 that are connected by channels (e.g., pipes) such as 607 to material reservoirs such as 609. The processing chamber is coupled with a build module 621 that comprises a substrate to which the base is attached, which substrate is configured to vertically translate with the aid of actuator 622 coupled with an elevator motion stage (e.g., supporting plate) 623 via a bent arm. The elevator motion stage and coupled components are supported by framing 608, (e.g., depicted in FIG. 6 missing a beam that may be removed for installation and/or maintenance). Atmosphere (e.g., content and/or pressure) may be equilibrated between the material reservoirs and the processing chamber via the schematic channel (e.g., pipe) portions 633a-c. Remainder material in the material reservoirs may be conveyed via schematic channels (e.g., pipes) 643a-b to a material recycling system, e.g., for future use in printing. The components of the 3D printing system are disposed of relative to gravitational vector 690 pointing to gravitational center G.

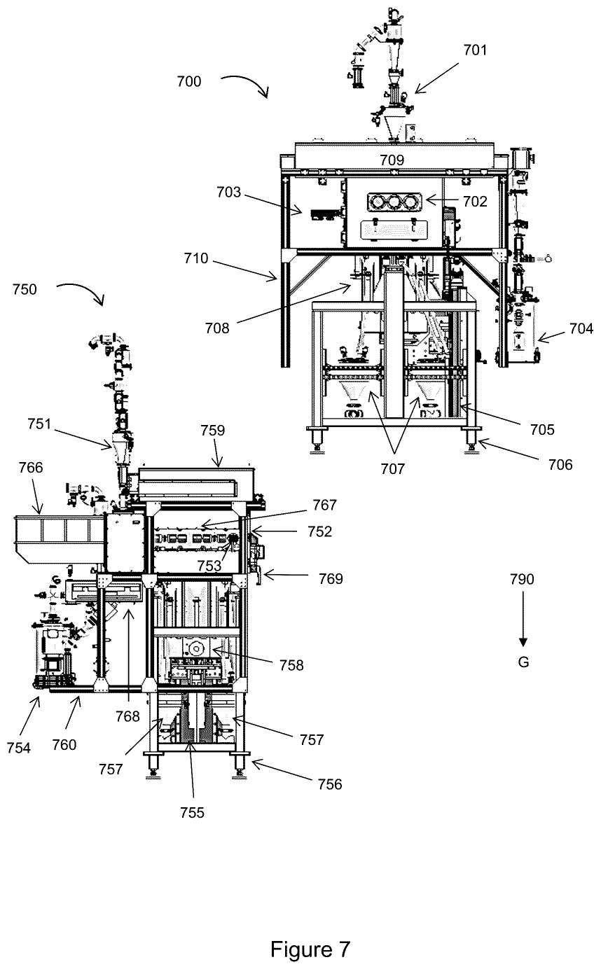

FIG. 7 shows in example 700 a front-side example of a portion of a 3D printing system comprising a material reservoir 701 configured to feed pre-transformed material to a layer dispensing mechanism, an enclosure 709 configured to enclosure, e.g., scanner(s) and/or director(s) (e.g., optical system) of at least one energy beam (e.g., laser beam) configured to transform the pre-transformed material into a transformed material to print one or more 3D object in a printing cycle. Example 700 of FIG. 7 shows a processing chamber 702 having a door with three circular viewing windows. The windows may be any window disclosed herein. The window may be a viewing window assembly. The viewing window assembly may comprise one or more panes. The viewing window (e.g., viewing window assembly) may be a single or a double-pane window. The window may be an insulated glass unit (IGU), the window may be configured to withstand positive pressure within the processing chamber, e.g., during printing. The positive pressure is above the ambient pressure external to the build module, e.g., the ambient pressure may be about one atmosphere. Example 700 shows a material reservoir 704 configured to accumulate recycled remainder starting material (e.g., pre-transformed material) from the layer dispensing process to form a material bed and/or a remainder of the material bed that did not form one or more 3D objects during a printing cycle, post 705 as part of a build platform assembly of build module 708; two material reservoirs 707 for accumulating a remainder of the material bed that did not form the 3D object, and actuator 703 configured to translate the layer dispensing mechanism to dispense a layer of pre-transformed material as part of a material bed. Supports 706 are planarly stationed in a first horizontal plane, which supports 706, and associated framing support one section of the 3D printing system portion 700, and framing 710 is disposed on a second horizontal plane higher than the first horizontal plane. FIG. 7 shows in 750 an example side view example of a portion of the 3D printing system shown in example 700, which side view comprises a material reservoir 751 configured to feed pre-transformed material to a layer dispensing mechanism, an enclosure 759 enclosing, e.g., scanners and/or directors (e.g., optical system) of at least one energy beam (e.g., laser beam) configured to transform the pre-transformed material into a transformed material to print one or more 3D object in a printing cycle. Example 750 of FIG. 7 shows an example of a processing chamber 752 having a door comprising handle 769 (as part of a handle mechanism). 3D printing system portion 750 shows a material reservoir 754 configured to accumulate recycled remainder from the layer dispensing process to form a material bed and/or a remainder of the material bed that did not form one or more 3D objects during a printing cycle, a portion of the material conveyance system 768 configured to convey the material to reservoir 754. The material conveyed to reservoir 754 may be separated (e.g., sieved) before reaching reservoir 754. The example shown in 750 shows post 755 as part of a build platform assembly of build module 758; two material reservoirs 757 for accumulating a remainder of the material bed that did not form the 3D object, and actuator 753 configured to translate the layer dispensing mechanism to dispense a layer of pre-transformed material as part of a material bed, e.g., along railing 767 in the processing chamber and into garage 766 in a reversible (e.g., back and forth) movement. Supports 756 are planarly stationed in a first horizontal plane, which supports 706, and associated framing support one section of the 3D printing system portion 750, and framing 760 is disposed on a second horizontal plane higher than the first horizontal plane. In the example shown in FIG. 7, the 3D printing system components may be aligned with respect to gravitational vector 790 pointing towards gravitational center G of the environment.

In some embodiments, a plurality of energy beams incident on a target surface may increase (i) the (e.g., total) processing field available for printing (e.g., in a X-Y plane) and/or (ii) the rate of 3D printing completion for a given print cycle (as compared to using a single energy beam). A plurality of energy beams (e.g., at least two energy beams) may be useful in providing a relatively larger processing area in which one or more 3D objects may be generated. A relatively larger processing area may be useful in generating a larger 3D object, or a plurality of (e.g., laterally) adjacent 3D objects. The larger 3D object may be larger in at least one dimension (e.g., in a X-Y plane), compared to a 3D object formed using a single energy beam. The build platform and/or material bed may be larger in at least one dimension (e.g., in a X-Y plane), compared to a build platform and/or a material bed used for 3D printing with a single energy beam. A relatively larger processing field may be larger in relation to a 3D printing system that comprises (e.g., only) a single energy beam, which processing area is limited to the areal extent (e.g., the processing field) of the single energy beam (e.g., as guided by an optical assembly), which is not arbitrarily sized.

At times, an energy beam from a first and/or second energy source is incident on, and/or is directed to, a target surface (e.g., the exposed surface of the material bed). The energy beam may be directed to and/or impinge on the pre-transformed material. The energy beam can be directed to the pre-transformed or transformed material for a specified period. The pre-transformed or transformed material can absorb the energy from the energy source (e.g., energy beam, diffused energy, and/or dispersed energy), and as a result, a localized region of that pre-transformed or transformed material can increase in temperature (e.g., and at least partially transform). The energy source and/or energy beam can be moveable such that it can translate relative to the surface (e.g., the target surface).

In some embodiments, the energy source is movable such that it can translate across (e.g., laterally) the top surface of the material bed, e.g., during the printing. Movable may be relative to the processing chamber, the build module, the target surface, or any combination thereof. The energy beam(s) can be moved via at least one scanner. In some embodiments, at least two energy beams are moved with the same scanner. In some embodiments, at least two energy beams are moved with different scanners (e.g., are each moved with a different scanner). The scanner may comprise a galvanometer scanner, a polygon, a mechanical-stage (e.g., X-Y-stage), a piezoelectric device, gimbal, or any combination of thereof. The galvanometer scanner may comprise a mirror. The scanner may comprise a modulator. The scanner may comprise a polygonal mirror. The scanner can be the same scanner for two or more energy sources and/or beams. At least two (e.g., each) energy sources and/or beams may have a separate scanner. At least two scanners may be operably coupled with a single energy source and/or energy beam. The energy sources and/or energy beams can be translated independently of each other. In some cases, at least two energy sources and/or energy beams can be translated at different rates, and/or along different paths. For example, the movement of a first energy beam may be faster (e.g., at a greater rate) as compared to the movement of a second energy beam. The systems and/or apparatuses disclosed herein may comprise one or more closures such as shutters (e.g., safety shutters). The energy beam(s), energy source(s), and/or the platform can be moved by the scanner (e.g., optical scanner to move the energy beam, or mechanical stage type scanner to move the platform or energy source). The galvanometer scanner may comprise a two-axis galvanometer scanner. The scanner may comprise a modulator. The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle).

At times, the energy source(s) are modulated. The energy (e.g., beam) emitted by the energy source can be modulated. The modulator can comprise an amplitude modulator, a phase modulator, or a polarization modulator. The modulation may alter the intensity of the energy beam. The modulation may alter the current supplied to the energy source (e.g., direct modulation). The modulation may affect (e.g., alter) the energy beam (e.g., external modulation such as external light modulator). The modulator can comprise an acoustic-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam.

The scanner can be included in an optical system that is configured to direct energy from the energy source to a predetermined position on the (target) surface (e.g., exposed surface of the material bed). The scanner may comprise one or more optical elements (e.g., mirrors). At least one controller can be programmed to control a trajectory of the energy beam(s), e.g., with the aid of the optical system. At least one controller can be programmed to control a trajectory of the energy source(s), e.g., with the aid of actuator(s). The controller can regulate a supply of energy from the energy source to the pre-transformed material (e.g., at the target surface) to form a transformed material. The optical system may be enclosed in an optical enclosure (e.g., of the system of optical assemblies). Examples of 3D printing systems, apparatuses, devices, and components (e.g., optical housing and optical system), controllers, software, and 3D printing processes can be found International Patent Application Ser. No. PCT/US17/64474, filed Dec. 4, 2017; in International Patent Application Ser. No. PCT/US18/12250, filed Jan. 3, 2018; in International Patent Application Ser. No. PCT/US19/226364, filed on May 16, 2019; or in International Patent Application Ser. No. PCT/US23/24161 filed on Jun. 1, 2023; each of which is incorporated herein by reference in its entirety.

In some embodiments, the 3D printing system comprises a controller. The controller may include one or more components. The controller may comprise a processor. The controller may comprise specialized hardware (e.g., electronic circuit). The controller may be a proportional-integral-derivative controller (PID controller). The control may comprise dynamic control (e.g., in real-time during the 3D printing process). For example, the control of the (e.g., transforming) energy beam may be a dynamic control (e.g., during the 3D printing process). The PID controller may comprise a PID tuning software. The PID control may comprise constant and/or dynamic PID control parameters. The PID parameters may relate a variable to the required power needed to maintain and/or achieve a setpoint of the variable at any given time. The calculation may comprise calculating a process value. The process value may be the value of the variable to be controlled at a given moment in time. For example, the process controller may control a height of at least one portion of the layer of hardened material that deviates from the average surface of the target surface (e.g., exposed surface of the material bed) by altering the power of the energy source and/or power density of the energy beam, wherein the height measurement is the variable, and the power of the energy source and/or power density of the energy beam is the process value(s). The variable may comprise a temperature or metrological value. The parameters may be obtained and/or calculated using a historical (e.g., past) 3D printing process. The parameters may be obtained in real-time, during a 3D printing process. A 3D printing process may comprise during the formation of a 3D object, during the formation of a layer of hardened material, or during the formation of a portion of a layer of hardened material. The calculation output may be a relative distance (e.g., height) of the material bed (e.g., from a cooling mechanism, bottom of the enclosure, optical window, energy source, or any combination thereof).

In some embodiments, a controller of a 3D printing system comprises a metrological detection system. The metrological detection system may be used in the control of 3D printing processes of the 3D printing system. The metrological detection system may be configured to detect distance variations such as vertical distance variations, e.g., height variations. The metrological detection system may be configured to detect distance variations such as horizontal distance variations, e.g., variations with respect to an XY plane. For example, a horizontal distance variation along an X-axis that is oriented parallel to a direction of translation of a translatable component (e.g., a translation mechanism). For example, a horizontal distance variation along a Y-axis that is orientated perpendicular to the direction of translation of the translatable component (e.g., the translation mechanism) and perpendicular to a gravitational vector. The metrological detection system may be configured to detect vertical (e.g., height) variations in a planar surface, e.g., a planar exposed surface of a material bed. The metrological detection system may comprise a height mapper system. The metrological detection system may comprise an interferometric optical system. The metrological detection system may comprise a position-sensitive device system. The metrological detection system may comprise an optical detector. The metrological detection system may include, or be operatively coupled with, an image processor. The metrological detection system may comprise an imaging detector to monitor irregularities. The image detector may comprise a camera such as a charged coupled device (CCD) camera. The image detector may comprise detecting a location or an area of the printed 3D object and converting it to a pixel in the X-Y (e.g., horizontal) plane. The image detector may comprise detecting an interference pattern generated by an interferometric beam path. The image detector may comprise detecting the position of a beam incident on the image detector relative to an imaging region of the image detector. The controller may comprise one or more computational schemes to convert data (e.g., measurement data) from the metrological detection system to generate a result. One or more computational schemes may be utilized to determine one or more aspects of the build platform assembly, the optical system, and/or the target surface, e.g., the exposed surface of the material bed or the build platform surface. One or more aspects may comprise positional aspects or localization aspects. One or more aspects may be absolute or relative. For example, an aspect can include a physical orientation of a moving component of the build module, the moving component comprising a base, substrate, or build platform assembly, and the build module assembly comprising the base (also herein “build a platform”). For example, an aspect can include a physical orientation of a moving component of the optical system, e.g., of one or more optical assemblies, energy beam paths, or processing cones incident on the target surface. The physical orientation may comprise a relative orientation (e.g., relative to a requested orientation) or an absolute orientation (e.g., relative to a coordinate axis). For example, an aspect may comprise a relative orientation of the target surface or at least one optical assembly (e.g., a plurality of optical assemblies) with respect to an enclosure (e.g., the processing chamber) with respect to a requested orientation, e.g., characterizing offset value(s) of the position (e.g., XY position) of the optical assembly or target surface from the requested value(s). For example, an aspect may include (a) a height (e.g., along a z-axis) of the target surface, (b) an XY position (c) a rotation of the target surface, or (d) any combination of (a), (b), and (c). The orientation may include (A) pitch or roll (e.g., due to movement around the horizontal axis). The controller may utilize one or more computational schemes to measure the height (e.g., along a z-axis) of the target surface (e.g., a phase shift computational scheme). The controller may utilize one or more computational schemes to measure a position (e.g., about the XY plane). The computational scheme may comprise an algorithm. The controller may utilize a computational scheme comprising a (e.g., digital) modulation scheme that conveys data by changing (e.g., modulating) the phase of a reference signal (e.g., carrier wave). Measurements collected by the metrological detection system may be utilized by one or more controllers, for example, to provide feedback controls to one or more control systems. For example, one or more controllers may process, or direct processing, the measurements at a time including before, after, and/or during the 3D printing process (e.g., in real-time). One or more controllers may be integrated with a control system that controls the 3D printing process (e.g., the recoater, gas flow system, and/or energy beam(s)). The control system may be any control system disclosed herein. For example, the control system may be a hierarchical control system. For example, the control system may comprise a least three hierarchical control levels.

In some embodiments, the 3D printing system comprises a control system. The control system may comprise one or more controllers. The control system may comprise, or be operatively coupled with, one or more devices, apparatuses, and/or systems of the 3D printing system, including any component of the device(s), apparatuses(s), and/or system(s). The controller(s) may comprise, or be operatively coupled with, a hierarchical control system. The hierarchical control system may comprise at least three, four, or five, control levels. In some embodiments, at least two operations are performed, or directed, by the same controller. In some embodiments, at least two operations are each performed, or directed, by a different controller. A control system may comprise a build module control system. The control system may comprise, or be operatively coupled with, a metrological detection system and configured to receive measurement data from the metrological detection system. At times, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS between any of the afore-mentioned FLS values (e.g., from about 1 nm to about 20 μm). The 3D object (or at least a layer thereof) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at the face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on the face of the generated 3D object. For example, a pore may start on a face of the plane and not extend to the opposing face of that 3D object.

The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dpi. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80 μm, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

At times, a 3D printing process, e.g., 3D printing processes described herein, may result in a physical signature in a 3D object such as a material signature. A physical signature may comprise a detectable deviation or change on the surface of the 3D object.

At times, the printing of a (e.g., complex) 3D object involves using a combination of methodologies (e.g., having respective process parameters). In some cases, different methodologies may be used to transform different portions of the object. Various apparatuses (e.g., controllers), systems (e.g., 3D printers), software, methods related to types of the energy beam and formation of 3D objects, as well as various control schemes are described in U.S. patent application Ser. No. 15/435,128; International Patent Application number PCT/US17/18191; European Patent Application number EP17156707.6; and International Patent Application number PCT/US18/20406; each of which is entirely incorporated herein by reference.

In some embodiments, once a 3D object is removed from a printer, the object may include identifying one or more characteristics that indicate the orientation of the object during its formation in the printer. For example, the object may include features (e.g., transition lines, surface steps, melt pools, and/or grain boundaries) that indicate one or more (e.g., average) layering planes. In some embodiments, the portion of the requested 3D object comprises (e.g., substantially) the same material as the support member. In some embodiments, the portion of the requested object comprises a different material than the support member. Some or (e.g., substantially) all the support members may be removed from the main portion (e.g., after the printing is complete). In some cases, the support member causes one or more layers of the portion of the requested object to deform during printing (e.g., due to the presence of the support member during the formation of the requested 3D object). Sometimes, the deformed layers comprise a visible mark. The mark may be a region of discontinuity in the layer, such as a microstructure discontinuity and/or an abrupt microstructural variation. The discontinuity in the microstructure may be explained by the inclusion of a foreign object (e.g., the support member). The microstructural variation may include (e.g., abruptly) altered melt pools and/or grain structure (e.g., crystals, e.g., dendrites) at or near the attachment point of the support member. The microstructure variation may be due to differential thermal gradients due to the presence of the support member. The discontinuity may be external at the surface of the 3D object. The discontinuity may arise from the inclusion of the support member to the surface of the 3D object (e.g., the discontinuity may be visible as a breakage of the support member when at attempt is made to remove the support member after the printing). Breakage may be the result of cutting, shaving, chipping, sawing, polishing, sanding, or any combination thereof (e.g., to remove the support member from the main portion). In some instances, the object includes two or more support members and/or support marks. The two or more support members and/or support marks can be used to define a build plane that is (e.g., substantially) parallel to the platform surface during printing. In some embodiments, the build plane is (e.g., substantially) parallel to the (e.g., average) layering plane. In some embodiments, the process used for printing at least a portion of the 3D object leaves one or more surface marks. The surface mark(s) may comprise (i) a surface marking characteristic of a top surface, (ii) a surface marking characteristic of a top surface, or (iii) a surface marking characteristic of a side surface. The characteristic may comprise a roughness, material deposition trajectory pattern, tessellation pattern, or auxiliary support(s) or mark(s) indicative thereof. At times, 3D printing comprises different printing methodologies. Each of the different printing methodologies may have a material signature, e.g., that is detectable. At least one of the 3D printing methodologies may have a material signature associated with at least one energy beam involved in the printing.

At times, it may be advantageous to allow for easy installation and/or component maneuvering of the 3D printing system. For example, it may be advantageous if one or more components of the 3D printing system are easily maneuvered (e.g., insertable and/or removed). Easy maneuvering (e.g., removal and/or insertion) may include actions of a user facing the 3D printing system, and maneuvering (e.g., pulling and/or pushing) one or more components to facilitate their maneuver (e.g., removal and/or insertion, respectively). For example, easy maneuvering (e.g., removal and/or insertion) may include actions of personnel facing a front, a back, a side, a top, or a bottom of the 3D system, and maneuvering (e.g., pulling and/or pushing) the one or more components to facilitate their maneuver (e.g., removal and/or insertion, respectively). One or more components may comprise an (e.g., laser generator), an optical system (e.g., including an array of optical assemblies), a detection system, an optical system enclosure, a side cover, or a door. The front of the 3D printing system can include a door to the processing chamber. A top of the 3D printing system can face the platform, e.g., through the optical window(s). One or more components can be reversibly secured to and released from the rest of the 3D printing system using a (e.g., flexible) fastener. The flexible fastener may facilitate reversible maneuvering of a component (e.g., retraction and insertion of the component into a designated location in the 3D printing system. The fastener may comprise any material disclosed herein, e.g., an elemental metal, a metal alloy, or a polymer. The fastener may comprise a lock assembly. The fastener may comprise a snap (e.g., snap-fit) assembly or a latch assembly. The fastener may comprise interlocking portions that engage and/or disengage using human-exerted force. The fastener may comprise a cantilever, torsional or annular. The fastener may be devoid of loose parts. The fastener may or may not comprise a spring. In some embodiments, a component may be configured to (e.g., reversibly) snap into and/or out of a cavity in the 3D printing system, e.g., without any fastener, and rather due to the geometric configuration of the cavity edge and component edge that fit together. The fastener may comprise a screw, a peg, or a pin. The component (e.g., energy source) may be disposed of on a rack (e.g., an electronic rack). The component may be engaged with a sliding mechanism (e.g., similar to a drawer). For example, the component may comprise at least one wheel (e.g., wheels) configured to couple to at least one rail (e.g., two rails) disposed of in a 3D printing system cavity. For example, the component may comprise at least one rail (e.g., two rails) configured to couple to the 3D printing system cavity (e.g., wheel(s) configured to engage with at least one rail. The component and/or 3D printing system cavity may comprise bracket(s) as part of the engagement mechanism between the 3D printing system cavity and the component. The engagement mechanism may comprise a rail, a wheel, or a bracket. The engagement mechanism may facilitate linear and/or tilting sliding of the component with respect to the 3D printing system. Any parts of the components may remain stable (e.g., configured to remain stable) during the maneuvering. For example, one or more parts (e.g., all parts) of the optical system may be stable during the extraction of the optical system, and/or one or more components of the optical system (e.g., an optical assembly of the array of optical assemblies) from the 3D printing system and/or insertion of the optical system into the 3D printing system. Such (e.g., reversible) maneuvering methodology may allow easy assembly, and/or maintenance of the 3D printing system (e.g., of the component thereof).

At times, maneuvering the optical system with respect to the 3D printing system causes no, or minimum (e.g., non-material), alternation of the optical system(s) disposed of in the optical system enclosure. For example, one or more parts (e.g., all parts) of the optical system, optical assembly/ies, or of the optical system enclosure may be stable during the extraction of the optical system, optical assembly/ies, (or optical system enclosure comprising the optical system) from the 3D printing system and/or insertion of the optical system or optical assembly/ies into the 3D printing system. Such (e.g., reversible) maneuvering methodology may allow easy assembly, and/or maintenance of the 3D printing system (e.g., of the component thereof).

In some embodiments, the 3D printing system comprises a control system. The control system may comprise one or more controllers. The control system may comprise, or be operatively coupled with, one or more devices, apparatuses, and/or systems of the 3D printing system, including any component of the device(s), apparatuses(s), and/or system(s). The controller(s) may comprise, or be operatively coupled with, a hierarchical control system. The hierarchical control system may comprise at least three, four, or five, control levels. In some embodiments, at least two operations are performed, or directed, by the same controller. In some embodiments, at least two operations are each performed, or directed, by a different controller. A control system may comprise a build module control system. A control system may comprise a laser control system. The controller may comprise a feedback control scheme. The feedback control scheme may comprise an open feedback loop control scheme. The feedback loop control scheme may comprise a closed feedback loop control scheme. The feedback control schemes may comprise hardware compensation. The feedback control schemes may comprise software compensation. The control system may comprise, or be operatively coupled with, a metrological detection system and configured to receive measurement data from the metrological detection system. The control system may be configured to generate control signals responsive to the measurement data collected by the metrological detection system.

In some embodiments, the control system comprises a laser control system. The laser control system may comprise or may be operatively coupled with, an optical translation control system. The laser control system may comprise, or be operatively coupled with, a laser system (e.g., optical system) of the 3D printing system, e.g., energy sources, optical components, translation mechanism, optical assemblies, motors, encoders, or the like. At times, the laser control system is operable to control operations of the optical system (e.g., optical assemblies) of the 3D printing system. The laser control system may be operable to adjust operations of the optical system (e.g., of the optical assemblies) in response to a measured positional deviation of one or more aspects of the translatable optical system. The laser control system may be operable to adjust (e.g., calibrate) one or more characteristics of the irradiating energy (e.g., the energy beam) incident on the target surface, e.g., the exposed surface of the material bed. Adjusting one or more characteristics of the irradiating energy beam may comprise a software adjustment (e.g., calibration). Adjusting one or more characteristics of the irradiating energy beam may comprise a hardware adjustment (e.g., calibration).

In some embodiments, the laser control system is configured to calibrate one or more characteristics of the irradiating energy (e.g., energy beam) in response to a positional deviation of the target surface, translational mechanism, the array of optical assemblies, build platform assembly, or build platform, from a requested position. For example, the laser control system may be configured to calibrate one or more characteristics of the irradiating energy in response to a positional deviation of the target surface about an XY plane and/or about a rotational axis of the target surface (e.g., rotation about a central axis, or pivoting). For example, the laser control system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with respect to a second energy beam position at the (e.g., target) surface, and/or (iv) the XY offset of the energy beam with respect to the (e.g., target) surface. The position at which the energy beam contacts the surface is the position at which the energy beam impinges on the surface.

In some embodiments, the laser control system is configured to calibrate one or more characteristics of the irradiating energy (e.g., energy beam). A calibration may include a comparison of a commanded (e.g., instructed) energy beam position (e.g., at the target surface) compared with an actual (e.g., measured) energy beam position at the target surface. The characteristics of the energy beam may be calibrated along a field of view of the optical system (e.g., and/or detector). The laser control system may calibrate the characteristics of a processing cone of the energy (e.g., laser beam). The calibration of the focus mechanism may achieve a requested spot or footprint size for various locations in the field of view of the irradiating energy (e.g., intersection of the processing cone with the target surface and/or calibration structure surface). The power density distribution measure may be calibrated (e.g., substantially) identically, or differently, along the field of view of the irradiating energy. In some embodiments, different positions in the field of view may require different focus offsets and/or footprint sizes. Processing cone coverage of the material bed can depend in part on the dimensions of one or more of the mirrors of a scanner, e.g., galvanometric scanner, utilized to direct a path of the energy beam about the target surface. Laser control systems, control systems, controllers and operation thereof, 3D printing systems and processes, apparatus, methods, and computer programs, are disclosed in International Patent Application Ser. No. PCT/US19/14635 filed on Jan. 22, 2019; and U.S. patent application Ser. No. 17/986,814 filed on Nov. 14, 2022; each of which is incorporated herein by reference in its entirety.

At times, a calibration comprises generated compensation for one or more characteristics of the laser system. Compensation may be effectuated at least in part by a (e.g., energy beam) calibration. At times, an energy beam calibration comprises the formation of one or more (e.g., physically printed or optically projected) alignment markers using at least one energy beam directed at a target surface. One or more alignment markers may form an arrangement (e.g., a pattern). The position(s) of the marker(s) may be according to a requested (e.g., pre-determined) arrangement (e.g., a reference pattern). The requested may be according to a commanded arrangement as directed by commands to a guidance system for directing the energy beam(s). The arrangement (e.g., position(s)) of one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). The deviation of the detected position(s) from the commanded position(s) may be caused in part by (a) thermal effects on the energy beam and/or optical components, (b) position deviation of the target surface, (c) a non-uniformity of layer deposition, or (d) a combination thereof. Following the application of the (e.g., initial) compensation to the energy beam (e.g., to the guidance system directing the energy beam), further, (e.g., additional) calibration may be performed. Further calibration may (e.g., iteratively) improve the compensation of any deviation between the detected position(s) from the commanded position(s) of the energy beam at the target surface. The deviation may depend on the nature and/or geometry of one or more optical elements of the optical system. The calibration may comprise altering one or more elements (e.g., position thereof) of the optical system. The calibration may comprise altering a command to one or more elements of the optical system and/or to the energy source.

In some embodiments, the control system utilizes data from a metrological detection system. The control system may use the data to control one or more parameters of the 3D printing. For example, the control system may use the metrology data to control one or more positions of the optical system. At times, the control system may utilize a control scheme comprising a feedback control loop that utilizes alignment data, e.g., collected from one or more metrological detection systems to update the control parameters of one or more control systems. Data collected from one or more metrological detection systems may comprise alignment data indicative of a position of a component of the optical system, for example, a position of (A) an optical assembly, (B) the array of optical assemblies, (C) the translation mechanism, (D) energy beam(s) of the optical system incident on the target surface, or (E) any combination of (A) to (D). The data collected from one or more metrological detection systems can be utilized by a feedback control loop to adjust the position of the component of the optical system, for example, a position of (A) an optical assembly, (B) the array of optical assemblies, (C) the translation mechanism, (D) energy beam(s) of the optical system incident on the target surface, or (E) any combination of (A) to (D). At times, a control scheme comprises a feedforward control loop that utilizes alignment data to update the control parameters of one or more control systems. Alignment data may comprise historical data, e.g., data collected after a three-dimensional process performed by a three-dimensional printer. Historical data (e.g., historical measurements) may comprise the characterization of three-dimensional objects formed utilizing the three-dimensional printer. The historical data may be utilized in a feedforward control loop to adjust the position of (A) an optical assembly, (B) the array of optical assemblies, (C) the translation mechanism, (D) energy beam(s) of the optical system incident on the target surface, or (E) any combination of (A) to (D). The control system may use the metrology data to control one or more parameters of the energy source and/or energy beam. One or more measurements from the metrological detection system may be used to alter (e.g., in real-time, and/or offline) the computer model. For example, the metrological detection system measurement(s) may be used to alter the optical proximity correction data. For example, the metrological detection system measurement(s) may be used to alter the printing instruction of one or more successive layers (e.g., during the printing of the 3D object).

In some embodiments, the detector and/or controller(s) averages at least a portion of the detected signal over time (e.g., period). In some embodiments, the detector and/or controller(s) reduces (at least in part) noise from the detected signal (e.g., over time). The noise may comprise detector noise, sensor noise, noise from the target surface, or any combination thereof. The noise from the target surface may arise from a deviation from planarity of the target surface (e.g., when a target surface comprises particulate material (e.g., powder)). The reduction of the noise may comprise using a filter, noise reduction algorithm, averaging of the signal over time, or any combination thereof.

In some embodiments, the controller(s) (e.g., continuously, or intermittently) calculates an error value during the control time. The intermittent calculation may or may not be periodic. The error value may be the difference between a requested setpoint and a measured process variable. The control may be continuous control (e.g., during the 3D printing process, during the formation of the 3D object, and/or during the formation of a layer of hardened material). The control may be discontinuous. For example, the control may cause the occurrence of a sequence of discrete events. The control scheme may comprise a continuous, discrete, or batch control. The requested setpoint may comprise a temperature, power, power density, or a metrological (e.g., height) setpoint. The metrological setpoint may relate to the target surface (e.g., the exposed surface of the material bed). The metrological setpoints may relate to one or more height setpoints of the target surface (e.g., the exposed (e.g., top) surface of the material bed). The controller(s) may attempt to minimize an error (e.g., temperature and/or metrological error) over time by adjustment of a control variable. The control variable may comprise a direction and/or (electrical) power supplied to any component of the 3D printing apparatus and/or system. For example, direction and/or power supplied to the: energy beam, scanner, motor translating the platform, optical system component, optical diffuser, or any combination thereof.

In some embodiments, the systems, apparatuses, and/or components thereof comprise one or more controllers. One or more controllers can comprise one or more central processing units (CPU), input/output (I/O), and/or communications modules. The CPU can comprise electronic circuitry that carries out instructions of a computer program by performing basic arithmetic, logical, control, and I/O operations specified by the instructions. The controller can comprise suitable software (e.g., an operating system). The control system may optionally include a feedback control loop and/or feed-forward control loop. The controllers may be shared between one or more systems or apparatuses. Each apparatus or system may have its own controller. Two or more systems and/or its components may share a controller. Two or more apparatuses and/or its components may share a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open-loop control or closed-loop control. The controller may comprise closed-loop control. The controller may comprise open-loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. The controller may be any controller (e.g., a controller used in 3D printing) such as, for example, the controller disclosed in International Patent Application Ser. No. PCT/US17/18191 that was filed on Feb. 16, 2017; or in International Patent Application Ser. No. PCT/US16/59781, that was filed on Oct. 31, 2016; each of which is incorporated herein by reference in their entirety.

At times, multiple tuning schemes can be generated for one or more controllers, each tuning scheme selectable for a set of operating conditions and/or powder characteristics. For example, the tuning scheme may utilize (i) a look-up table (LUT), (ii) historical data, (iii) experiments, (iv) physics simulation, (v) artificial intelligence, (vi) data analysis, and/or (vii) the like. Artificial intelligence may comprise training a plant model (a machine-learned model). Artificial intelligence may comprise data analysis. The training model may be trained to utilize (i) a look-up table (LUT), (ii) historical data, (iii) experiments, (iv) synthesized results from physics simulation, or (v) the like. In some embodiments, control scheme(s) can use a single plant model and project changes due to the temperature based on previously identified models. The control scheme(s) may be inscribed as program instructions (e.g., software).

In some embodiments, the control scheme used by the controller(s) disclosed herein involve data analysis. The data analysis techniques involve one or more regression analyses/es and/or calculation(s). The regression analysis and/or calculation may comprise linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition (SVD)), probability measure techniques (e.g., fuzzy measure theory, Borel measure, Harr measure, risk-neutral measure, Lebesgue measure), predictive modeling techniques (e.g., group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM)), or any other suitable probability and/or statistical analys(es). The learning scheme may comprise neural networks. The leaning scheme may comprise machine learning. The learning scheme may comprise pattern recognition. The learning scheme may comprise artificial intelligence, data miming, computational statistics, mathematical optimization, predictive analytics, discrete calculus, or differential geometry. The learning schemes may comprise supervised learning, reinforcement learning, unsupervised learning, and semi-supervised learning. The learning scheme may comprise bias-variance decomposition. The learning scheme may comprise decision tree learning, associated rule learning, artificial neural networks, deep learning, inductive logic programming, support vector machines, clustering, Bayesian networks, reinforcement learning, representation learning, similarity, and metric learning, sparse dictionary learning, genetic algorithms (e.g., evolutional algorithm). The non-transitory computer media may comprise any of the algorithms disclosed herein. The controller and/or processor may comprise the non-transitory computer media. The software may comprise any of the algorithms disclosed herein. The controller and/or processor may comprise the software. The learning scheme may comprise a random forest scheme.

In some embodiments, the control system utilizes a physics simulation, e.g., in a computer model (e.g., comprising a prediction model, statistical model, a thermal model, or a thermo-mechanical model). The computer model may provide feedforward information to the control system. The computer model may provide the feed-forward control scheme. There may be more than one computer model (e.g., at least 1, 2, 3, 4, 5, 6, 7, 8, 9, or 10 different computer models). The controller may (e.g., dynamically) switch between the computer models to predict and/or estimate the behavior of the optical elements. Dynamic includes changing computer models (e.g., in real-time) based at least in part on sensor input or based on a controller decision that may in turn be based at least in part on the monitored target temperature. The dynamic switch may be performed in real-time, e.g., during the operation of the optical system and/or during printing 3D object(s). The controller may be configured (e.g., reconfigured) to include additional one or more computer models and/or readjust the existing one or more computer models. A prediction may be done offline (e.g., predetermined) and/or in real-time. Examples of the calibration, control systems, controllers, and operation thereof, 3D printing systems and processes, apparatus, methods, and computer programs, are disclosed in International Patent Application Ser. No. PCT/US19/14635, filed Jan. 22, 2019, which is incorporated herein by reference in its entirety.

In some instances, the processing unit includes one or more cores. The computer system may comprise a single-core processor, multi-core processor, or a plurality of processors for parallel processing. The processing unit may comprise one or more central processing units (CPU) and/or a graphic processing unit (GPU). The multiple cores may be disposed of in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed of in close proximity. The physical unit may comprise an integrated circuit chip. The integrated circuit chip may comprise one or more transistors. The close proximity may allow substantial preservation of communication signals that travel between the cores. The close proximity may diminish communication signal degradation. A core as understood herein is a computing component having independent central processing capabilities. The computing system may comprise a multiplicity of cores, which may be disposed of on a single computing component. The multiplicity of cores may include two or more independent central processing units. The independent central processing units may constitute a unit that reads and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. In some processors (e.g., FPGA), the cores may be equivalent to multiple digital signal processor (DSP) slices (e.g., slices). The plurality of DSP slices may be equal to any of the plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred to as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS).

In some instances, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

In some instances, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

In some instances, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). Partially reconfigurable computing may include module-based partial reconfiguration or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, ethernet media access control (MAC) blocks, or high-speed serial transceivers. DSP blocks can be DSP slices.

In some examples, the computing system includes an integrated circuit. The computing system may include an integrated circuit that performs the algorithm (e.g., control algorithm). In some instances, the controller uses calculations, real-time measurements, or any combination thereof to regulate the energy beam(s).

Aspects of the systems, apparatuses, and/or methods provided herein, such as the computer system, can be embodied in programming (e.g., using software). Various aspects of the technology may be thought of as “product,” “object,” or “articles of manufacture” typically in the form of machine (or processor) executable code and/or associated data that is carried on, or embodied, in a type of machine-readable medium. Machine-executable code can be stored on an electronic storage unit, such as memory (e.g., read-only memory, random-access memory, flash memory) or a hard disk. The storage may comprise non-volatile storage media. “Storage” type media can include any or all of the tangible memory of the computers, processors, or the like, or associated modules thereof, such as various semiconductor memories, tape drives, disk drives, external drives, and the like, which may provide non-transitory storage at any time for the software programming.

In some examples, the computer system comprises a memory. The memory may comprise random-access memory (RAM), dynamic random access memory (DRAM), static random access memory (SRAM), synchronous dynamic random access memory (SDRAM), ferroelectric random access memory (FRAM), read-only memory (ROM), programmable read-only memory (PROM), erasable programmable read-only memory (EPROM), electrically erasable programmable read-only memory (EEPROM), a flash memory, or any combination thereof. The flash memory may comprise a negative-AND (NAND) or NOR logic gates. A NAND gate (negative-AND) may be a logic gate that produces an output that is false only if all its inputs are true. The output of the NAND gate may be complemented by that of the AND gate. The storage may include a hard disk (e.g., a magnetic disk, an optical disk, a magneto-optic disk, a solid-state disk, or the like), a compact disc (CD), a digital versatile disc (DVD), a floppy disk, a cartridge, a magnetic tape, and/or another type of computer-readable medium, along with a corresponding drive.

In some instances, all or portions of the software are at times communicated through the Internet and/or other telecommunication networks. Such communications, for example, may enable the loading of the software from one computer or processor into another, for example, from a management server or host computer into the computer platform of an application server. Thus, another type of media that may bear the software elements includes optical, electrical, and electromagnetic waves, such as those used across physical interfaces between local devices, through wired and optical landline networks, and over various air-links. The physical elements that carry such waves, such as wired or wireless links, optical links, or the like, also may be considered as media bearing the software. As used herein, unless restricted to non-transitory, tangible “storage” media, terms such as a computer or machine “readable medium” refer to any medium or media that participates (s) in providing instructions to a processor for execution.

In some embodiments, the computer system utilizes a machine-readable medium/media to execute, or direct execution of, operation(s). The program instructions can be inscribed in a machine-executable code. A machine-readable medium/media, such as computer-executable code, may take many forms, including, but not limited to, a tangible storage medium, a carrier wave medium, or a physical transmission medium. Non-volatile storage media include, for example, optical or magnetic disks, such as any of the storage devices in any computer(s) or the like, such as may be used to implement the databases. Volatile storage media can include dynamic memory, such as the main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media, therefore, include for example a floppy disk, a flexible disk, a hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from the device, such as a Universal Serial Bus (USB) memory stick, or/and a hard disk. Many of these forms of computer-readable media may be involved in carrying one or more sequences of one or more instructions to a processor for execution.

In some instances, the computer system comprises an electronic display. The computer system can include or be in communication with an electronic display that comprises a user interface (UI) for providing, for example, a model design or graphical representation of a 3D object to be printed. Examples of UI's include, without limitation, a graphical user interface (GUI) and a web-based user interface. The computer system can monitor and/or control various aspects of the 3D printing system. The control may be manual and/or programmed. The control may rely on feedback mechanisms (e.g., from one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., a monitor) may output various parameters of the 3D printing system (as described herein) in real time or in a delayed time. The output unit may output the current 3D-printed object, the ordered 3D-printed object, or both. The output unit may output the printing progress of the 3D-printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at a predetermined time(s), on a request (e.g., from an operator), and/or at a whim. The output unit may comprise a screen, printer, or speaker. The control system may provide a report. The report may comprise any items recited as optional output by the output unit.

In some instances, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some instances, the computer system includes a user interface. The computer system can include, or be in communication with, an electronic display unit that comprises a user interface (UI) for providing, for example, a model design or graphical representation of an object to be printed. Examples of UI include a graphical user interface (GUI) and a web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., a monitor) may display various parameters of the printing system (as described herein) in real-time or in a delayed time. The display unit may display the requested printed 3D object (e.g., according to a model), the printed 3D object, a real-time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the pre-transformed material. The display unit may display the amount of a certain gas in the chamber. The gas may comprise an oxidizing gas (e.g., oxygen), hydrogen, water vapor, or any of the gasses mentioned herein. The gas may comprise a reactive agent. The display unit may display the pressure in the chamber. The computer may generate a report comprising various parameters of the methods, objects, apparatuses, or systems described herein. The report may be generated at a predetermined time(s), on a request (e.g., from an operator), or at a whim.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the requested result). Other control and/or algorithm examples may be found in International Patent Application Ser. No. PCT/US17/18191, filed Feb. 16, 2017, which is incorporated herein by reference in their entirety.

In some embodiments, the 3D printer comprises and/or communicates with a plurality of processors. The processors may form a network architecture. The 3D printer may comprise at least one processor (referred to herein as the “3D printer processor”). The 3D printer may comprise a plurality of processors. At least two of the plurality of the 3D printer processors may interact with each other. At times, at least two of the plurality of the 3D printer processors may not interact with each other.

In some embodiments, a 3D printer processor interacts with at least one processor that acts as a 3D printer interface (also referred to herein as “machine interface processor”). The processor (e.g., machine interface processor) may be stationary or mobile. The processor may be a remote computer system. The machine interface of one or more processors may be connected to at least one 3D printer processor. The connection may be through a wire (e.g., cable) and/or wireless (e.g., via Bluetooth technology). The machine interface may be hardwired to the 3D printer. The machine interface may directly connect to the 3D printer (e.g., to the 3D printer processor). The machine interface may indirectly connect to the 3D printer (e.g., through a server, or through wireless communication). The cable may comprise a coaxial cable, shielded twisted cable pair, unshielded twisted cable pair, structured cable (e.g., used in structured cabling), or fiber-optic cable.

In some embodiments, the machine interface processor directs 3D print job production, 3D printer management, 3D printer monitoring, or any combination thereof. The machine interface processor may not be able to influence (e.g., direct, or be involved in) pre-print or 3D printing process development. The machine management may comprise controlling the 3D printer controller (e.g., directly, or indirectly). The printer controller may direct start (e.g., initiation) a 3D printing process, stop a 3D printing process, maintenance of the 3D printer, clearing alarms (e.g., concerning safety features of the 3D printer).

In some embodiments, the machine interface processor allows monitoring of the 3D printing process (e.g., accessible remotely or locally). The machine interface processor may allow viewing a log of the 3D printing and the status of the 3D printer at a certain time (e.g., 3D printer snapshot). The machine interface processor may allow the monitoring of one or more 3D printing parameters. The one or more printing parameters monitored by the machine interface processor can comprise 3D printer status (e.g., 3D printer is idle, preparing to 3D print, 3D printing, maintenance, fault, or offline), active 3D printing (e.g., including a build module number), status and/or position of build module(s), status of build module and processing chamber engagement, type and status of pre-transformed material used in the 3D printing (e.g., amount of pre-transformed material remaining in the reservoir), status of a filter, atmosphere status (e.g., pressure, gas level(s)), ventilator status, layer dispensing mechanism status (e.g., position, speed, rate of deposition, level of exposed layer of the material bed), status of the optical system (e.g., optical window, mirror), status of scanner, alarm (, boot log, status change, safety events, motion control commands (e.g., of the energy beam, or of the layer dispensing mechanism), or printed 3D object status (e.g., what layer number is being printed),

In some embodiments, the machine interface processor allows controlling (e.g., monitoring) the 3D print job management. The 3D print job management may comprise the status of each build enclosure, e.g., atmosphere condition, power levels of the energy beam, type of pre-transformed material loaded, 3D printing operation diagnostics, status of a filter, or the like. The machine interface processor (e.g., output device thereof) may allow viewing and/or editing of any of the job management and/or one or more printing parameters. The machine interface processor may show the permission level given to the user (e.g., view, or edit). The machine interface processor may allow prioritize 3D objects to be printed, pause 3D objects during 3D printing, delete 3D objects to be printed, select a certain 3D printer for a particular 3D printing job, insert and/or edit considerations for restarting a 3D printing job that was removed from 3D printer. The machine interface processor may allow initiating, pausing, and/or stopping a 3D printing job. The machine interface processor may output message notification (e.g., alarm), log (e.g., other than Excursion log or other default log), or any combination thereof.

In some embodiments, the 3D printer interacts with at least one server (e.g., print server). The 3D print server may be separate or interrelated with the 3D printer. One or more users may interact with one or more 3D printing processors through one or more user processors (e.g., respectively). The interaction may be in parallel and/or sequentially. The users may be clients. The users may belong to entities that request a 3D object to be printed or entities that prepare the 3D object printing instructions. One or more users may interact with the 3D printer (e.g., through one or more processors of the 3D printer) directly and/or indirectly. Indirect interaction may be through the server. One or more users may be able to monitor one or more aspects of the 3D printing process. One or more users can monitor aspects of the 3D printing process through at least one connection (e.g., network connection). For example, one or more users can monitor aspects of the printing process through direct or indirect connections. Direct connection may be using a local area network (LAN), and/or a wide area network (WAN). The network may interconnect computers within a limited area (e.g., a building, campus, or neighborhood). The limited area network may comprise Ethernet or Wi-Fi. The network may have its network equipment and interconnects locally managed. The network may cover a larger geographic distance than the limited area. The network may use telecommunication circuits and/or internet links. The network may comprise Internet Area Network (IAN), and/or the public switched telephone network (PSTN). The communication may comprise web communication. The aspect of the 3D printing process may comprise a 3D printing parameter, machine status, or sensor status. The 3D printing parameter may comprise hatch strategy, energy beam power, energy beam speed, energy beam focus, and thickness of a layer (e.g., of hardened material or of pre-transformed material).

In some embodiments, a user develops at least one 3D printing instruction and directs the 3D printer (e.g., through communication with the 3D printer processor) to print in a requested manner according to the developed at least one 3D printing instruction. A user may or may not be able to control (e.g., locally, or remotely) the 3D printer controller, e.g., depending on permission preferences. For example, a client may not be able to control the 3D printing controller (e.g., maintenance of the 3D printer).

In some embodiments, the user (e.g., other than a client) processor may use real-time and/or historical 3D printing data of one or more 3D printers. The 3D printing data may comprise metrology data. The user processor may comprise quality control. The quality control may use a statistical method (e.g., statistical process control (SPC)). The user processor may (i) log an excursion log, (ii) report when a signal deviates from the nominal level, or (iii) any combination thereof. The user processor may generate a configurable response. The configurable response may comprise a print/pause/stop command (e.g., automatically) to the 3D printer (e.g., to the 3D printing processor). The configurable response may be based on a user-defined parameter, threshold, or any combination thereof. The configurable response may result in a user-defined action. The user processor may control the 3D printing process and ensure that it operates at its full potential. For example, at its full potential, the 3D printing process may make a maximum number of 3D objects with a minimum of waste and/or 3D printer down time. The SPC may comprise a control chart, design of experiments, and/or focus on continuous improvement.

In some embodiments, at least one of the build modules is operatively coupled with at least one controller. The controller may be its own controller. The controller may comprise a control circuit. The controller may comprise a programmable control code. The controller may be different than the controller controlling the 3D printing process and/or the processing chamber. The controller controlling the 3D printing process and/or the processing chamber may comprise a different control circuit than the control circuit of the build module controller. The controller controlling the 3D printing process and/or the processing chamber may comprise a different programmable control code than the programmable control code of the build module controller. The build module controller may communicate the engagement of the build module to the processing chamber. Communicating may comprise emitting signals to the processing chamber controller. The communication may cause the initialization of 3D printing. The communication may cause one or more load lock closures (e.g., shutters) to alter their position, e.g., to open. The build module controller may monitor sensors (e.g., position, motion, optical, thermal, spatial, gas, gas composition, or location) within the build module. The build module controller may control (e.g., adjust) the active elements (e.g., actuator, atmosphere, elevator mechanism, valves, opening/closing ports, and seals) within the build module based on the sensed measurements. The translation facilitator may comprise an actuator. The actuator may comprise a motor. The translation facilitator may comprise an elevation mechanism. The translation mechanism may comprise a gear (e.g., a plurality of gears). The gear may be circular or linear. The translation facilitator may comprise a rack and pinion mechanism, or a screw. The translation facilitator (e.g., build module delivery system) may comprise a controller (e.g., its own controller). The controller of the translation facilitator may be different than the controller controlling the 3D printing process and/or the processing chamber. The controller of the translation facilitator may be different than the controller of the build module. The controller of the translation facilitator may comprise a control circuit (e.g., its own control circuit). The controller of the translation facilitator may comprise a programmable control code (e.g., its own programmable code). The build module controller and/or the translation facilitator controller may be a microcontroller. At times, the controller of the 3D printing process and/or the processing chamber may not interact with the controller of the build module and/or translation facilitator. At times, the controller of the build module and/or translation facilitator may not interact with the controller of the 3D printing process and/or the processing chamber. For example, the controller of the build module may not interact with the controller of the processing chamber. For example, the controller of the translation facilitator may not interact with the controller of the processing chamber. The controller of the 3D printing process and/or the processing chamber may be able to interpret one or more signals emitted from (e.g., by) the build module and/or translation facilitator. The controller of the build module and/or translation facilitator may be able to interpret one or more signals emitted from (e.g., by) the processing chamber. One or more signals may be electromagnetic, electronic, magnetic, pressure, or sound signals. Electromagnetic signals may comprise visible light, infrared, ultraviolet, or radio frequency signals. The electromagnetic signals may comprise a radio frequency identification signal (RFID). The RFID may be specific for a build module, user, entity, 3D object model, processor, material type, printing instruction, 3D print job, or any combination thereof.

In some embodiments, the build module controller controls an engagement of the build module with the processing chamber and/or load-lock. In some embodiments, the build module controller controls a dis-engagement (e.g., release and/or separation) of the build module with the processing chamber and/or load-lock. In some embodiments, the processing chamber controller may control the engagement of the build module with the processing chamber and/or load-lock. The processing chamber controller may control a dis-engagement (e.g., release, and/or separation) of the build module with the processing chamber and/or load-lock. In some embodiments, the load-lock controller may control the engagement of the build module with the processing chamber and/or load-lock. The load-lock controller may control a dis-engagement (e.g., release, and/or separation) of the build module with the processing chamber and/or load-lock. In some embodiments, the 3D printer comprises one controller which is a build module controller, a processing chamber controller, or a load-lock controller. In some embodiments, the 3D printer comprises at least two controllers selected from the group consisting of a build module controller, a processing chamber controller, and a load-lock controller.

In some embodiments, when a plurality of controllers is configured to direct a plurality of operations; at least two operations of the plurality of operations can be directed by the same controller of the plurality of controllers. In some embodiments, when a plurality of controllers is configured to direct a plurality of operations; at least two operations of the plurality of operations can be directed by different controllers of the plurality of controllers.

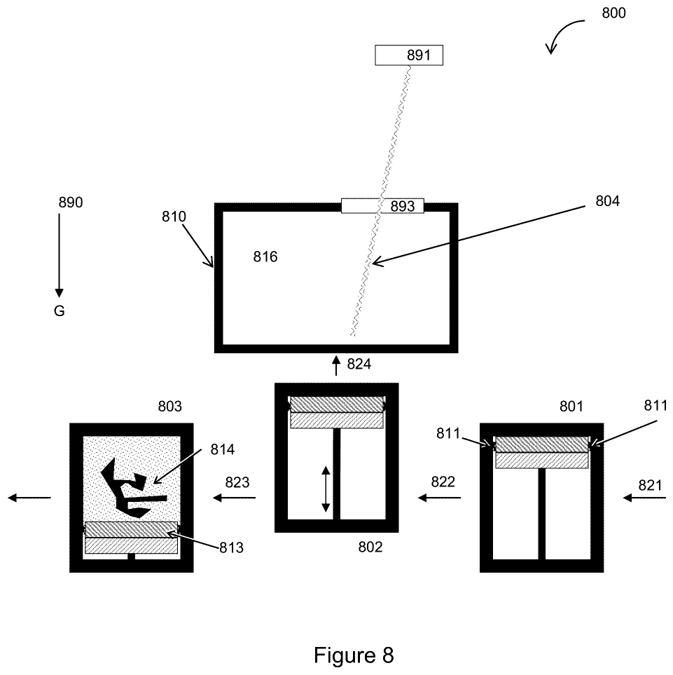

In some embodiments, the build module controller controls the translation of the build module, sealing status of the build module, the atmosphere of the build module, engagement of the build module with the processing chamber, the exit of the build module from the enclosure, entry of the build module into the enclosure, or any combination thereof. Controlling the sealing status of the build module may comprise opening or closing the build module lid assembly (e.g., shutter). The build module controller may be able to interpret signals from the 3D printing controller and/or processing chamber controller. The processing chamber controller may be the 3D printing controller. For example, the build module controller may be able to interpret and/or respond to a signal regarding the atmospheric conditions in the load lock. For example, the build module controller may be able to interpret and/or respond to a signal regarding the completion of a 3D printing process (e.g., when the printing of a 3D object is complete). The build module may be connected to an actuator. The actuator may be translating or stationary. In some embodiments, the actuator may be coupled with a portion of the build module. For example, the actuator may be coupled with the bottom surface of the build module. In some examples, the actuator may be coupled with a side surface of the build module (e.g., the front, and/or back of the build module). The controller of the build module may direct the translation facilitator (e.g., actuator) to translate the build module from one position to another (e.g., arrows 821-824 in FIG. 8), when translation is possible. The translation facilitator (e.g., actuator) may translate the build module in a vertical direction, horizontal direction, or at an angle (e.g., planar and/or compound). In some examples, the build module may be heated during translation. The translation facilitator may be a build module delivery system. The translation facilitator may be autonomous. The translation facilitator may operate independently of the 3D printer (e.g., mechanisms directed by the 3D printing controller). The translation facilitator (e.g., build module delivery system) may comprise a controller and/or a motor. The translation facilitator may comprise a machine or a human. The translation is possible, for example, when the destination position of the build module is empty. The controller of the 3D printing and/or the processing chamber may be able to sense signals emitted from the controller of the build module. For example, the controller of the 3D printing and/or the processing chamber may be able to sense a signal from the build module that is emitted when the build module is docked into engagement position with the processing chamber. The signal from the build module may comprise reaching a certain position in space, reaching a certain atmospheric characteristic threshold, opening, or shutting the build plate closing, or engaging or disengaging (e.g., docking or undocking) from the processing chamber. The build module may comprise one or more sensors. For example, the build module may comprise a proximity, movement, light, sounds, or touch sensor.

In some embodiments, the build module is included as part of the 3D printing system. In some embodiments, the build module is separate from the 3D printing system. The build module may be independent (e.g., operate independently) from the 3D printing system. For example, the build module may comprise its own controller, motor, elevator, build plate, valve, channel, or lid assembly. In some embodiments, one or more conditions differ between the build module and the processing chamber, and/or among the different build modules. The difference may comprise different pre-transformed materials, atmospheres, platforms, temperatures, pressures, humidity levels, oxygen levels, gas (e.g., inert), traveling speed, traveling method, acceleration speed, or post-processing treatment. For example, the relative velocity of the various build modules with respect to the processing chamber may be different, similar, or substantially similar. The build plate may undergo different, similar, or substantially similar post-processing treatment (e.g., further processing of the 3D object and/or material bed after the generation of the 3D object in the material bed is complete).

In some embodiments, at least one build module translates relative to the processing chamber. The translation may be parallel or substantially parallel to the bottom surface of the build chamber. The bottom surface of the build module is the one closest to the gravitational center. The translation may be at an angle (e.g., planar or compound) relative to the bottom surface of the build chamber. The translation may use any device that facilitates translation (e.g., an actuator). For example, the translation facilitator may comprise a robotic arm, conveyor (e.g., conveyor belt), rotating screw, or a moving surface (e.g., platform). The translation facilitator may comprise a chain, rail, motor, or actuator. The translation facilitator may comprise a component that can move another. The movement may be controlled (e.g., using a controller). The movement may comprise using a control signal and source of energy (e.g., electricity). The translation facilitator may use electricity, pneumatic pressure, hydraulic pressure, or human power.

In some embodiments, the 3D printing system comprises multiple build modules. The 3D printing system may comprise at least 1, 2, 3, 4, 5, 6, 7, 8, 9, or 10 build modules. FIG. 8 shows an example of three build modules (e.g., 801, 802, and 803) and one processing chamber 810 depicted with respect to examples 1010, 1020, and 1030 are shown as schematic side cross-sectional views with respect to the environmental gravitational vector 890 pointing towards the environmental gravitational center G. During printing, energy beam 804 is generated by an energy source 891 and passes through an optical window 893, on its way into the processing chamber 810 having internal space 816.

In some embodiments, at least one build module (e.g., 801, 802, and 803) engages (e.g., 824) with the processing chamber to expand the interior volume of the processing chamber. At times, the build module may be connected to or may comprise an autonomous guided vehicle (AGV). The AGV may have at least one of the following: a movement mechanism (e.g., wheels), positional (e.g., optical) sensor, and controller. The controller (e.g., build module controller) may enable self-docking of the build module (e.g., to a docking station) and/or self-driving of the AGV. The self-docking of the build module (e.g., to the processing chamber) and/or self-driving may be to and from the processing chamber. The build module may engage with (e.g., couple to) the processing chamber. The engagement may be reversible. The engagement of the build module with the processing chamber may be controlled (e.g., by a controller). The controller may be separate from a controller that controls the processing chamber (or any of its components). In some embodiments, the controller of the processing chamber may be the same controller that controls the build module. The control may be automatic, remote, local, and/or manual. The engagement of the build module with the processing chamber may be reversible. In some embodiments, the engagement of the build module with the processing chamber may be permanent. The controller (e.g., of the build module) may control the engagement of the build module with a load lock mechanism (e.g., that is coupled with the processing chamber). Control may comprise regulating, monitoring, restricting, limiting, governing, restraining, supervising, directing, guiding, manipulating, or modulating.

In some embodiments, the 3D object is removed from the material bed after the completion of the 3D printing process. For example, the 3D object may be removed from the material bed when the transformed material that formed the 3D object hardens. For example, the 3D object may be removed from the material bed when the transformed material that formed the 3D object is no longer susceptible to deformation under standard handling operations (e.g., human and/or machine handling).

In some embodiments, the processing chamber is configured to reversibly couple and decouple from a build module, e.g., to exchange the build module and/or unpack the printed 3D object away from the processing chamber such as away from the 3D printer. For example, FIG. 8 shows an example of the processing chamber 810 of a 3D printer. FIG. 8 shows an example of build modules 801, 802, and 803 in various positions with respect to their attachment/detachment from processing chamber 810. The internal atmosphere presiding in the build module(s) and/or in the processing chamber, can be different from the ambient atmosphere external to the 3D printer by at least one atmospheric characteristic. For example, at least one reactive agent in the internal atmosphere can be reduced as compared to that reactive agent in the ambient atmosphere. The reactive agent may comprise water, hydrogen sulfide, or oxygen. The reactive agent may react with at least one material component of the 3D printing during the 3D printing. For example, the reactive agent may react with the starting material (e.g., pre-transformed material). For example, the reactive agent may react with the transformed material (e.g., molten material). For example, the reactive agent may react with the hardened material (e.g., a 3D object). The reactive agent may react with at least one material component of the 3D printing after the 3D printing, e.g., after the disengagement of the build module from the processing chamber. In some embodiments, the processing chamber and build module are disposed of in an ambient atmosphere. In such an example, care should be taken during printing and removal of the build module from the processing chamber, e.g., to separate (i) the reactive species present in the ambient atmosphere from (ii) the internal environment of the enclosure including the build module and processing chamber.

Ins some embodiments, the build module comprises a vertically translatable build platform, e.g., configured for discrete translation. The build platform may be configured to support one or more three-dimensional objects during their build. The build platform may be configured to support a material bed, e.g., used during the 3D printing. The build platform may be configured to support a weight of at least about 300 Kilograms (Kg), 500 Kg, 800 Kg, 1000 Kg, 1200 Kg, 1500 Kg, 1800 Kg, 2000 Kg, 2500 Kg, or 3000 Kg. In some embodiments, the material bed may comprise pre-transformed material susceptible to reactive agent(s) present in the ambient atmosphere, e.g., as disclosed herein. Such reaction may result a harmful event such as a violent reaction, e.g., as disclosed herein. As the size and/or weight of the material bed increases (e.g., is scaled up), the harm of the harmful event (e.g., violent reaction) may increase as well, e.g., in a non-linear fashion. To reduce the possibility of such harmful event, it may be advantageous to hold the material bed in an internal environment different than the ambient environment, the internal environment having a reduced concentration of the reactive agent(s) (e.g., as disclosed herein), the internal environment being in the build module that is closed such as shut. To reduce the possibility of such harmful event, it may be advantageous to close (e.g., shut) the open build module while the open build module is exposed to the internal environment, e.g., of a chamber such as the processing chamber. It may be advantageous to control (e.g., maintain) the internal atmosphere in the closed build module until safe unpacking is possible. The safe unpacking may comprise (i) unpacking in an unpacking station having an internal environment different that the ambient environment external to the unpacking station, (ii) cooling the interior of the build module to a temperature that is safe for handling, or (iii) any combination thereof. The internal environment of the unpacking station may be the same or different than the internal environment of the processing chamber. The internal environment of the unpacking station may comprise a reduced concentration of the reactive agent(s), e.g., as disclosed herein.

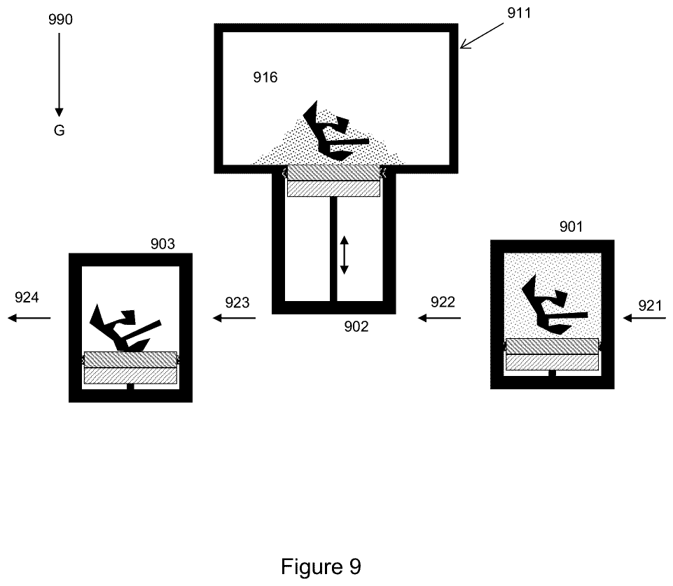

In some embodiments, the 3D object is removed from the build module inside or outside of the 3D printer. For example, the 3D object that is disposed of within the material bed may be removed outside of the enclosure (e.g., by being enclosed in the build module, e.g., FIG. 8, 803). The 3D object may be removed from the build module to an unpacking station (also referred to herein as “unpacking system”). The unpacking station may be within the 3D printer enclosure, or outside of the 3D printer enclosure. The enclosure of the unpacking station may be different (e.g., separate) from the 3D printer enclosure. FIG. 9 shows an example of an unpacking station comprising an unpacking chamber 911, and build modules 901, 902, and 903 disposed at various positions with respect to the unpacking chamber 911. The build modules may transition between the various positions (e.g., near numbers 901, 902, and 903) according to arrows 921, 922, 923, and 924, respectively. The unpacking station (e.g., having chamber 911), and/or build module (e.g., 901, 902, and/or 903) may comprise an ambient or an atmosphere different from the ambient atmosphere by at least one atmospheric characteristic. At least one atmospheric characteristic may comprise pressure, material (e.g., gas) content, or temperature. The atmosphere in the separate unpacking chamber may be identical, substantially identical, or different from the atmosphere in the build module, and processing chamber of the 3D printer. The unpacking chamber may comprise a controlled atmosphere. The atmosphere (e.g., 916) of the unpacking chamber (e.g., 911) may be controlled, e.g., using a control system. The control system of the unpacking station may be the same or different from the control system of the 3D printer. The control system of the unpacking station may or may not be operatively coupled with the control system of the 3D printer. The unpacking chamber may comprise a closure (e.g., similar to the closure of the processing chamber). The closure can comprise a shutter. The build modules may dock to the unpacking chamber in a manner similar to the way the build modules dock to the processing chamber (e.g., through a load lock, conditioning the load lock atmosphere to a 3D printing atmosphere, and removing the respective closures such as shutters). The docking may be from any direction (e.g., any of the six spatial directions). The direction may comprise a Cartesian direction. The direction may comprise a cardinal direction. The direction may be horizontal or vertical. The direction may be lateral. The material bed comprising the 3D object may be separated from an operator (e.g., human). The unpacking operation may take place without contact of the operator with the pre-transformed material (e.g., remainder). The unpacking operation may take place without contact with the pre-transformed material (e.g., remainder) with the ambient atmosphere. The unpacking station may be sealed prior to engagement, or after an engagement with the build module (e.g., using an unpacking station closure such as shutter), for example, to deter atmospheric exchange between the external environment and the interior of the unpacking station. The build module may be sealed prior to engagement of the build module with the unpacking station, for example, to deter atmospheric exchange between the external environment and the interior of the unpacking station. The build module may be sealed prior to disengagement of the build module from the unpacking station (e.g., using a load lock closure such as shutter), for example, to deter atmospheric exchange between the external environment and the interior of the unpacking station. To deter atmospheric exchange between the external environment and the interior of the unpacking station may comprise to deter infiltration of one or more reactive agents from the ambient atmosphere. The reactive agent may comprise humidity and/or oxidizing agent (e.g., oxygen). The unpacking station (e.g., having chamber 911), and/or build module (e.g., 901, 902, and/or 903) may comprise an atmosphere having a pressure greater than the ambient pressure. Greater pressure may be a pressure of at least about 0.2 pounds per square inch (PSI), 0.25 PSI, 0.3 PSI, 0.35 PSI, 0.4 PSI, 0.45 PSI, 0.5 PSI, 0.8 PSI, 1.0 PSI, 1.5 PSI, or 2.0 PSI above ambient pressure (e.g., of 14.7 PSI). The ambient pressure may be constant or fluctuating. Greater pressure may be between any of the afore-mentioned values (e.g., from about 0.2 PSI to about 2.0 PSI, from about 0.3 PSA to about 1.5 PSI, or from about 0.4 PSI to about 1.0 PSI above ambient pressure). Greater pressure may be any pressure above the ambient atmosphere disclosed herein. The 3D object in the build module may be kept in an atmosphere that is different from the external (e.g., ambient) atmosphere from prior to entry to the unpacking station (e.g., via build module 901), through its unpacking (e.g., via build module 902 coupling to chamber 911), to its exit from the unpacking station (e.g., via build module 903). FIG. 9 shows an example of build module exchange and reversible coupling and uncoupling of build modules 901, 902, and 903 from an unpacking chamber 911 shown with respect to environmental gravitational vector 990 pointing towards the gravitational center of the ambient environment.

In some embodiments, the processing is done in an internal environment different from an ambient environment by at least one atmospheric characteristic, e.g., as disclosed herein. At times, it may be required to maneuver components in the internal environment, e.g., by a user or machinery. The maneuvering of the component in the chamber can be done by a user disposed externally to the chamber, e.g., at least in part by using a flexible membrane configured to separate the internal environment of the chamber and the ambient environment in which the user is disposed of. The such membrane can be comprised in at least one glove of a glove box type arrangement. Such membrane may be configured to be sufficiently flexible to allow the user to maneuver component(s) in the processing chamber to facilitate the maneuver of the lid assembly and/or associated mechanism. The user may be substituted by a mechanism (e.g., a robot). The chamber may comprise the processing chamber or the unpacking chamber.

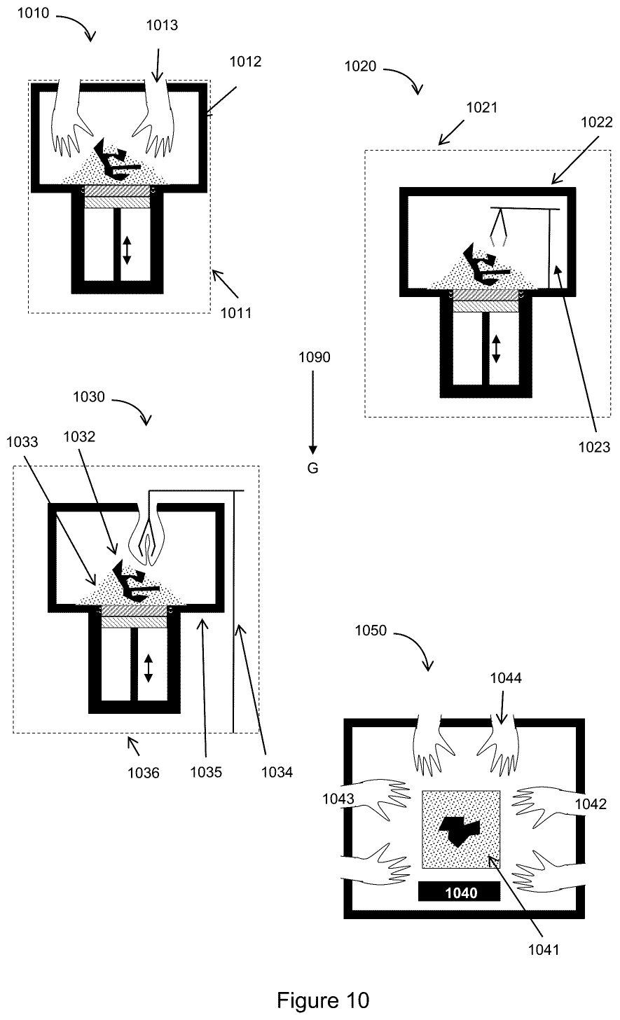

In some embodiments, when a build module is docked in the unpacking chamber, and the build module lid assembly (e.g., shutter) and the unpacking chamber closure (e.g., shutter) are opened (e.g., removed), the vertical translation mechanism (e.g., elevator) may elevate the 3D object with its respective material bed into the unpacking chamber. The unpacking chamber atmosphere may be controlled. The 3D object (e.g., FIG. 10, 1032) may be removed from the remainder (e.g., FIG. 10, 1033) of the material bed that did not transform to form the 3D object. The removal may be in a controlled atmosphere. The controlled atmosphere may be different from the ambient atmosphere external to the chamber in which the material bed is disposed of. For example, the atmosphere may be an inert atmosphere. The removal of the remainder may be manual and/or using a machine. The removal may be fully automatic, partially automatic, or manual. The unpacking stations illustrated in FIG. 10 show examples of 3D object removal using manual intervention (e.g., FIGS. 10, 1010, and 1050), or mechanical intervention (e.g., FIG. 1020 or 1030). The manual intervention may use at least one glove box. The machine (e.g., FIG. 10, 1023) may be situated in the unpacking chamber (e.g., FIG. 10, 1022). The machine (e.g., FIG. 10, 1034) may be situated in the unpacking chamber (e.g., FIG. 10, 1036) or in an ambient environment. The machine (e.g., FIG. 10, 1034) may be situated outside of the unpacking chamber (e.g., FIG. 10, 1035). The machine may be situated outside of the unpacking chamber such as FIG. 10, 1036. At least one side of the unpacking chamber (e.g., 1012) may merge with at least one respective side of the unpacking station chamber (e.g., 1011). At times, at least one side of the unpacking chamber (e.g., 1022) may not merge with at least one respective side of the unpacking station chamber (e.g., 1021). The mechanical intervention may comprise a motor, a tweezer, a hook, a swivel axis, a joint, a crane, drone, or a spring. The mechanical intervention device may comprise a robot. The mechanical intervention device may be controlled by at least one controller (e.g., locally and/or remotely). The remote control may use a remote input device. The remote control may use a remote console device (e.g., a joystick). The controller may use a gaming console device. The controller may use a home video game console, handheld game console, micro-console, dedicated console, or any combination thereof. The local controller may be directly connected to the unpacking station (e.g., using one or more wires), or through a local network (e.g., as disclosed herein). The local controller may be stationary or mobile. The remote controller may connect to the unpacking station through a network that is not local. The remote controller may be stationary or mobile. The unpacking station (e.g., unpacking chamber) may comprise its own controller. The controller may control (e.g., direct, monitor, and/or regulate) one or more apparatuses (e.g., other apparatuses) in the unpacking process, unpacking temperature, and/or unpacking atmosphere. The apparatuses in the unpacking process may comprise mechanical intervention devices, pre-transformed material removal devices (e.g., powder removal devices), and/or a closure (e.g., shutter).

In some embodiments, the unpacking station comprises an unpacking chamber. The unpacking chamber may be accessed from one or more directions (e.g., sides) by a person or machine located outside of the unpacking chamber. In some embodiments, in addition to the docking area (e.g., FIG. 10, 1041), the unpacking chamber may be accessed from at least one, two, three, four, five, or six directions by a person or machine located outside of the unpacking chamber. FIG. 10, 1010 shows an example of an unpacking chamber that can be accessed from the side of the unpacking chamber, and/or from the top of the unpacking chamber (e.g., 1013 using a glove box). FIG. 10, 1050 shows an example of a top view of an unpacking chamber that can be accessed by at least one person standing outside from at least one of three directions (e.g., 1044, 1042, and 1043). In some embodiments, the 3D object may be removed from an opening (e.g., a door) of the unpacking chamber. The removal of the 3D object may be directly from the unpacking chamber (e.g., not through the usage of the build module). The remainder of the pre-transformed material may be removed through an opening in a floor of the unpacking chamber, e.g., FIG. 10, 1040. The remainder of the pre-transformed material may be removed using an attractive force such as a vacuum, using a conduit such as a suction wand. FIG. 10 shows various examples of unpacking stations 1010, 1020, 1030, and 1050. The unpacking stations in examples 1010, 1020, and 1030 are shown as schematic side cross-sectional views with respect to the environmental gravitational vector 1090 pointing towards the environmental gravitational center G. Example 1050 shows a horizontal top view of an unpacking station.

In some embodiments, the build module may comprise a first atmosphere, the processing chamber may comprise a second atmosphere, and the unpacking station may comprise a third atmosphere. At least two of the first, second, and third atmosphere may be detectibly the same. At least two of the first, second, and third atmosphere may differ. Differ may be in material (e.g., gaseous) composition and/or pressure. For example, the pressure in the build module may be higher than in the processing chamber (e.g., before their mutual engagement). For example, the pressure in the build module may be higher than in the unpacking station (e.g., before their mutual engagement). For example, the pressure in the build module may be lower than in the unpacking station (e.g., before their mutual engagement). For example, the pressure in the build module may be lower than in the processing chamber (e.g., before their mutual engagement). At least two of the first, second, and third atmosphere (e.g., all three atmospheres) may have a pressure above ambient pressure. The pressure above ambient pressure may deter reactive agents from the ambient atmosphere to penetrate into an chamber having a positive atmospheric pressure (e.g., whether it is a build module, unpacking station, and/or processing chamber).

In some embodiments, the usage of reversibly closable (e.g., sealable) build modules may facilitate separation of the 3D object and/or any remainder of pre-transformed (e.g., starting) material that was not used to form the 3D object, from contacting at least one reactive agent in the ambient atmosphere. In some embodiments, the usage of reversibly closable (e.g., sealable) build modules may facilitate separation of a pre-transformed material from contacting at least one reactive agent in the ambient atmosphere.

In some embodiments, the build module disengages from the processing chamber, e.g., after printing of one or more 3D objects in a printing cycle. The build module may engage with an unpacking station for the unpacking of the 3D object(s) and/or separation of the 3D object(s) from (i) the build module, (ii) a remainder of the starting material that did not generate the 3D object(s), or (iii) a combination of (i) and (ii). At times, the unpacking station may not be ready to receive the build module for the unpacking operation. In such instances, the separated build module may be stored (e.g., may park), for example, in a waiting station. The waiting station may accommodate (e.g., house) one build module, e.g., and be referred to herein as an “individual waiting station.” The waiting station may accommodate (e.g., house) several separated build module, e.g., and may be referred to herein as a “collective waiting station”.

In some embodiments, a waiting station is utilized for storing build module(s). At least one build module of the build module(s) may enclosure starting material for the 3D printer, printed 3D object(s), or a remainder of the starting material with printed 3D object(s). The build module may be held by a framing system. The framing system may be a framing system dedicated for the waiting room. The framing system may be used along with the build module during the printing. The framing system may be used to hold the build module during its transfer from the 3D printer to the waiting station, and/or vice versa. The framing system may be used to hold the build module during its transfer from the waiting station to the unpacking station, and/or vice versa. The framing may include, or be operatively coupled with, a mounting system such as a kinematic mounting system. The kinematic mounting system may be configured to engage the framing with the build module. The kinematic mounting system may facilitate coupling the frame to the build module. The build module may be portable, e.g., using a vehicle such as a forklift or any other vehicle disclosed herein. The vehicle may transport the build module to the framing. The vehicle may transport the build module with the framing, e.g., when the build module is coupled with the framing. The mounting of the build module to the framing may be with at least a micrometer or a nanometer scale precision. The precision of the mounting may be repetitive, e.g., over multiple cycles of use such as over at least 1,000, 10,000, or 100,000 cycles of use. The waiting station may comprise an ambient atmosphere, e.g., an atmosphere in which users operate. The waiting station may comprise an internal atmosphere that is different than the ambient atmosphere by at least one atmospheric characteristic, e.g., as disclosed herein. In the waiting station, the build module may (A) be temperature adjusted such as cooled, (B) unpacked from its interior such as from a starting material, remainder material, build plate, and/or 3D object(s), (C) pre-purged, or (D) any combination thereof. Pre-purging may comprise purging before engaging the build module with a 3D printer (e.g., with a processing chamber thereof), and/or before engaging the build module with an unpacking station (e.g., with a unpacking chamber thereof).

In some embodiments, the waiting station has certain configurations configured to allow the build module to undergo various processes such as conditioning. In some embodiments, at least two individualized waiting stations of the collective waiting station can have different configurations. In some embodiments, at least two individualized waiting stations of the collective waiting station can have (e.g., substantially) the same configurations. A waiting station can include connections that can be reversibly engaged and disengaged with interconnects of a respective build module. Connections can be to source(s) comprising: gas sources (e.g., helium, argon, nitrogen, or the like), electrical sources, or hydraulic pressure source. Connections can be to system(s) comprising a control system, e.g., to control operation of a build platform assembly and/or to maintain the atmosphere in the build module. The waiting station can comprise a locking mechanism such as to secure (i) the build module and/or (ii) the framing frame with respect to the individual waiting station (e.g., as part of a collective waiting station). Individualized waiting stations can be configured to be supportive of a kinematic mounting platform for the build module.

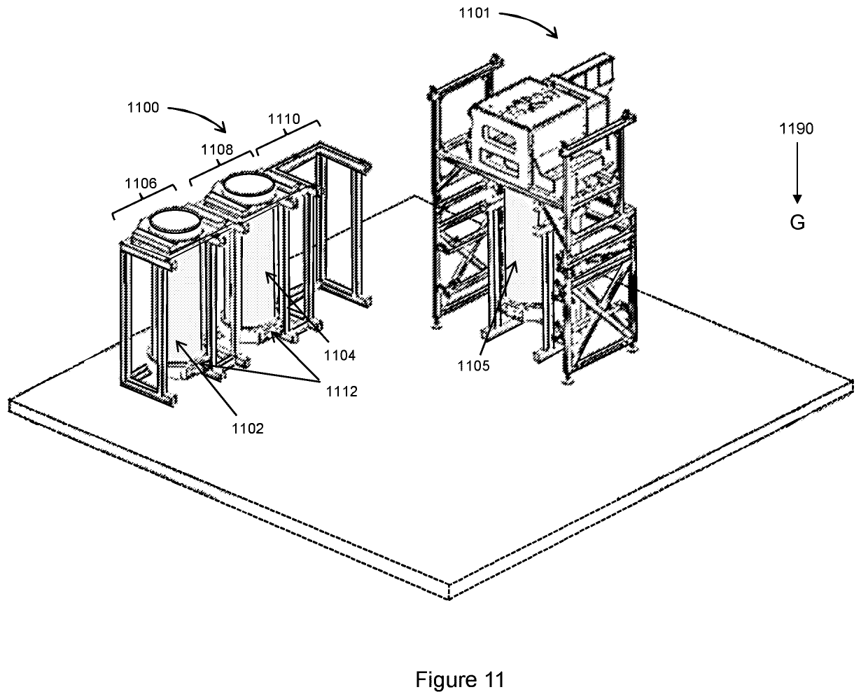

FIG. 11 shows an example of a 3D printing system and components depicted relative to the gravitational vector 1190 pointing to the gravitational environmental center G. As depicted in FIG. 11, a collective waiting station 1100 is depicted in which several build modules and several frames are disposed. Each of the frames configured to support a build module, e.g., using kinematic mounting that it may have. A 3D printing system 1101 may engage with build modules during respective number of 3D printing cycles, e.g., one build module per building cycle. Collective waiting station 1100 can be utilized (i) to prepare (e.g., purge), (ii) store (e.g., under inert atmosphere), and (iii) transfer the build modules 1102, 1104, to their subsequent density. The storage may be at an atmosphere different from the ambient atmosphere external to the 3D printer and to the build modules. The build module may be empty or full. Empty may be with respect to a material bed, and/or with respect to any 3D objects. The empty build module may be destined to engage with a processing chamber of a 3D printing system such as 1101. The build module may contain a printed 3D object when it is destined to an unpacking station, e.g., after the printing cycle ends. Build modules 1102, 1104 may be retained in collective waiting station 1100 while another build module 1105 is engaged with the 3D printing system 1101. Collective waiting station 1100 can include individualized waiting stations 1106, 1108, 1110. The 3D object(s) disposed in a build module may be unpacked from the build module (I) at the processing chamber, (II) at a dedicated unpacking station separate from the processing chamber, or (III) at the waiting station. Individualized waiting stations such as 1106, 1108, and 1110 can be configured for (A) build module cooling, (B) build module unpacking (e.g., of parts and pre-transformed/transformed material), (C) pre-purge (e.g., prior to and/or after a 3D printing process), or (D) any combination thereof. At least two individualized waiting stations of the collective waiting station can have (e.g., substantially) same configuration. At least two individualized waiting stations of the collective waiting station can have different configurations. Collective waiting station 1100 can include connections (not shown) that can be reversibly engaged/disengaged with interconnects 1112 of a respective build module such as 1102, and 1104. Connections can include gas sources (e.g., helium, argon, nitrogen, or the like), electrical, and/or hydraulic pressure source. Connections can include control system, e.g., to control operation of a build platform assembly, and/or to maintain the atmosphere in the build module. Unpacking stations 1106, 1108, 1110 include a frame for reversibly engaging and disengaging with a build modules such as 1102, 1104. Individualized waiting stations 1106, 1108, 1110 can include a locking mechanism (not shown) to secure the build module and/or frame with respect to the individualized waiting station. Individualized waiting stations such as 1106, 1108, and 1110 can be configured to be supportive of a kinematic mounting platform of the build module.

In some embodiments, the build module is being unpacked from its enclosed starting material, remainder material, build plate, and/or 3D object(s). The unused starting material removed from the 3D object(s) during unpacking may be recycled. The unpacking station may be operatively coupled with a recycling system. The recycling system can be the same, similar, or different from the recycling system of the 3D printer. The recycling system can be any recycling system disclosed herein. In some embodiments, the build platform assembly comprises a substrate, a base, a shaft, a post (e.g., posts), an encoder, a compartment associated with the encoder, a temperature adjustment system, a distance measuring scale (e.g., ruler), a sensor, a bent arm, or an actuator. The temperature adjustment system may comprise a temperature adjustment channel, a temperature adjustment chamber, or a temperature adjuster such as controller(s). Examples of 3D printing systems, unpacking stations, their components, associated methods of use, software, devices, systems, and apparatuses, can be found in International Patent Application Ser. No. PCT/US22/52588 filed Dec. 12, 2022, which is incorporated herein by reference in its entirety.

In some embodiments, the pre-transformed material is removed from the 3D object (e.g., within the unpacking chamber) by suction (e.g., vacuum), gas blow, mechanical removal, magnetic removal, or electrostatic removal. Examples of pre-transformed material removal, 3D printing systems, their components, associated methods of use, software, devices, systems, and apparatuses, can be found in International Patent Application Ser. No. PCT/US15/36802, or in U.S. patent application Ser. No. 17/881,797, each of which is incorporated herein by reference in its entirety. The pre-transformed material may comprise shaking the pre-transformed material (e.g., powder) from the 3D object. The shaking may comprise vibrating. Vibrating may comprise using a motor. Vibrating may comprise using a vibrator or a sonicator. The vibration may comprise ultrasound waves, sound waves, or mechanical force. For example, the 3D object may be disposed on a scaffold that vibrates. The ultrasonic waves may travel through the atmosphere of the unpacking chamber. The ultrasonic waves may travel through the material bed disposed in the unpacking chamber. The scaffold may be tilted at an angle that allows the pre-transformed material to separate from the 3D object. The scaffold may be rotated in a way that allows the pre-transformed material to separate from the 3D object (e.g., a centrifugal rotation). The scaffold may comprise a rough surface that can hold the 3D object (e.g., using friction). The scaffold may comprise hinges that prevent slippage of the 3D object (e.g., during the vibrating operation). The scaffold may comprise one or more holes. The scaffold may comprise a mesh. The one or more holes or mesh may allow the pre-transformed material to pass through, and prevent the 3D object from passing through (e.g., such that the 3D object is held on an opposite side of the mesh from the removed pre-transformed material).

In some embodiments, the removal of the pre-transformed material comprises using a modular material removal mechanism. The material removal mechanism may be similar to the one used for leveling the exposed surface of the material bed. The material removal mechanism may be interchangeable between the 3D printing enclosure and the unpacking enclosure (e.g., chamber). For example, the material removal mechanism may be interchangeable between the processing chamber and the unpacking chamber. For example, the material removal mechanism may be used for at least one of leveling an exposed surface of a material bed, cleaning the processing chamber (e.g., from excess pre-transformed material), and removing the pre-transformed material from the 3D object. The material removal mechanism may remove the pre-transformed material and sieve it.

In some embodiments, the build module is closed by a lid assembly prior to its disengagement from the processing chamber, e.g., and after printing of 3D object(s). The lid assembly may be stored (e.g., substantially) vertically in an environment of the processing chamber, e.g., before, during and/or after the 3D printing. The lid assembly may be stored along a vertical wall of the processing chamber. The lid assembly may be stored in a casing. The casing may be part of the vertical wall of the processing chamber. The casing may be operatively coupled with the processing chamber. The casing may have an opening through which the build module can reversibly enter and exit. The opening may remain open to an interior space of the processing chamber, e.g., before, during and/or after the 3D printing. The opening may be devoid of a closure, e.g., devoid of a door or devoid of a window. During storage, at least a portion of the lid assembly may be disposed in the casing. The portion of the lid assembly disposed in the casing may be sufficient to hold it in a (e.g., substantial) vertical position. In some embodiments, the lid assembly is partially outside of the casing during storage. The part of the lid assembly outside of the casing during storage, can be disposed in the interior space of the processing chamber. The casing may be disposed as part of, or may be operatively coupled with, a front wall of the processing chamber. For example, the casing may be disposed immediately adjacent to (e.g., and contacting) a primary door of the processing chamber. The primary door of the processing chamber may comprise a handle mechanism that facilitate reversible opening and closing of the primary door, e.g., by swiveling it along a (e.g., vertical) axis. The primary door of the processing chamber may comprise a viewing window (e.g., comprising one or more viewing windows) that allow user(s) to (e.g., safely) view the interior space of the processing chamber without opening the primary door. The viewing windows may be configured to protect the user from processes occurring in the processing chamber. The viewing windows may be configured to protect the user from energy beam(s) used in the processing chamber. The viewing windows may be configured to withstand the interior conditions of the processing chamber, e.g., before, during, and/or after the 3D printing. The primary door may comprise a secondary door. The secondary door may be configured to reversibly open and close, e.g., along a direction that is (e.g., substantially) the same or different from that of the primary door. For example, the secondary door is configured to reversibly open and close along a direction that is different from that of the primary door, such as a perpendicular direction thereto. The secondary door may comprise a flexible boundary. The flexible boundary may allow a user to reach into the processing chamber through the secondary door, manipulate components in the processing chamber, while maintaining environmental separation between the interior environment of the processing chamber and the ambient environment. The secondary door may comprise one or more portals coupled to the flexible boundary. The flexible boundary may comprise a polymer or a resin. The flexible boundary may be in a form (e.g., a type) of a glove. The secondary door may comprise a door to a glove box type arrangement. The build module may comprise, or be operatively coupled with a control system, e.g., that facilitates maneuvering of the build module such as before, during and/or after the printing.

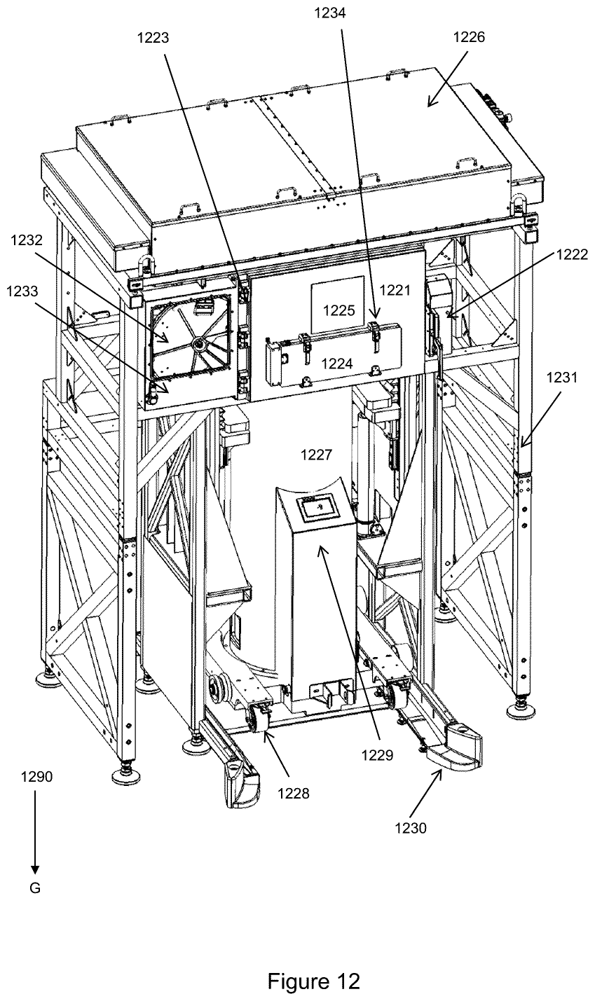

FIG. 12 shows an example of a portion of a 3D printing system shown with respect to gravitational vector 1290 pointing towards the gravitational center of the ambient environment external to the 3D printer. The 3D printer has a processing chamber comprising a primary door 1221 that includes handle 1222 as part of a handle mechanism by which the door can swivel about hinges such as 1223 to reversibly open and close, e.g., by a user. The primary door 1221 of the processing chamber has a secondary door 1224, which when opened, provides access to the interior of the processing chamber by a user while maintaining an atmospheric separation between the interior of the processing chamber and the ambient environment, e.g., using an arrangement similar to a glove box arrangement. Primary door 1221 comprises viewing window area 1225. The viewing window area can accommodate one or more viewing windows through which a user in an ambient environment can view an interior of the processing chamber while being separate from an internal environment of the processing chamber. An optical enclosure 1226 is disposed above the processing chamber, e.g., to facilitate scanning of energy beam(s) directed from outside to the processing chamber into the internal environment of the processing chamber, e.g., through optical window(s) (not shown). A build module 1227 is situated below the processing chamber 1221 and engages with the processing chamber 1221. Build module 1227 comprises wheels such as 1228 to facilitate its maneuvering to reversibly enter an engagement position with the processing chamber and to reversibly exit the engagement position with the processing chamber. Build module 1227 comprises a control port 1229, e.g., that can facilitate its (i) disengagement with the processing chamber, (ii) engagement with the processing chamber, (iii) entrance to an engagement position with the processing chamber, (iv) exit from an engagement position with the processing chamber, or (v) any combination of (i) to (iv). The build module 1227 is supported by a framing system having railing 1230. The railing 1230 may be configured to engage with a maneuvering vehicle such as a forklift. The 3D printer comprises a framing 1231 configured to support various components of the 3D printer such as the processing chamber 1221 and the optical system enclosure 1226. Lid assembly (e.g., shutter) 1232 is configured to close (e.g., shut) a top opening of build module 1227, e.g., before its disengagement from the processing chamber (e.g., and after the 3D printing process). Lid assembly 1232 is configured to close (e.g., shut) a top opening of build module 1227 when the lid assembly is in a (e.g., substantially) horizontal position, not shown. During storage, lid assembly 1232 is disposed (e.g., substantially) vertically as shown in FIG. 12, in a lid assembly storage compartment—casing 1233. The casing can be placed in a front wall of the processing chamber, or be part of the front wall of the processing chamber. Casing 1233 is disposed adjacent to primary door 1221. The lid assembly can traverse from the casing into a position in front of door 1221 while in the interior environment of the processing chamber, and then maneuvered from its vertical position to a horizontal position, e.g., to shut the processing chamber. Maneuvering of the lid assembly can be done entirely manually, partially manually, or automatically. For example, maneuvering of the lid assembly can be done entirely manually by a user through use of the secondary opening 1224, e.g., using a glove box type arrangement. Secondary opening 1224 is secured by fasteners such as 1234 to primary door 1221. The casing may comprise a cassette or a cartridge. The cartridge may comprise a case or a container configured to hold the lid assembly. The lid assembly in the cartridge may be difficult, troublesome, or cumbersome to handle, e.g., in the internal atmosphere of the processing chamber or of the unpacking station. The lid assembly in the cartridge can be exchanged. The cassette can comprise a flat and/or planar case or cartridge that can be (e.g., reversibly) loaded or unloaded relative to the chamber, e.g., processing chamber or unpacking chamber. The cassette can comprise a substantially flat case or cartridge that can be (e.g., reversibly) loaded or unloaded with the lid assembly and/or associated lid maneuvering assembly comprising a retaining arm operatively (e.g., physically) coupled with the casing, and reversibly coupled with the lid assembly. The substantially flat casing may have a smaller width relative to its length and/or height. The casing (e.g., cartridge) may have an opening port from which the lid assembly can reversibly enter and exit.

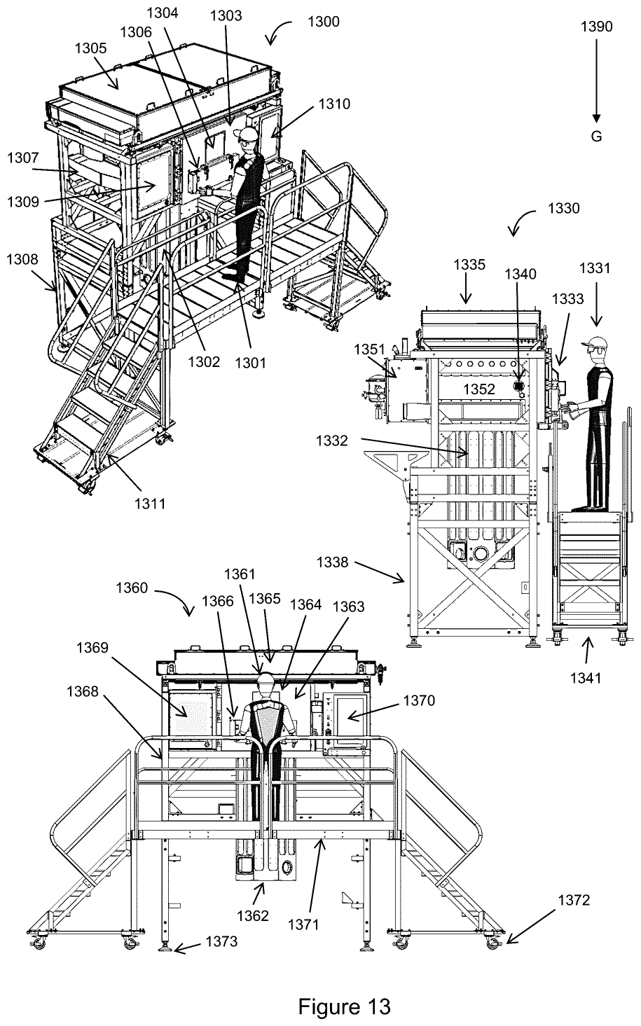

FIG. 13 shows an example of a perspective view of a portion 1300 of a 3D printing system shown with respect to gravitational vector 1390 pointing towards the gravitational center of the ambient environment external to the 3D printer. User 1301 stands on a bridge having stairs such as 1311 and railing. Thus, user 1301 is elevated from the ground surface. Build module 1302 is engaged with processing chamber having primary door 1303 facing user 1301. Primary door 1303 comprises viewing window area 1304 that can accommodate one or more viewing windows through which user 1301 can view into the processing chamber, e.g., during operation of energy beam(s) disposed in the processing window. Optical enclosure 1305 houses at least one optical arrangement for the energy beam(s), e.g., to direct the energy beam(s) from their energy source(s) into the processing chamber space. Primary door 1303 includes secondary door 1306 that allows user 1301 to access an arrangement facilitating user 1301 to reach into the interior of the processing chamber while remaining separate from the internal environment of the processing chamber, e.g., using a glove box type arrangement. Gas enters the processing chamber through gas conveyance channel such as 1307. Various components of the 3D printer are supported by framing system 1308. Build module 1302 can be closed (e.g., shut) by a lid assembly, e.g., before its disengagement from the processing chamber. The lid assembly (e.g., shutter) can be applied in the internal environment of the processing chamber, e.g., that is different from the ambient environment. The lid assembly can be stored (e.g., substantially) vertically when idle, e.g., in casing 1309 disposed along, or as part of, the frontal wall of the processing chamber facing user 1301. User 1301 can control (e.g., monitor and/or alter) progress of operations associated with the 3D printer, e.g., using screen 1310.

FIG. 13 shows an example of a side view of a portion 1330 of 3D printing system 1300. 3D printer portion 1330 is shown with respect to gravitational vector 1390 pointing towards the gravitational center of the ambient environment external to the 3D printer. User 1331 stands on a bridge having stairs such as 1341 and railing. Thus, user 1331 is elevated from the ground surface. Build module 1332 is engaged with processing chamber 1352 having primary door 1333 facing user 1331. Optical enclosure 1335 houses at least one optical arrangement for the energy beam(s), e.g., to direct the energy beam(s) from their energy source(s) into the processing chamber space. Primary door 1333 includes secondary door that allows user 1331 to access an arrangement facilitating user 1331 to reach into the interior of the processing chamber while remaining separate from the internal environment of the processing chamber, e.g., using a glove box type arrangement. Various components of the 3D printer are supported by framing system 1338. Processing chamber 1352 is coupled with an ancillary enclosure 1351 configured to house a layer dispensing mechanism, e.g., when it is idle. The layer dispensing mechanism can reversibly translate towards door 1333 and back into ancillary chamber 1351, e.g., to dispense a layer of starting material, which translation is facilitated by actuator 1340. Positioning of user 1331 above the ground level may facilitate engagement, disengagement, entrance, and/or exit, of build module 1332 with respect to processing chamber 1352.

FIG. 13 shows an example of a front view of a portion 1360 of a 3D printing system portions 1300 and 1330. 3D system portion 1360 is shown with respect to gravitational vector 1390 pointing towards the gravitational center of the ambient environment external to the 3D printer. User 1361 stands on bridge 1371 having stairs and railing. Thus, user 1361 is elevated from the ground surface. Build module 1362 is engaged with processing chamber having primary door 1363 facing user 1361. Primary door 1363 comprises viewing window area 1364 that can accommodate one or more viewing windows through which user 1361 can view into the processing chamber, e.g., during operation of energy beam(s) disposed in the processing window. Optical enclosure 1365 houses at least one optical arrangement for the energy beam(s), e.g., to direct the energy beam(s) from their energy source(s) into the processing chamber interior space. Primary door 1363 includes secondary door 1366 that allows user 1361 to access an arrangement facilitating user 1361 to reach into the interior of the processing chamber while remaining separate from the internal environment of the processing chamber, e.g., using a glove box type arrangement. Various components of the 3D printer are supported by framing system 1368. Build module 1362 can be closed (e.g., shut) by a lid assembly, e.g., before its disengagement from the processing chamber. The lid assembly (e.g., shutter) can be applied in the internal environment of the processing chamber, e.g., that is different from the ambient environment. The lid assembly can be stored (e.g., substantially) vertically when idle, e.g., in casing 1369 disposed along, or as part of, the frontal wall of the processing chamber facing user 1361. User 1361 can control (e.g., monitor and/or alter) progress of operations associated with the 3D printer, e.g., using screen 1370. Framing 1368 includes feet such as 1373 facilitating leveling of the framing with respect to a floor, with respect to the horizon (e.g., normal to gravitational vector 1390). Bridge 1371 can be maneuvered with respect to the processing chamber using wheels such as 1372. Maneuvering of the bridge may take place, e.g., during maneuvering of build module 1362 with respect to the processing chamber. Maneuvering of the bridge may allow entrance of build module 1362 into an engagement position with the processing chamber. Maneuvering of the bridge may allow a transport vehicle (e.g., forklift) to access the space below the processing chamber, e.g., to engage or disengage the transport vehicle with the build module. Maneuvering of the bridge may comprise moving the bridge (with stairs and railing) away from the processing chamber. Maneuvering of the bridge may comprise returning the bridge (with stairs and railing) away from the processing chamber. The bridge may be adjusted spatially, e.g., to allow users of different height to view and/or access an interior of the processing chamber ergonomically. Spatial arrangement of the bridge may comprise vertical adjustment of the bridge. The spatial adjustment of the bridge may comprise manual and/or automatic adjustment.

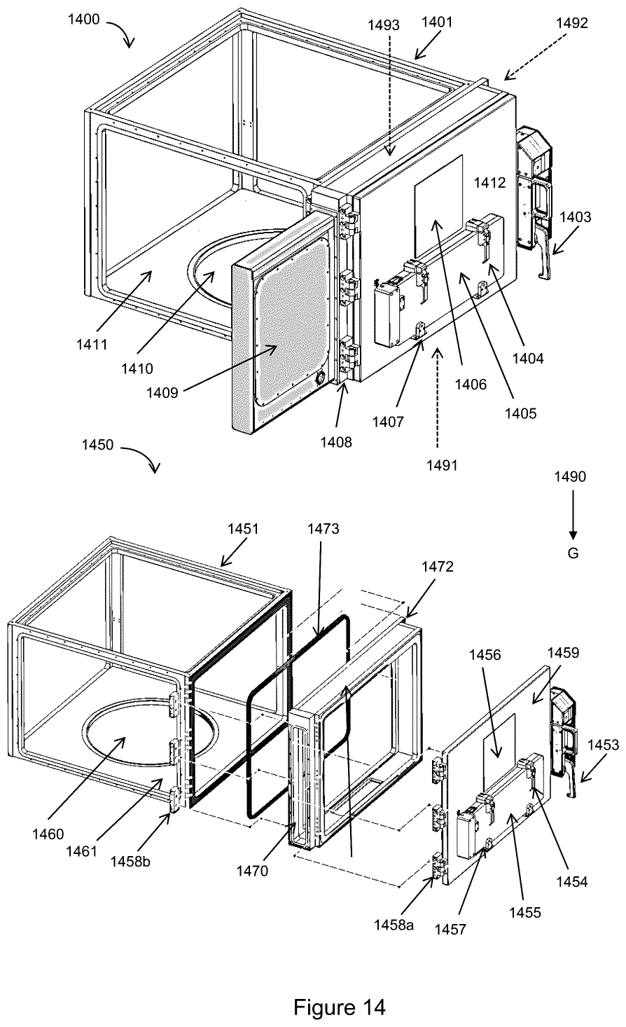

FIG. 14 shows in example 1400 a portion of a 3D printing system shown in perspective view with respect to gravitational vector 1490 pointing towards the gravitational center of the ambient environment external to the 3D printer. 3D printing system portion 1400 includes a processing chamber having framing 1401, the processing chamber including an opening 1410 at the processing chamber floor 1411, a primary door 1412 comprising a primary handle 1403, a viewing window area 1406 that can accommodate one or more viewing windows, a secondary door 1405 having fasteners such as 1404 and secondary hinges such as 1407, and a lid assembly storage compartment that is a casing 1409. The primary door 1412 can pivot about primary hinges such as 1408 with respect to the processing chamber framing 1401. Secondary door 1404 can pivot about its secondary hinges including 1407 relative to the primary door. The primary door can facilitate accessing the interior space of the processing chamber from the ambient environment while exposing the interior space to the ambient environment (e.g., atmosphere) external to the processing chamber. The secondary door can facilitate accessing the interior space of the processing chamber while maintaining separation of the internal atmosphere of the processing chamber from the ambient environment, e.g., using a glove box type arrangement. The processing chamber can facilitate (e.g., reversible) engagement and disengagement of a build module with the processing chamber, e.g., to allow an energy beam to impinge on a target surface disposed in the opening and/or in the build module. The target surface may retract into the build module in a stepwise fashion during the 3D printing, in a downwards direction, e.g., away from the floor of the processing chamber in a direction of gravitational vector 1490 and into the interior space of the build module. The build module and target surface are not shown in the examples in FIG. 14.

In some embodiments, the casing is operatively (e.g., physically) coupled with an extension of a processing chamber framing. The extension is configured to maintain the environmental conditions in the processing chamber, e.g., before, during and/or after the printing. The extension may be coupled with the processing chamber framing by components comprising a seal, a fastener, a hinge pin, or a door latch. The seal, fastener, hinge pin, and the door latch may be any of the ones disclosed herein.

FIG. 14 shows in example 1450 a portion of a 3D printing system shown as an exploded view with respect to gravitational vector 1490 pointing towards the gravitational center of the ambient environment external to the 3D printer. 3D printing system portion 1450 includes a processing chamber having framing 1451, the processing chamber including an opening 1460 at the processing chamber floor 1461, a primary door 1459 comprising a primary handle 1453, a viewing window area 1456 that can accommodate one or more viewing windows, a secondary door 1455 having fasteners such as 1454 and secondary hinges such as 1457, and a side opening 1470 configured to operatively coupled with lid assembly storage compartment (e.g., a casing, not shown), the side opening 1470 configured to facilitate reversible extraction and retraction of a build module lid assembly (not shown) and associated maneuvering mechanism (e.g., retaining arm). The side opening is part of structural extension 1472 to processing framing 1451, the structural extension being toward a user disposed facing primary door 1459. Structural extension 1472 is coupled with the processing chamber framing using seal 1473. The seal can be a hermetic seal, e.g., a gas tight seal. The seal can be configured to maintain the internal environment (e.g., comprising the internal atmosphere) of the processing chamber different from the ambient environment, e.g., during operation and when the primary door is closed. The primary door 1459 can pivot about primary hinges comprising sections 1458a and 1458b with respect to the processing chamber framing 1451. Numeral 1458a points to one section of a hinge coupled with primary door 1459, and numeral 1458b points to a second section of the hinge coupled with processing chamber framing 1451. By their mutual coupling through a lock pin (e.g., along the hinge axis) to form an assembled hinge, the two hinge sections of each hinge facilitate coupling of primary door 1459 to processing chamber framing 1451. Secondary door 1404 can pivot about its secondary hinge axes including 1407 relative to the primary door.

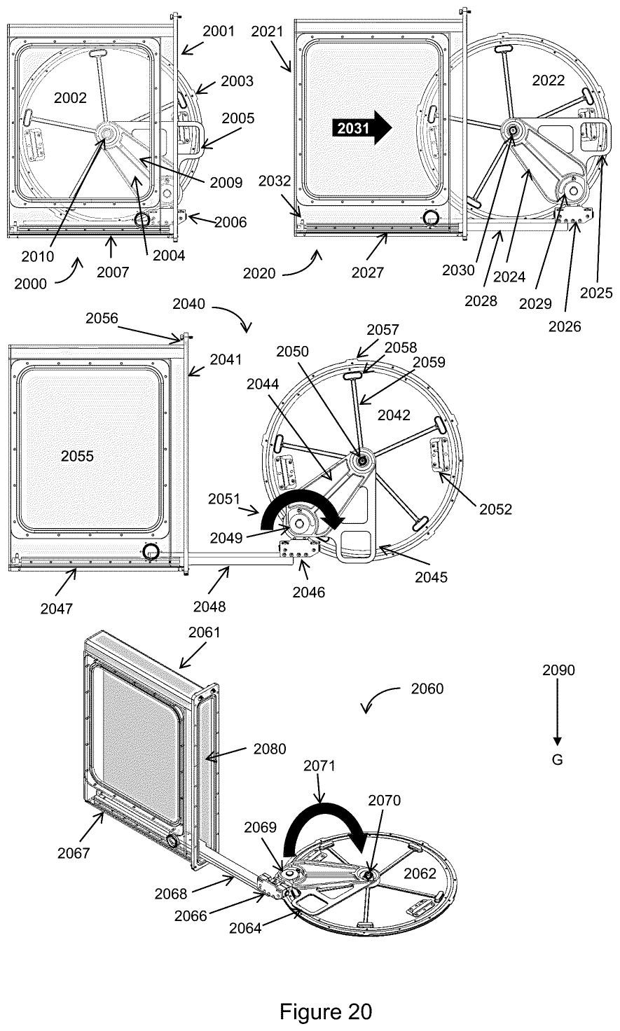

In some embodiments, a casing is disposed adjacent to (e.g., contacting) a primary door of the chamber. The chamber can be a processing chamber or an unpacking chamber. The door can engage with a side of the primary door. For example, with a right side, left side, bottom side, or top side. In some embodiments, the casing is reversibly engageable with the chamber. For example, the casing can reversibly attach and detach from the chamber. FIG. 14 shows an example of casing 1409 disposed to the left of primary door 1412, when looking at the primary door from an ambient environment. In another embodiment, the casing can be attached to the right side 1492 of primary door 1412, to the top side 1493 of primary door 1412, or to the bottom side 1491 of primary door 1412. The casing can attach to the chamber using fasteners (e.g., FIG. 20, 2056). The fasteners may comprise snap fit attachment(s), screw(s), clamp(s), or nail(s). The casing can attach to the chamber using railing. For example, the casing can attach to the chamber in the form of a drawer fitting into a drawer track. For example, the casing can be clamped onto the chamber.

In some embodiments, a lid assembly is used to close the build module. Closure of the build module may be for a purpose of maintaining an internal atmosphere in the build module that is different from the ambient atmosphere outside of the build module. Closure of the build module may be for a purpose of maintaining an internal atmosphere in the build module that is (e.g., substantially) the same as the atmosphere in the chamber. The chamber may comprise the processing chamber or the unpacking chamber. The lid assembly may comprise at least one mechanism to physically couple the lid mechanism to the body of the build module. At least one mechanism may be configured to lock, shut, fasten, and/or hold in place the lid assembly with respect to the build module. At least one mechanism may comprise a seal, an engager, or a pin. The seal may be any seal disclosed herein. For example, the seal may comprise an O-ring. The makeup of a seal may comprise a polymer or a resin. The seal may be flexible. The lid mechanism may comprise engagers. The engagers may be equally spaced along the lid assembly. The engager(s) may be disposed of along the rim of the ring assembly. The engager may comprise a protrusion in the circumference of the lid assembly, e.g., in a direction away from the center of the lid assembly. For example, the engagers may be disposed of at equal distances along the rim of the lid assembly. The engager may comprise a tab, an ear, or a latch. The engager may comprise a flange tab such as a beta flange tab. The engager may comprise a planar portion, e.g., be planar. The engager may comprise a non-planar portion. For example, the engager may comprise an ellipsoid portion, e.g., may comprise a ball. The lid assembly may comprise concentric components. The engager may be considered a male portion, and the engager receptacle may be considered a female portion. The lid assembly may comprise a locking ring having the engagers. The build module may comprise an opening having the engager receptacles. The lid assembly may engage with the build module opening at least in part by (e.g., manually) placing the lid assembly onto the opening of the build module such that the engagers fit into the position of the engager receptacles. Once the lid assembly is fitted into place with the engagers of the build module, the lid assembly may be pivoted to tuck the engager into the engager receptacles, e.g., to lock each engager into its respective engager receptacle. The engager may be a projection on the rotatable portion of the lid assembly (e.g., the sealing ring). The engager may be configured to make sliding contact with the engager receptacle, e.g., while rotating the engager with respect to the receptacle. The engager may impart reciprocal or variable motion to the engager receptacle. The engager may be reversibly locked and unlocked in one direction (e.g., vertical direction) by the engager, on rotation (e.g., pivoting) of the engager relative to its engager-receptacle. The engager may have a cavity ending with a stopper (e.g., a wall of the receptacle). The end of the cavity hinders continued rotation of the engager past the engager receptacle. The (partial) rotation may be clockwise or in a counterclockwise direction. The pivoting may be about an axis going through the center of the lid assembly. The engager may cam over from the first side of the engager receptacle which is devoid of a ceiling, to the second side of the engager receptacle which has a ceiling.

An exposed surface of the lid assembly may comprise a handle. The handle may be configured to allow maneuvering (e.g., by a user) the lid assembly in space. For example, the lid assembly can comprise two handles. The two handles may be disposed symmetrically about a center of the lid assembly. The handle may be affixed to the lid assembly using one or more fixtures (e.g., screws). A central portion of the lid assembly may be equipped with a central receptacle. The central receptacle (e.g., socket) may be configured to reversibly engage and disengage with a retaining arm, with a lock pin, and/or with a drive spinner. The lock pin can include a ball lock pin, a (e.g., quick) release pin, a spring lock pin, a coupling pin, or any combination thereof. The drive spinner may comprise a hex drive spinner. The drive spinner may comprise a ratchet. The lid assembly may comprise on a skeletal rod. For example, the lid assembly may comprise several skeletal rods. The skeletal rod may extend from a central portion of the lid assembly toward a distal opening. The skeletal rods may be equally distanced along an exposed surface of the lid assembly. The skeletal rods may divide the lid assembly into (e.g., substantially) equal portions. The lid assembly may comprise a distal opening. The distal opening may have a shape that facilitates translation of the guiding post with respect to the distal hole. For example, the lid assembly may comprise distance openings. Each of the distal openings may be disposed in front of an engager. The distal openings may be equally spaced along an exposed surface of the lid assembly, e.g., along a rim of the lid assembly. The engager, the distal opening, and the skeletal rod may be aligned along the skeletal rod. The distal opening may comprise a guiding post. The distal opening may be configured to move with respect to the guiding post, e.g., by using the drive spinner. Movement of the distal opening with respect to the guiding post may cause the seal to compress. The lid assembly may comprise a retaining ring, lid top plate (e.g., locking plate), locking ring, lid base plate, seal (e.g., O-ring), and/or a sealing ring. The seal can be hollow and/or porous. The seal can be compressible. The seal may comprise rubber, nitrile, latex, or silicone. The seal may comprise a polymer or a resin. The seal may comprise an organic or a silicon based material. The locking plate may comprise an exposed surface of the lid assembly. The locking plate may comprise the skeletal rod, the distal opening, the handle, the fastener of the handle, and a central receptacle (e.g., socket). The locking ring may comprise the engager. The guiding post may be coupled with, or may be part of, the lid base plate. The retaining ring may have an opening for the guiding post to go through. The locking plate may be configured to move with respect to the lid sealing ring, base plate, and/or with respect to the retaining ring. When assembling the lid assembly, each of the guiding post is engaged with each of the distal opening, respectively. The locking plate may rotate at least in part (e.g., pivot) by using the drive spinner. An extend of movement of the locking plate may be determined by the extent of movement of the distal opening relative to the guiding post with which it is engaged. The build module may comprise an engager receptacle, e.g., disposed at the rim of its top opening. For example, the build module comprises engager receptacles, e.g., disposed the rim of its top opening. The engager receptacles may be equally spaced along the rim of the top opening of the build module. The engager receptacles may be concentrically spaced along the rim of the top opening of the build module. The engager receptacle may be configured to receive an engager of the lid assembly. The rim of the top opening of the build module may be configured to receive each receptacle of the lid assembly. In a first section of the receptacle, the receptacle of the build module may be configured to receive the engager from a top position going down in a direction towards a bottom of the build module. The receptacle may be configured to allow the engager to slide horizontally along a body of the receptacle from the first section to a second section of the receptacle. In the second section of the receptacle, the receptacle may be configured to hinder the engager from disengaging from the receptacle upwards in a vertical position in a direction away from a bottom of the build module. The lid assembly may comprise at least 2, 3, 5, 7, or 9 engagers. The lid assembly may comprise at least 2, 3, 5, 7, or 9 skeletal rods. The lid assembly may comprise at least 2, 3, 5, 7, or 9 guiding posts. The lid assembly may comprise at least 2, 3, 5, 7, or 9 distal openings. The lid assembly may comprise at most 3, 5, 7, 9, or 12 engagers. The lid assembly may comprise at most 3, 5, 7, 9, or 12 skeletal rods. The lid assembly may comprise at most 3, 5, 7, 9, or 12 guiding posts. The lid assembly may comprise at most 3, 5, 7, 9, or 12 distal openings. The first component set may be centrally aligned, the first component set comprising a skeletal rod, the distal opening, and the engager. Members of the second component set may be disposed concentrically with respect to the lid assembly. The second component set may include a component type comprising the engagers, the skeletal rods, the distal openings, or the guiding posts. Members of the second component set may be equi-distanced with respect to a circumference of the lid assembly. Members of the second component set may be arranged (e.g., substantially) symmetrically with respect to a circumference of the lid assembly. For example, members of the second component set may be arranged (e.g., substantially) symmetrically with respect to a rotational axis disposed at the center of the lid assembly and (e.g., substantially) perpendicular to an area enclosed by the locking ring and/or a planar exposed surface of the locking plate of the lid assembly. For example, members of the second component set may relate to each other by a Cn symmetry axis, with n designating the number of members in the second component set. For example, members of the second component may relate to each other by a C2, C3, C5, C7, C9, or C12 rotational symmetry axis. For example, when the lid assembly has three engagers, they may relate to each other by a C3 rotational symmetry axis going through the center of the lid assembly. In that case the lid assembly may comprise three skeletal rods, three distal openings and three guiding posts. For example, when the lid assembly has seven engagers, they may relate to each other by a C7 rotational symmetry axis going through the center of the lid assembly. In that case the lid assembly may comprise seven skeletal rods, seven distal openings and seven guiding posts. Each engager, distal opening, and skeletal rod may be aligned along a long axis of the skeletal rod. Each distal opening may engage with a guiding post. The lid assembly may have a number of members of the second component set such that upon closure (e.g., and seal) of the build module by the lid assembly, the closed build module and lid assembly may maintain the requested internal environment in the build module for a prolonged time, e.g., until its opening is requested. The requested conditions maintained in the build module during storage may be any of those disclosed herein, e.g., concerning at least one atmospheric condition such as comprising pressure, level of a reactive agent, or temperature. In some cases, the prolonged time may be for the storage period, e.g., as disclosed herein. For example, the storage period may be at least about 0.5 day, 1 day, 5 days, 7 days, 10 days, 30 days, or 60 days.

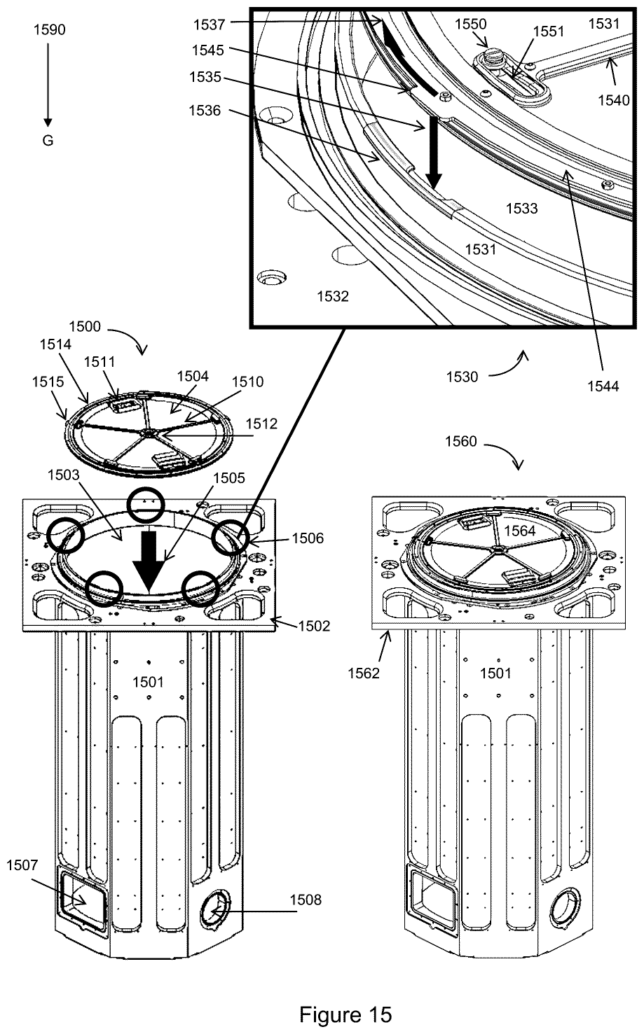

FIG. 15 shows an example of portion 1500 of a 3D printing system shown with respect to gravitational vector 1590 pointing toward the gravitational center of the ambient environment external to the 3D printer. In portion 1500, build module 1501 is coupled with plate 1502 configured to couple to a floor of a processing chamber, the floor having central opening 1503. Build module 1501 is open, and lid assembly 1504 is directed downwards in direction 1505 to close a top opening of build module 1501. The plate (e.g., coupling plate) is configured to couple to the floor of a chamber from a side of the floor facing outside of the processing chamber, e.g., the external side of the floor. The chamber can comprise a processing chamber or an unpacking chamber. The plate of the build module is configured to couple to the floor of the chamber externally relative to the processing chamber. The plate of the build module is configured to couple to the floor of the chamber beneath the floor of the chamber with respect to the gravitational vector of the ambient environment outside of the chamber. Lid assembly 1504 comprises five skeletal rods such as 1510, the five skeletal rods extending from a central portion of the lid assembly towards an engager, e.g., a flange tab such as a beta flange tab. Lid assembly 1504 includes two handles 1511 are configured to swivel about an axis parallel to an external surface of the two handles being disposed symmetrically to each other about the center of the lid assembly. The center of the lid assembly is equipped with a central receptacle 1512 configured to reversibly engage and disengage with a retaining arm (not shown), with a lock pin (not shown), and/or with a drive spinner (e.g., hex drive spinner). Lid assembly 1504 and build module 1501 are configured to couple via five engagers such as 1515 in the form of (e.g., planar) protrusions that function as stationary latches. The five engagers are disposed along the circumference of a locking ring 1514 coupled to the lid assembly, the five engagers being equally spaced along the circumference. In other embodiments, the five engagers can be part of the body of the lid assembly, and the lid assembly is devoid of the locking ring. In the example shown in portion 1500, build module 1501 and lid assembly 1504 are configured to couple via five engager receptacles such as 1506, each being configured to receive and engage with an engager upon rotation (e.g., pivoting) of the lid assembly relative to plate 1502. An enlarged view of engager receptor 1506 is shown in enlarged view 1530. Building module 1501 has side openings 1507 and 1508. Any side openings 1507 and 1508 can be fitted with a door. Any openings 1507 and 1508 can be fitted with a window such as a viewing window. Any openings 1507 and 1508 can be utilized for control, inspection, and/or maintenance of the build module and its associated mechanisms disposed of in the interior of the build module.

FIG. 15 shows an example enlarged view 1530 of a portion of lid assembly 1531 showing a portion 1540 of a skeletal rod extending from a central portion of the lid assembly towards engager 1545 which is part of locking ring 1544. The skeletal rod portion ends in a distal opening 1551 having an oblong shape. Distal opening 1551 facilitates compressing a seal (e.g., O-ring) disposed of in an opposing side of the lid assembly, the opposing side configured to face a downward direction once the lid assembly closes the build module. The downward direction is a direction toward the gravitational center of the environment. The distal opening facilitates alteration of the compressed state of the lid assembly 1531 with respect to build module 1531, e.g., by varying the position of a guiding post (e.g., screw) 1550 with respect to the distal opening. Engager 1545 is configured to couple with engager receptacle 1536 disposed about an opening of build module portion 1531 engaged with plate portion 1532. Engager receptacle 1536 comprises (i) an upper depression in its ceiling configured to accept an engager from above, and (ii) a covered ceiling portion (e.g., a partial pocket) configured to accept the engager from a side and cover it from above. The engager receptacle is configured to remain open along its side facing the center of the build module opening, to allow partial sliding of the engager along a portion of the circumference of the opening to allow reversible (i) locking and unlocking of the engager with respect to the engager receptacle and (ii) engagement and disengagement of the engager with the engager receptacle. The lid assembly can be lowered down towards opening 1533 of build module 1531 in the first direction of arrow 1535 to facilitate the engagement of engager 1545 with the ceiling depression in engager receptacle 1536. The lid assembly can then be rotated (e.g., pivoted) in a second direction along arrow 1537 to move the engager into the covered portion of engager receptacle 1536, to lock the lid assembly and hinder its movement along a direction opposite to the first direction of arrow 1535. The lid assembly can then be sealed by pressing a sealed example an O-ring disposed at the face of the lid assembly facing the interior of the build module (O-ring not shown). Such sealing is accomplished at least in part by rotating (e.g., pivoting) the locking plate with respect to the build module and/or by toggling the position of the lock pin, e.g., to extend the lock pin.

FIG. 15 shows an example of portion 1560 of a 3D printing system shown with respect to gravitational vector 1590 pointing toward the gravitational center of the ambient environment external to the 3D printer. Example 1560 depicts build module 1561 engaged with plate 1562. The plate can be configured to couple to a floor of the processing chamber, and/or to a floor of an unpacking chamber. Build module 1561 has lid assembly 1564 engaged with its top opening to close it.

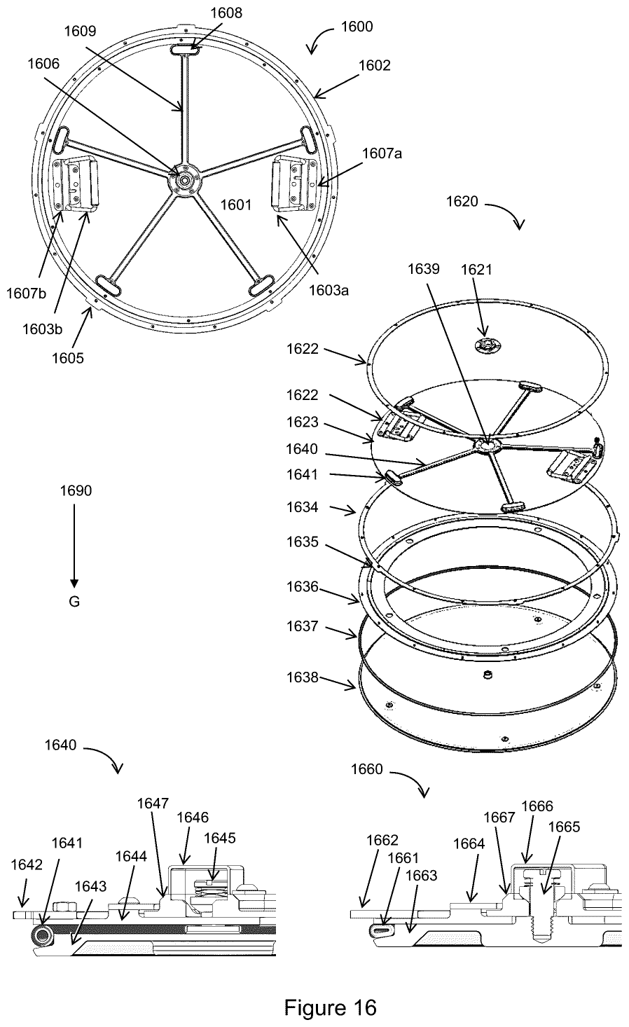

FIG. 16 shows an example of a top surface of lid assembly 1601 coupled with locking ring 1602 having five equi-spaced engagers, such as 1605, the engagers being disposed along its circumference, the engagers being (e.g., planar or non-planar) protrusions in a direction outwards of the ring, the planar engager having planarity of a top surface of the ring and/or parallel to a top planar surface of lid assembly 1601. The engager can comprise a tab or a flange. For example, the engager can comprise a flange tab such as a beta flange tab. In some embodiments, the engagers are non-planar. For example, the engagers may have a curved surface, e.g., the engagers may be elliptical, e.g., circular. Lid assembly 1601 includes two handles disposed symmetrically about its central portion 1606. Each of handles 1603a and 1603b are coupled with the lid assembly via couplers 1607a and 1607b, respectively. Handles 1603a and 1603b are configured to allow a user to handle the lid assembly, e.g., by lifting and/or maneuvering it manually. The central portion 1606 is equipped with a central receptacle configured to reversibly engage and disengage with a retaining arm (not shown), with a lock pin (not shown), and/or with a drive spinner (e.g., hex drive spinner). Five skeletal rods, such as skeletal rod 1609, extend from the central portion 1606, each toward a distal opening such as 1608. Each of the distal openings is disposed of in front of an engager. The engager, the distal opening, and the skeletal rod are aligned along the skeletal rod. The five skeletal rods are disposed symmetrically about a C5 axis that is normal to the planar external surface of lid assembly 1601 and in the center of the lid assembly.

FIG. 16 shows an exploded view example of lid assembly 1620 shown with respect to gravitational vector 1690 pointing towards the gravitational center of the ambient environment. The lid assembly comprises receptacle (e.g., knob) 1621 configured for a locking pin (not shown), retaining ring 1622, locking plate (e.g., lid top plate) 1623 (e.g., locking plate), locking ring 1634 having engagers such as 1635, lid sealing ring 1636, a seal (e.g., an O-ring) 1637, and base plate 1638. The socket facilitates engagement with a spinning drive to rotate locking plate 1623 with respect to base plate 1638, e.g., to vary the compressed state of the O-ring. The O-ring can be hollow and/or porous. The O-ring can be compressible. The O-ring may comprise rubber, nitrile, latex, or silicone. The O-ring may comprise a polymer or a resin. The O-ring may comprise an organic or a silicon-based material. The locking plate 1623 of the lid assembly comprises a central hole 1639 receptacle, the receptacle comprising a socket (e.g., hex socket) for the spinning drive, and five symmetrically spaced skeletal rods such as 1640 each skeletal rod extending from central hole 1639 and extending to distal hole such as 1641. The five distal holes are each oblong and equally spaced along the circumference of locking plate 1623. The long axis of the oblong is disposed along the circumference of locking plate 1623. The distal holes are configured to each allow pivot of the locking plate with respect to the base plate, as guided by a guiding post (not shown) disposed of in each distal hole, the guiding post extending from the base plate into the distal hole, the guiding post being disconnected from the locking plate and connected to the base plate. Locking plate 1623 includes two handles such as 1622 that are each collapsible, movable (such as swivelable) and coupled with and exposed surface of the locking plate by a hinge.

FIG. 16 shows a vertical cross section view example 1640 of lid assembly portion shown with respect to gravitational vector 1690 pointing towards the gravitational center of the ambient environment. Lid assembly portion 1640 comprises a seal example that is an O-ring 1641 show in a less compressed (e.g., uncompressed) state. Lid assembly portion 1640 comprises locking ring having engager 1642 (e.g., tab), base plate 1643, locking plate 1644, lock pin 1645 in a less compressed state, and its optional cover 1646 covering an opening of pin receptacle 1647 and lock pin 1645. Cover 1646 may be configured to protect from debris a mechanism secluded by Cover 1646. For example, the mechanism configured to seal the lid assembly with the build module opening, e.g., by compressing the seal. The debris (e.g., as disclosed herein) may comprise gas borne material. The debris may comprise soot, spatter, splatter, or gas borne pre-transformed material. The debris may comprise side products of the 3D printing.

FIG. 16 shows a vertical cross section view example 1660 of lid assembly portion shown with respect to gravitational vector 1690 pointing towards the gravitational center of the ambient environment. Lid assembly portion 1660 comprises a seal example that is an O-ring 1661 show in a more compressed state. Lid assembly portion 1660 comprises locking ring having engager 1662 (e.g., tab), base plate 1663, locking plate 1664, lock pin 1665 in an uncompressed (e.g., released) state, and its optional cover 1666. Covering an opening of pin receptacle 1647 and lock pin 1645. Cover 1666 may be configured to protect from debris (e.g., as disclosed herein) a mechanism secluded by Cover 1666. For example, the mechanism configured to seal the lid assembly with the build module opening, e.g., by compressing the seal. The debris may comprise gas borne material. The debris may comprise soot, spatter, splatter, or gas borne pre-transformed material. The debris may comprise side products of the 3D printing.

In some embodiments, the lid assembly is sealed to the build module. Sealing of the lid assembly to the build module may facilitate isolation and/or control (e.g., maintenance) of the internal environment with respect to the ambient environment external to the closed build module, e.g., with respect to the reactive agent in the external environment. The reactive agent may comprise oxygen, sulfur dioxide, or water. Sealing may comprise forming a gas tight closure. Sealing may comprise forming a hermetic closure. Sealing may or may not comprise using a seal. A gas tight and/or hermetic seal may comprise using a seal, or using planar surfaces forming the seal, e.g., a top surface of the build module that meets a bottom surface of the lid assembly. The planar surface forming the gas tight seal may have a surface roughness of at most about 125 AARH or RMS, 64 AARH or RMS, 30 AARH or RMS, or 10 AARH or RMS, with the Arithmetic Average Roughness Height abbreviated as “AARH,” and Root Mean Square abbreviated as “RMS.” The contact between the lid assembly and the build module body may be tightened using downward pressing and/or rotation (e.g., pivoting) of a portion of the lid assembly with respect to another about a central axis of the lid assembly. For example, rotation of the lid plate with respect to the lid base plate and/or sealing ring, may facilitate such engagement. The lid assembly may be rotated, e.g., manually using a spinning drive. The rotation (e.g., pivoting) of the lid plate with respect to the lid base may take place after the engagers of the lid assembly have been engaged with the engager receptacles disposed in the build module top opening, e.g., in the second portion of the engager receptacles that hinders disengagement of the lid assembly from the build module in a vertical position. In some embodiments, engagement of the engager with the lid assembly receptacles comprises rotating (e.g., pivoting) the lid assembly in a first direction. In some embodiments, tightening the contact between the lid assembly and the build module body comprising rotating the locking plate by rotating (e.g., pivoting) it with respect to the lid base plate and/or sealing ring in the first direction.

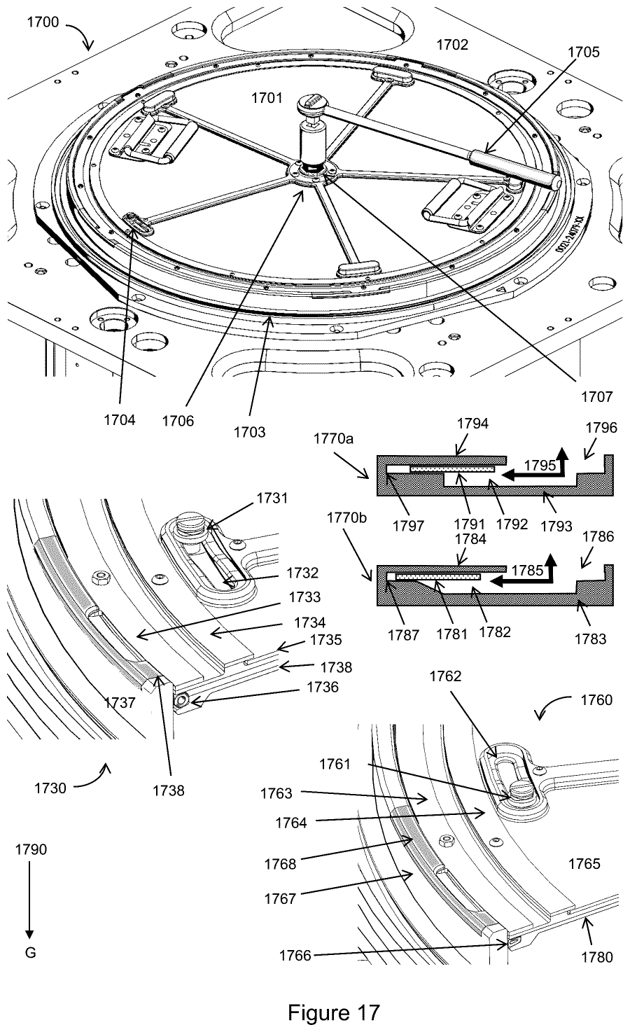

FIG. 17 shows a perspective view example of a portion 1700 of a 3D printing system shown with respect to gravitational vector 1790 pointing towards the gravitational center of the ambient environment external to the 3D printer. Lid assembly 1701 is disposed relative to plate 1702. The plate can be configured to couple to a processing chamber and/or to an unpacking chamber. Plate 1702 and lid assembly 1701 are engaged with a build module 1703, the lid assembly dosing a top opening of build module 1703. Lid assembly 1701 includes five distal openings such as 1704. Each distal openings is engaged with a guiding post. The guiding post can comprise a screw, or a nail. Rotation (e.g., pivoting) of a portion of the lid assembly (e.g., rotation of the locking plate of the lid assembly) with respect to the guiding posts (e.g., and with respect to the build module 1701) alters compression of a seal (e.g., O-ring) disposed at an opposing side of the lid assembly facing downwards, e.g., towards the gravitational center of the environment and the bottom of the build module. Rotation of the lid assembly portion to compress the seal is facilitated in this example at least in part by using a rotating tool such as a drive spinner (e.g., ratchet) 1705 engaging with socket 1707 configured to fit drive spinner 1705, socket 1707 being disposed in central opening portion 1706.

FIG. 17 shows an example of a portion 1730 of a 3D printing system shown with respect to gravitational vector 1790 pointing towards the gravitational center of the ambient environment external to the 3D printer. Portion 1730 includes a lid assembly comprising locking plate 1735, retaining ring 1734, locking ring 1733, base plate 1738, and a seal example that is an O-ring 1736. The lid assembly is shown with respect to build module 1737 having a wall and an upper opening which lid assembly covers. a protrusion is an example for an engager. Build module 1737 includes engager receptable 1738 with which an engager having a form of a protrusion (e.g., tab) in locking ring 1733 engages, to couple the lid assembly with build module 1737. O-ring 1736 is shown in a less compressed (e.g., uncompressed) state. Locking plate 1735 includes distal hole 1732 engaged with guiding post 1731. Locking plate 1735 is configured to rotate with respect to retaining ring 1734, locking ring 1733, base plate 1738, and/or build module 1737. Rotation of locking plate 1735 alters the position of guiding post 1731 with respect to distal hole 1732. The extent of rotation of locking plate 1735 depends at least in part on an extend of movement of guiding post 1731 that is allowed within distal hole 1732. Such movement of the locking plate may be facilitated manually, e.g., using a drive spinner.

FIG. 17 shows an example of a portion 1760 of a 3D printing system shown with respect to gravitational vector 1790 pointing towards the gravitational center of the ambient environment external to the 3D printer. Portion 1760 includes a lid assembly comprising locking plate 1765, retaining ring 1764, locking ring 1763, base plate 1780, and a seal example that is an O-ring 1766. The lid assembly is shown with respect to build module 1767 having a wall and an upper opening which lid assembly covers. Build module 1767 includes engager receptable 1768 with which a protrusion (e.g., tab) of locking ring 1763 engages to couple the lid assembly with build module 1767. O-ring 1766 is shown in a more compressed state. Locking plate 1765 includes distal hole 1762 engaged with guiding post 1761. Locking plate 1765 is configured to rotate with respect to retaining ring 1764, locking ring 1763, base plate 1780, and/or build module 1767. Rotation of locking plate 1765 alters a position of guiding post 1761 with respect to distal hole 1762. The extent of rotation of locking plate 1765 depends at least in part on an extend of movement of guiding post 1761 that is allowed within distal hole 1762. Such movement of the locking plate may be facilitated manually, e.g., using a drive spinner.

FIG. 17 shows examples of vertical cross sections 1770a and 1770b portions comprising engager receptacles engaged with respective engagers, relative to gravitational vector 1790. Example 1770a shows an engager receptacle as part of a build module wall portion 1793, the engager receptacle comprising cavity 1792 having top opening 1796 and ceiling 1794. Cavity 1792 ends at rear portion 1797. Engager 1791 is engaged with portion of cavity 1792 having a low height, e.g., as compared to the cavity portion closer to opening 1796. Engager 1791 is engaged with portion of cavity 1792 having an elevated floor, e.g., as compared to the cavity portion closer to opening 1796. The low (e.g., narrow, and floor-elevated) portion of cavity 1792 forms abruptly in the cavity towards rear portion 1797, e.g., using a step. Engager 1791 can reversibly translate in and out of the cavity along direction 1795. Pushing engager 1791 towards rear portion 1797 facilitates pressing the seal, e.g., O-ring. Example 1770b shows an engager receptacle as part of a build module wall portion 1783, the engager receptacle comprising cavity 1782 having top opening 1786 and ceiling 1784. Cavity 1782 ends at rear portion 1787. Engager 1781 is engaged with portion of cavity 1782 having a low height, e.g., as compared to the cavity portion closer to opening 1786. Engager 1781 is engaged with portion of cavity 1782 having an elevated floor, e.g., as compared to the cavity portion closer to opening 1786. Engager 1781 is engaged with a narrow portion of cavity 1782. The low (e.g., narrow, and floor-elevated) portion of cavity 1782 forms gradually in the cavity towards rear portion 1797, e.g., using a slope. Engager 1781 can reversibly translate in and out of the cavity along direction 1785. Pushing engager 1781 towards rear portion 1787 facilitates pressing the seal, e.g., O-ring. Pressing of the seal can be brought about at least in part by pivoting the engager into the rear (e.g., distal) portion of the engager receptacle's cavity, e.g., gradually, or abruptly—depending at least in part on a shape of the internal portion of the cavity.

In some embodiments, a mechanical arm (e.g., mount arm, or retaining arm) may be configured to translate in and out of the casing. The mechanical arm may be configured to: (i) (e.g., reversibly) affix the lid assembly to the mechanical arm, (ii) (e.g., reversibly) release the lid assembly from the mechanical arm, (iii) (e.g., reversibly) translate the lid assembly from a (e.g., substantially) vertical position to a (e.g., substantially) horizontal position, (iv) (e.g., reversibly) translate the lid assembly from a more enclosure position in the lid assembly, to an exposed position from the lid assembly, (v) pivot while in a (e.g., substantially) vertical position, or (iv) any combination thereof.

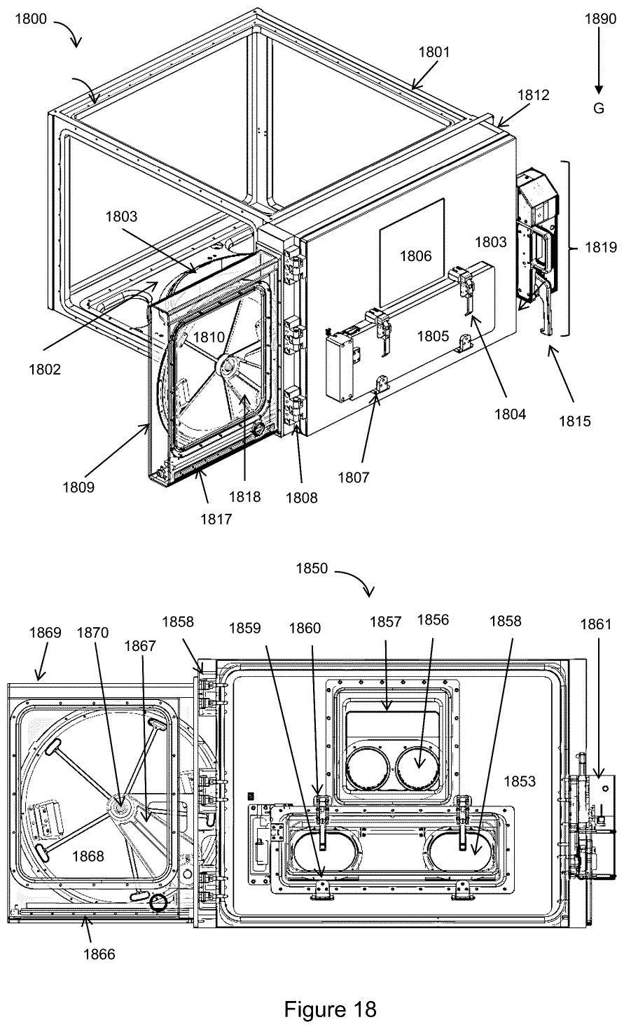

FIG. 18 shows a perspective view example of a portion 1800 of a 3D printing system shown with respect to gravitational vector 1890 pointing towards the gravitational center of the ambient environment external to the 3D printer. The 3D printer portion example 1800 includes framing 1801 of a processing chamber that is devoid of walls for illustrative purposes. Plate 1802 engages with the processing chamber from its bottom face, the plate having a central opening 1803. The central opening can be configured to accommodate a platform supporting a 3D object during its printing. When the 3D object is generated from a material bed, the platform is able to support the material bed. During the printing, the platforms recedes sequentially (e.g., layerwise) downwards into the build module (build module and platform not shown) and away from the processing chamber. Processing chamber framing 1801 is coupled with structural extension 1812 configured to couple to casing 1809 extending to a side of structural extension 1812 and adjacent to primary door 1803 that is coupled with processing chamber framing 1801 through structural extension 1812. Primary door 1803 is coupled with structural extension 1812 at least in part using hinges such as 1808. Primary door 1803 comprises viewing window area 1806 that can accommodate one or more viewing windows, and secondary door 1805. Primary door 1803 can swivel about the hinges to reversibly close and open, e.g., by using a handle mechanism 1819 including handle 1815. Secondary door 1805 is coupled with primary door 1803 at least in part using hinges such as 1807. Secondary door 1805 can swivel about an axis of the hinges to reversibly open and close. Secondary door 1805 is secured (e.g., kept closed) using handles such as 1804 that can be reversibly opened and closed. The secondary door can reversibly open and close about a first axis, and the primary door can reversibly open and close about a second axis. In example 1800, the first axis is (e.g., substantially) perpendicular to the second axis. Casing 1809 accommodates lid assembly 1810 attached to mechanical arm 1818 shown pointing towards the interior of casing 1809, and railing assembly 1817 shown in a contracted configuration.

FIG. 18 shows a front view example of a portion 1850 of a 3D printing system shown with respect to gravitational vector 1890 pointing towards the gravitational center of the ambient environment external to the 3D printer. Primary door 1853 is coupled with a processing chamber framing (e.g., through a structural extension) using hinges such as 1858. Primary door 1853 comprises viewing windows such as 1856 disposed in a viewing area 1857, and protected openings such as 1858 through which a user can access the interior of the processing chamber while being separated from the ambient environment, e.g., using a glove box type arrangement. The protected opening can include a flexible material that allows manipulation of items in the processing chamber while environmentally separating the internal environment of the processing chamber from the ambient environment. The flexible material may comprise a polymer or a resin, e.g., any polymer or resin disclosed herein that is suitable. For example, the flexible material may comprise rubber. The protected openings may be reversibly covered by a secondary door, not shown. The secondary door can be secured to the primary door using hinges such as 1859, and handles such as 1860, which can be opened or closed, e.g., manually. The primary door can be reversibly opened and closed using the handle mechanism 1861 coupled with the primary door. The handle mechanism can latch to the processing chamber, e.g., to its structural extension. Casing 1869 accommodates lid assembly 1868 attached to mechanical arm 1867 shown in a configuration pointing into the interior of the casing and away from an opening of the casing through which lid assembly 1868 partially emerges. Casing 1860 accommodates railing assembly 1866 shown in a contracted configuration. Lid assembly 1868 is reversibly secured to mechanical arm 1867 using lock pin 1870.

In some embodiments, the build module may be operatively coupled with a plate. For example, the top opening of the build module may be coupled with the plate. The plate may comprise a central opening such as a hole. The central opening may be configured to accommodate the build module. The plate may comprise one or more additional openings. A set of the additional openings may be symmetrically related, e.g., using a rotational axis normal to the plate, using an inventions center, or using one or more mirror planes. A set of the additional openings may not be symmetrically related. For example, the plate may comprise a first set having symmetrically related openings, and a second set having non-symmetrically related openings. The one or more additional openings may be configured to accommodate (e.g., and engage with) plate associated components comprising sensor(s), valve(s), or channel(s). The plate may be configured to engage with a vehicle, e.g., to facilitate transit of the build module, e.g., a transit vehicle as disclosed herein. In an example, the plate is configured to engage with a forklift. One or more of the additional openings may be configured to reduce a weight of the plate, while (e.g., substantially) maintaining its strength such as during transit of the build module.

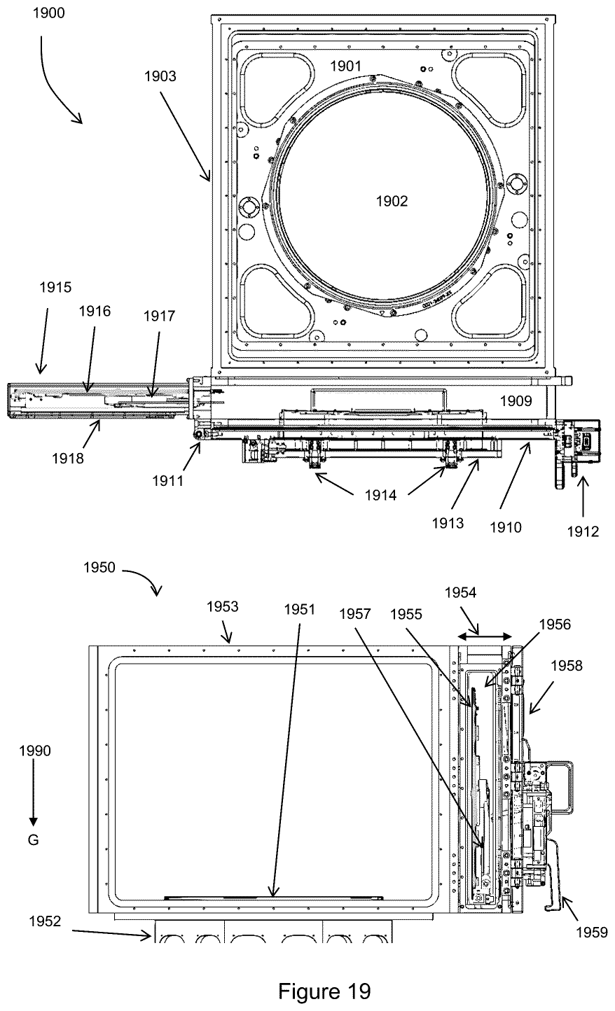

FIG. 19 shows an example of a portion 1900 of a 3D printing system shown at a horizontal view top down towards the gravitational center of the environment. Portion 1900 comprises plate 1901 having central opening 1902. Plate 1901 coupled with processing chamber frame 1903. Processing chamber frame 1903 is coupled on one side to structural extension 1904, that is coupled with primary door 1910. Primary door 1910 can reversibly swivel about hinge axis 1911 disposed vertically, e.g., at least in part by using handle mechanism 1912 such as by manual use. Primary door 1910 is coupled with secondary door 1913 that can swivel to reversibly open and closer about a horizontal hinge axis. The secondary door can be secured or released relative to the primary door 1910, using handles 1914. Structural extension 1909 is coupled with casing 1915 that accommodates lid assembly 1909, mechanical arm 1917, and railing assembly 1918 shown in a retracted configuration.

FIG. 19 shows a side view (e.g., vertical) example of a portion 1950 of a 3D printing system shown with respect to gravitational vector 1990 pointing towards the gravitational center of the ambient environment external to the 3D printer. Portion 1950 comprises processing chamber frame 1953 that is coupled with build module portion 1952 having opening 1951. Build module framing 1953 is coupled with structural extension having width 1954, that is coupled with a casing having (e.g., substantially) the same width. Lid assembly 1955 is disposed in an internal space 1956 of the casing. Lid assembly 1955 is engaged with mechanical arm 1957. Primary door 1958 is coupled with processing chamber framing 1953 indirectly, by being directly coupled with structural extension 1954 that is directly coupled with the processing chamber framing 1953. In other embodiments, the primary door may be directly coupled with the framing of the processing chamber. Primary door 1958 can be reversibly opened and closed at least in part using a handle assembly having handle 1959.

FIG. 20 shows an example of a portion 2000 of a casing and associated components shown with respect to gravitational vector 2090 pointing towards the gravitational center of the ambient environment external to the casing. Portion 2000 shows casing 2001 having an opening through which lid assembly 2002 partially emerges. Lid assembly 2002 comprises a locking ring having protrusions such as 2003. Lid assembly 2002 is coupled with mechanical arm 2004 shown in a configuration pointing in a direction into casing 2001 and away from an opening of the casing through which lid assembly 2002 partially emerges. Mechanical arm 2005 comprises supportive skeletal portion 2009. Mechanical arm 2004 includes stopper portion 2005. Lid assembly 2002 engages with railing assembly 2005 shown in a contracted configuration. Railing assembly 2007 is coupled with torque hinge 2006. Lid assembly 2002 is shown in portion 2000 is stored in casing 2001, e.g., in a storage position. Mechanical arm 2004 is coupled with lid assembly 2002 using lock pin 2010. The lock pin may be situated in a first position that allows coupling of the lid assembly to the mechanical arm, and a second position that allows release of the lid assembly from the mechanical arm. Switching between the first position and the second position of the lock pin relative to the mechanical arm can be done manually and/or automatically.

FIG. 20 shows an example of a portion 2020 of a casing and associated components shown with respect to gravitational vector 2090 pointing towards the gravitational center of the ambient environment external to the casing. Portion 2020 shows casing 2021 having an opening through which lid assembly 2022 almost fully emerges. Lid assembly 2022 is coupled with mechanical arm 2024 shown in a configuration pointing in a direction into casing 2021 and opposite to direction 2031. Lid assembly 2022 is coupled with mechanical arm 2024 at least in part by lock pin 2030 extending from mechanical arm 2024 and into lid assembly 2022. Mechanical arm 2024 includes stopper portion 2025. Lid assembly 2022 engages with railing assembly comprising fixed rail 2027 and sliding bar 2028, the railing assembly shown in an extended configuration. Sliding bar 2028 is coupled with torque hinge 2026. Circular bearing 2029 (e.g., flange bearing such as bold flange bearing) can be configured to facilitate rotation (e.g., pivoting) of the lid assembly about a first axis going through the bearing. Torque hinge 2029 can be configured to facilitate swiveling of the lid assembly about a second axis. The first axis can be (e.g., substantially) perpendicular to the second axis. Lid assembly 2022 is shown in portion 2020 as partially pulled out from casing 2021 along direction 2031 at least in part by using a gas pressure exerted thorough rod-less gas cylinder 2032, e.g., during its use.

FIG. 20 shows an example of a portion 2040 of a casing and associated components shown with respect to gravitational vector 2090 pointing towards the gravitational center of the ambient environment external to the casing. Portion 2040 shows casing 2041 having an opening through which lid assembly 2042 fully emerges. Lid assembly 2042 is coupled with mechanical arm 2024 shown in a configuration pointing in a direction away from an interior of casing 2041, e.g., along in a direction similar to 2031. Lid assembly 2042 is coupled with mechanical arm 2044 at least in part by lock pin 2050 extending from mechanical arm 2044 and into lid assembly 2042. Mechanical arm 2044 includes stopper portion 2045. Lid assembly 2042 engages with railing assembly comprising fixed rail 2047 and sliding bar 2048, the railing assembly shown in an extended configuration. The railing assembly may comprise ball bearings, e.g., disposed between the sliding bar and the fixed rail. Sliding bar 2048 is coupled with torque hinge 2046. Circular bearing 2049 (e.g., flange bearing such as bold flange bearing) facilitates the partial rotation 2051 (e.g., pivoting) of the lid assembly about a first axis going through circular bearing 2049. Coupling of circular bearing 2049 to torque hinge 2046 can be configured to facilitate swiveling of the lid assembly about a second axis parallel to sliding bar 2048, e.g., to translate lid assembly 2042 and mechanical arm 2044 to a (e.g., more) horizontal position (not shown in example portion 2040). The partial rotation (e.g., pivoting) along direction 2051 can be performed at least in part manually, e.g., by a user. For example, a user may hold handles such as 2052 to pivot along 2051 lid assembly 2042 about the first axis going through circular bearing 2049. Lid assembly 2042 can rotate about the central axis of circular bearing 2042 (e.g., the first axis) along rotational direction 2051, until stopper portion 2045 contacts a floor, e.g., floor of the processing chamber (including floor of the structural extension). The first axis can be (e.g., substantially) perpendicular to the second axis. Lid assembly 2042 is shown in portion 2040 as pulled out from casing 2041. Casing 2041 comprises a side 2055 facing a user. The side 2055 can comprise an opaque or a transparent material. The casing (e.g., and side) can be configured to maintain an atmosphere different than the ambient atmosphere external to the casing. The casing (e.g., and side) can be configured to couple to the processing chamber (including to its structural extension). The casing be configured to maintain an atmosphere different than the ambient atmosphere external to the casing. Lid assembly 2042 comprises protrusions such as 2057 disposed in a locking ring, distal openings such as 2058, and skeletal rods such as 2059. Casing 2041 comprises fasteners such as 2056 to facilitate its coupling, e.g., to a chamber (including to any structural extension of the chamber). The chamber can be a processing chamber and/or an unpacking chamber.

FIG. 20 shows an example of a portion 2060 of a casing and associated components shown with respect to gravitational vector 2090 pointing towards the gravitational center of the ambient environment external to the casing. Portion 2060 shows casing 2061 having an opening 2080 through which lid assembly 2062 fully emerged. Lid assembly 2062 is coupled with mechanical arm 2064 shown pointing in a direction away from an interior of casing 2061. Lid assembly 2042 is coupled with mechanical arm 2044 at least in part by lock pin 2070 extending from an exposed surface of mechanical arm 2064 and into lid assembly 2062. Mechanical arm 2064 includes stopper portion. Lid assembly 2062 engages with railing assembly comprising fixed rail 2067 and sliding bar 2068, the railing assembly shown in an extended configuration. The railing assembly may comprise ball bearings, e.g., disposed between the sliding bar and the fixed rail. Sliding bar 2068 is coupled with torque hinge 2066. Circular bearing (e.g., flange bearing such as bold flange bearing) 2069 facilitated a first partial rotation (e.g., pivoting) of the lid assembly about a first axis going through the bearing as shown in example portion 2040, e.g., along rotational direction 2051. Torque hinge 2049 facilitates swiveling of lid assembly 2062 about a second axis and along rotational direction 2071, per rotational extent of torque hinge 2066 along that direction. The (partial) rotation along the second axis can be done manually, e.g., by a user.

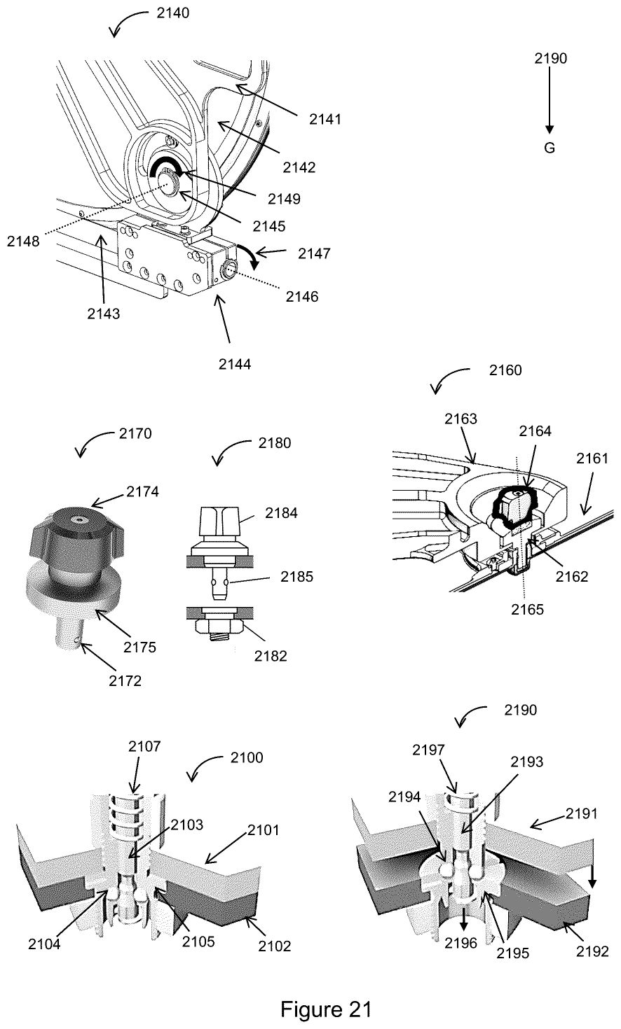

FIG. 21 shows an example of portion 2140 of a lid assembly maneuvering system shown with respect to gravitational vector 2190 pointing towards the gravitational center of the ambient environment. Portion 2140 comprises a portion of a mechanical arm 2141 coupled with a portion of lid assembly 2142. Mechanical arm 2142 is coupled with railing system comprising sliding bar 2143 of a railing system by torque hinge 2144 having hinge leaves, one of which is stationary and the other can swivel about axis 2146 in the direction 2147. Torque hinge 2144 is coupled with Circular bearing (e.g., flange bearing such as bold flange bearing) 2145 that can rotate (e.g., pivot) about axis 2148. Circular bearing 2145 is coupled with mechanical arm 2141 and facilitate rotation (e.g., pivoting) of mechanical arm 2141 about axis 2148 along rotational direction 2149.

In some embodiments, the maneuvering mechanism of the lid assembly comprises a lock pin. The lock pin can be a ball lock pin. The ball lock pin (e.g., quick release pin or self-locking pin) can be a fastener used to quickly lock or fasten the mechanical arm with the lid assembly together. The pin can be pushed through a clearance fit hole, and a sprung-loaded balls can subsequently be pushed out of the pin into a recess, which effectively cause locking of the pin in place. To remove the pin from its place, the sprung-loaded balls may be retracted back into the body of the pin. This can be done by depressing the push-button on the head of the ball lock pin whilst the pin is pulled out of the clearance hole. The ball lock pin may provide convenient, quick, and positive fastening. The ball lock pin may provide locating and/or alignment of the mechanical arm and the lid assembly relative to each other.

FIG. 21 shows an example of a portion 2160 of lid assembly coupled with a mechanical arm. Portion 2160 shows a portion 2161 of lid assembly coupled by lock pin 2164 to mechanical arm portion 2163, the lock pin 2164 that can rotate (e.g., pivot) about a long axis of the lock pin, which top portion is also compressible to toggle between configurations of the lock pin. Lock pin 2164 is engaged with its receptacle 2162. FIG. 21 shows an example of an assembled lock pin assembly including lock pin 2174 having balls 2172, and lock pin receptable 2175. FIG. 21 shows an example of a disassembled ball lock in assembly including lock pin 2184 having balls 2185, and lock pin receptable 2182 (e.g., knob).

FIG. 21 shows an example 2190 a portion of a lock pin assembly coupled with a first plank 2191 and to a second plank 2192 having a gap therebetween, the lock pin assembly comprising pin 2193, balls such as 2194, receptacle 2195, and spring 2197. To bring the first plank and the second plank closer together, the lock pin assembly can be pressed in direction 2196 to lock the surfaces in a closer position depicted in example 2100.

Example 2100 shows a portion of a lock pin assembly coupled with a first plank 2101 and to a second plank 2102 contacting each other, the lock pin assembly comprising pin 2103, balls such as 2104, receptacle 2105, and spring 2107. To separate the first plank and the second plank, the lock pin assembly can be again pressed down to facilitate retraction of the balls and release of the lock pin from its receptable.

In some embodiments, the casing has a body having a narrow opening and a wide opening. The narrow opening may be disposed on a first side of the casing, and the wide opening may be disposed on a second side of the casing. The second side of the casing may contact the first side of the casing. The second side may be disposed (e.g., substantially) normal to the first side. The wide opening may be closeable with a closure, e.g., using fastener(s). For example, the closure can be a window that facilitates viewing an interior of the casing, e.g., during idle time and/or during operation. The window may be a viewing window. The closure may be transparent, e.g., to an average user. The closure may be opaque. The closure can be made from a material that is (e.g., substantially) the same as the material from which the body is made. For example, the body of the casing may be made of metal (e.g., any metal disclosed herein), and the closure may be made of (e.g., substantially) the same metal. The closure can be made from a material that is different from the material from which the body is made. For example, the body of the casing may be made of a first metal (e.g., any metal disclosed herein), and the closure may be made of a second metal. The closure can be made from a material that is of the same type as the material from which the body is made. For example, the body of the casing may be made of the metal alloy Inconel, and the closure may be made of the metal alloy stainless steel. The closure can be made from a material that is of a different type than the material from which the body is made. For example, the body may be made of the elemental alloy aluminum, and the closure may comprise a polymer. The first opening may be devoid of a closure.

FIG. 22 shows an example of various views of a casing and related components shown with respect to gravitational vector 2290 pointing towards the gravitational center of the ambient environment external to the 3D printer.

Portion 2200 shows a perspective view example of a casing having body 2201. The body has a narrow opening 2202 on a first side, and a wide opening 2213 on a second side, the wide opening being closeable by a closure 2203, e.g., a cover. Closure 2203 may face an ambient environment. The narrow opening 2202 is devoid of a closure. Body 2201 of the casing is configured for attachment, e.g., using fasteners (e.g., screws) such as 2204, and aligners (e.g., pins) such as 2205. Attachment of the casing may be to a framing of a chamber. The chamber may comprise a processing chamber or an unpacking chamber. The casing is configured to accommodate a railing system comprising sliding bar 2206. The railing system is configured to operatively (e.g., physically) coupe to mechanical arm 2207 having a stopper portion 2208, e.g., a stopper leg. Mechanical arm 2207 is operatively coupled with the railing system via torque hinge 2209 through circular bearing 2210. The railing system in this example is manually movable, e.g., using handle 2211. The user may be disposed in an ambient environment external to a processing chamber to which the casing may be attached to. Casing body 2201 comprises seal 2212 (e.g., a continuous tube). The seal may comprise a tube, or a cushion. The seal may facilitate sealing and/or controlling (e.g., maintaining) an internal environment in the processing chamber that is different from the ambient environment, e.g., during user of the processing chamber. In the example of 2200, mechanical arm 2207 is extended out of casing body 2201. Mechanical arm 2207 includes pin receptacle 2215. The pin coupler can be configured to reversibly couple and decouple from a lid assembly (not shown). Pin receptacle (e.g., knob) 2215 with pin is directed towards a distal side of the casing facing narrow opening 2202.

Portion 2230 shows a perspective view example of a casing having body 2231a. A back portion of casing body 2231a is cut for illustrative purposes, as indicated in 2231b. Casing body 2231a has a narrow opening 2232 on a first side, and a wide opening on a second side, the wide opening being closed by closure 2233. Closure 2233 (e.g., cover) may face an ambient environment. The narrow opening 2232 is devoid of a closure. Body 2231a of the casing is configured for attachment, e.g., using fasteners (e.g., screws) such as 2234, and aligners (e.g., pins) such as 2235. Attachment of the casing may be to a framing of a chamber. The chamber may comprise a processing chamber or an unpacking chamber. The casing is configured to accommodate a railing system 2236. The railing system is configured to operatively (e.g., physically) coupe to mechanical arm 2237 having a stopper portion 2238, e.g., a stopper leg. Mechanical arm 2237 is operatively coupled with the railing system via torque hinge 2239 through circular bearing 2240. Casing body 2231a comprises seal 2242 (e.g., a continuous tube). The seal may comprise a tube, or a cushion. The seal may facilitate sealing and/or controlling (e.g., maintaining) an internal environment in the processing chamber that is different from the ambient environment, e.g., during user of the processing chamber. In the example of 2230, mechanical arm 2237 is disposed in casing body 2231a at its innermost position of the railing system (e.g., most compressed), in which a section of leg portion 2238 of mechanical arm 2237 extends out of opening 2232. Mechanical arm 2237 includes a pin receptacle (e.g., knob) 2243 engaged with a lock pin e.g., ball lock pin. The pin receptacle can be configured to reversibly couple and decouple from a lid assembly (not shown). Pin receptacle 2243 is directed towards a distal side of the casing facing narrow opening 2232. Railing system 2236 is connected to bumpers such as 2244, connected to a distal side of the casing that faces narrow opening 2232.

In some embodiments, the casing may comprise a railing system. The railing system may be operated manually and/or automatically. The railing system may comprise a gear and a belt having respective teeth engageable with the gear. The gear may be rotated manually and/or automatically (e.g., using at least one controller). The at least one controller can be any controller disclosed herein, e.g., the control system of the 3D printer and/or the control system of the unpacking station. The railing system may comprise a rotatable handle, e.g., configured to manually rotate the gear. The gear may be manually rotated by a user disposed in an ambient environment. The railing system may comprise tracks. The railing system may comprise a sliding bar. The sliding bar may be movable using the gear (e.g., and the belt). The sliding bar may slide along the tracks. The tracks may be affixed to a side of a casing, e.g., using a retaining plate and fixture(s), e.g., screws. The railing system may comprise a belt clamp.

Portion 2260 shows an exploded view example of a casing having body 2261a. A back portion of casing body 2261a is cut for illustrative purposes, as indicated in 2261b. Casing body 2261a has a narrow opening 2262 on a first side, and a wide opening 2273 on a second side, the wide opening being closed by closure 2263, e.g., a cover. Closure 2263 may face an ambient environment. Closure 2263 is configured to close wide opening 2273 using fasteners such as 2281. Seal 2282 is disposed between closure 2263 and a rim of opening 2273, e.g., to seal an internal environment of the casing and any enclosure coupled thereto through the narrow opening 2262. The enclosure can be a processing chamber or an unpacking chamber. The narrow opening 2262 is devoid of a closure. Body 2261a of the casing is configured for attachment, e.g., using fasteners (e.g., screws) such as 2264, and aligners (e.g., pins) such as 2265. Attachment of the casing may be to a framing of a chamber. The chamber may comprise a processing chamber or an unpacking chamber. The casing is configured to accommodate railing system 2266. Railing system 2266 is configured to operatively (e.g., physically) coupe to mechanical arm 2267 having a stopper portion 2268, e.g., a stopper leg. Mechanical arm 2267 is operatively coupled with the railing system via torque hinge comprising first hinge leaf 2269a and second hinge leaf 2269b through circular bearing 2270. Casing body 2261a comprises seal 2272 (e.g., a continuous tube). The seal may comprise a tube, or a cushion. The seal may facilitate sealing and/or controlling (e.g., maintaining) an internal environment in the processing chamber that is different from the ambient environment, e.g., during user of the processing chamber. In the example of 2260, mechanical arm 2267 is disposed in casing body 2231a at its innermost position of the railing system, e.g., most compressed. Mechanical arm 2237 includes a pin receptacle (e.g., knob) 2273 engaged with a lock pin 2274 e.g., ball lock pin. Pin receptacle 2273 can be configured to reversibly couple and decouple from a lid assembly (not shown). Pin receptacle 2273 is directed towards a distal side of the casing facing narrow opening 2262. Railing system 2266 can be connected to bumpers such as 2275, which can be connected to a distal side of the casing that faces narrow opening 2262. Railing system 2266 comprises railing 2285, belt 2286, and belt tensioner 2287 (e.g., comprising a gear). Handle 2288 (e.g., coupled with a gear) may couple to belt 2286, and be configured to rotate belt 2286 that can couple to a sliding bar (now shown) and cause it to translate relative to the casing opening 2262 and relative to tracks 2285a and 2285b, e.g., by rotation of handle 2288. Railing system 2266 comprises retaining plate 2291. The retaining plate may be configured to retain the track and associated components affixed to a side of the casing, e.g., the second side of casing body 2261a having wide opening 2273. When raining assembly 2266 is assembled, tracks 2285a and 2285b face each other. Optional opening 2289 (e.g., port) may or may not be part of the casing assembly. Opening 2289 may be used to inspect functionality of the casing and/or its components, as applicable.

In some embodiments, the sliding bar may slide on the tracks. In some embodiments, the sliding bar may slide directly on the tracks by contacting the track. In some embodiments, the sliding bar may slide (indirectly) on the track by sliding on balls disposed between the track and the sliding bar. In some embodiments, the sliding bar may be operatively coupled with a bearing wheel that slides on the tracks, the wheel bearing contacting the track. A vertical cross section of the track contacting the sliding component may comprise a vee “V” shape, or a pointing arrow shape. A vertical cross section of the component (e.g., sliding bar, or the wheel), contacting the track may have a (e.g., substantially) complimentary vee (“V”) cross section. For example, the wheel may be a vee wheel (e.g., a circular vee bearing). The vee cross sectional component may have a minimal contact with the track during preparation of the vee cross sectional component along the track. For example, the vee track may have planar sides, while the vee wheel surface contacting the planar sides of the track, may comprise a curvature.

In some embodiments, the railing system is configured to push away debris during the propagation of the mechanical arm (e.g., and of the slide bar) along the track, e.g., such that if there is any debris accumulated on the track(s), it will be pushed away during translation. For example, the track may have a pointed cross section (e.g., substantially) complementary to the cross section of a component contacting the track, to facilitate removal (e.g., pushing away) of the debris that is caused by propagation of the component along the railing. For example, the component may have a groove (e.g., substantially a V shaped groove) that (e.g., substantially) complements a cross section of the track. The component may comprise a bearing (e.g., the wheel may be a wheel bearing). The wheel may be a dual vee wheel. The wheel may have a dovetail cross section. The wheel may include a polymer and a metal (e.g., elemental metal and/or metal alloy). The track may comprise a vee guide track. In some embodiments, the dual vee guide wheel are designed with a contact surface of 90 degrees. The wheel cross section may comprise an internal vee or an external vee (e.g., both an external vee and an internal vee).

FIG. 22 shows a vertical cross-sectional example of a track tip 2294 engaged with two external surface portions of a component having a vertical cross section in the shape of a V having curved surfaces that contact the track, which external surface portions are 2292a and 2292b. Dotted arrows 2293a and 2293b denote optional debris and/or powder being pushed from the cavity between the track 2294 and the surface portions 2292a and 2292b of the component.

In some embodiments, the lid assembly is maneuvered from the casing to close the build module. The maneuver may be fully manual, partially manual, and partially automatic, or fully automatic. In some embodiments, the maneuver is fully manual, or fully automatic such as using one or more controllers. The one or more controllers can be any controller disclosed herein. The maneuver can be accomplished without disrupting the internal environment of the enclosure. The maneuver can be accomplished without exposing the internal environment of the enclosure to an ambient environment external to the enclosure. The maneuver may be done using a lid assembly that is disposed in the enclosure. The enclosure may comprise (i) a chamber (ii) a build module, or (iii) the build module and the chamber. The chamber may comprise a processing chamber or an unpacking chamber. The maneuver can be accomplished without exposing the starting material, the remainder material, and/or the 3D object, to the ambient environment. The maneuver may comprise (a) translating the lid assembly into the chamber along a long axis of a railing mechanism and out of the casing until the lid assembly is out of the casing, the lid assembly being disposed (e.g., substantially) in a first position in space, the lid assembly being coupled with the railing mechanism at least in part by a mechanical arm having stopper operation that is suspended during this translation out of the casing; (b) partially rotating (e.g., pivoting) the lid assembly to relocate the stopper portion of the mechanical arm from its suspended position to a floor position contacting the floor of the chamber, the pivoting of the mechanical arm being along a first axis; (c) maneuvering the lid assembly onto an interior space by partially rotating (e.g., pivoting) the mechanical arm along a second axis to a second position in space; (d) decoupling the mechanical arm and the lid assembly; (e) using the lid assembly in the chamber to close an opening of the build module, or (f) any combination of (a)-(e). The first position in space can be different from the second position in space by at least one axial position, e.g., of a Cartesian axial system. The first position in space can be different from the second position in space by at least two axial positions, e.g., of a Cartesian axial system. For example, the first position in space can be a (e.g., substantially) vertical position. For example, the second position in space can be different from a (e.g., substantially) vertical position. For example, the second position in space can be a (e.g., substantially) horizontal position. In some embodiments, the first position in space and the second position in space are in an interior space of the chamber. The first axis can be different from the second axis. For example, the first axis can be (e.g., substantially) perpendicular to the second axis. Decoupling the mechanical arm from and the lid assembly can be at least in part by using a lock pin. The decoupled mechanical arm can be at least partially stored in (e.g., tucked away into) the casing. For example, the decoupled mechanical arm can be pivoted in reverse direction along the second axis to lift the mechanical arm to the first position in space. For example, the decoupled mechanical arm can be pivoted in a reverse direction along the first axis to lift the stopper portion from contacting the floor to a suspended position. For example, the mechanical arm can traverse along the long axis of the railing system towards an interior of the casing, e.g., for storage. The mechanical arm, when stored, can be partially, or completely, encased in the casing. Maneuvering of the lid assembly and/or of the mechanical arm can be done by a user disposed externally to the processing chamber, e.g., at least in part by using a flexible membrane configured to separate the internal environment of the processing chamber and the ambient environment in which the user is disposed. Such membrane can be comprised in at least one glove of a glove box type arrangement. Such membrane may be configured to be sufficiently flexible to allow the user to maneuver components in the processing chamber to facilitate maneuver of the lid assembly and/or of the mechanical arm.

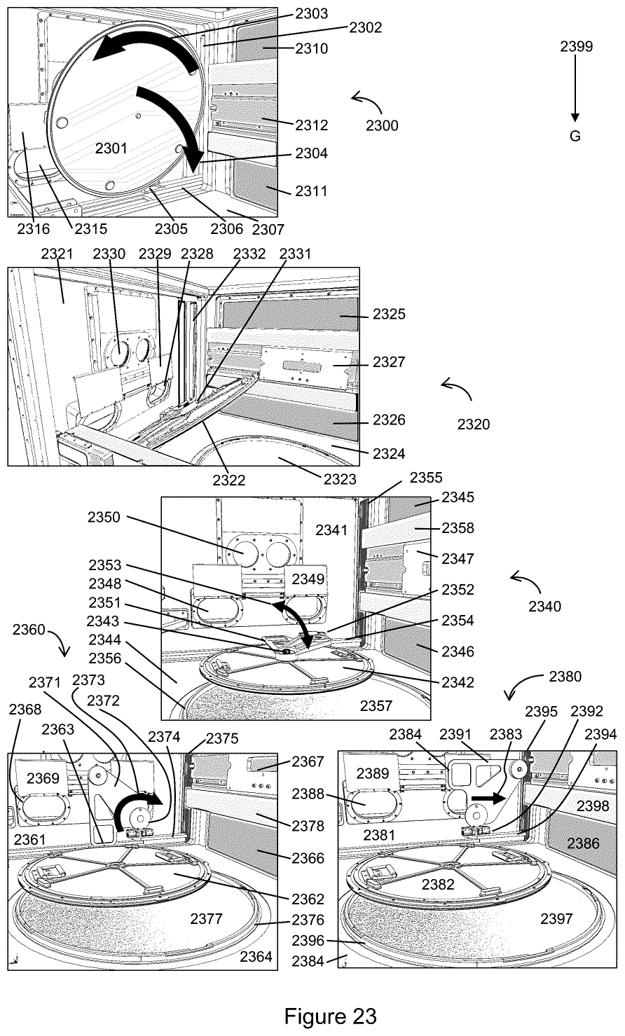

FIG. 23 shows an example of various portions of a 3D printing system shown with respect to gravitational vector 2399 pointing towards the gravitational center of the ambient environment external to the 3D printer. Portions 2300, 2320, 2340, 2360, and 2380 each show the processing chamber interior, in a direction that generally faces a primary door of the processing chamber. FIG. 23 shows various operations associated with closing the lid and storing the decoupled mechanical arm in the casing.

Portion 2300 of FIG. 23 shows lid assembly 2301 disposed in an interior space of a processing chamber, and not in a casing having opening 2302. Lid assembly 2301 can be maneuvered from its substantial vertical position to a more horizontal position towards floor 2307 of the processing chamber, e.g., by being (i) partially rotated (e.g., pivoted) along rotational (e.g., sectional) direction 2303, and (ii) partially rotated (e.g., pivoted) along rotational (e.g., sectional) direction 2303. Lid assembly 2301 is coupled with torque hinge 2305 that is coupled with sliding bar 2306 of a railing assembly that extends into the casing and through casing opening 2302. The processing chamber is equipped with an upper gas ingress port 2310 and a lower gas ingress port 2311. Gas (e.g., through a gas conveyance system) can enter into the processing chamber to maintain an atmosphere in the processing chamber, e.g., that is different from the ambient atmosphere external to the processing chamber by at least one atmospheric characteristic. The processing chamber comprises a side railing system 2312. A layer dispensing mechanism (not shown) can be reversibly translated at least in part by using the side railing system. The side railing system is disposed on a side wall of the processing chamber. An interior space of the processing chamber can be accessed (e.g., by a user) through access ports such as 2015. The access port(s) can be equipped with a flexible material (e.g., rubber) that allows a user disposed in an ambient environment to manipulate component(s) in the internal space of the processing chamber while maintaining separation of the user from an internal environment of the processing chamber, e.g., using a glove box type arrangement. The access ports can each be closed using a cover (e.g., flap) such as cover 2316.

Portion 2320 shows an example of primary door 2321 shown from an interior of a processing chamber. In the example of portion 2320, lid assembly 2322 is disposed as inclined with respect to primary door 2321 and processing chamber floor 2324. For example, lid assembly 2322 may be on its way to close opening 2323 in floor 2324 of the processing chamber. The processing chamber is equipped with an upper gas ingress port 2325 and a lower gas ingress port 2326. The processing chamber comprises a side railing system. A layer dispensing mechanism (not shown) can be reversibly translated at least in part by using the side railing system, e.g., by using (e.g., also) carriage 2327. The side railing system is disposed on a side wall of the processing chamber. An interior space of the processing chamber can be accessed (e.g., by a user) through access ports such as 2328. The access port can be equipped with a flexible material (e.g., rubber) that allows a user disposed in an ambient environment (outside the processing chamber) to manipulate component(s) in the internal space of the processing chamber, while maintaining separation of the user from an internal environment of the processing chamber, e.g., using a glove box type arrangement. The access ports can each be closed using a cover (e.g., flap) such as cover 2329. Primary door 2321 is equipped with windows such as 2330 through which the user standing outside of the processing chamber, can view the processing chamber interior. Lid assembly 2322 is coupled with mechanical arm 2331. The mechanical arm can (in part) facilitate ingress and egress of lid assembly 2322 relative to a casting having opening 2332. For example, the lid assembly can be stored in the casing and taken out of the casing through opening 2332. For example, the lid assembly can be placed into the casing through opening 2332, e.g., for storage.

Portion 2340 shows an example of primary door 2341 shown from an interior of a processing chamber. In the example of portion 2340, lid assembly 2342 is disposed horizontally in a processing chamber having floor 2344. The processing chamber is equipped with an upper gas ingress port 2345 and a lower gas ingress port 2346. The processing chamber comprises a side railing system. A layer dispensing mechanism (not shown) can be reversibly translated at least in party by using the side railing system, e.g., by being coupled with carriage 2347 disposed on a side railing system having covers such as cover 2358. The side railing system can couple (e.g., using carriage 2347) to a layer dispensing machines (not show) to dispense material bed 2357. The side railing system is disposed on a side wall of the processing chamber. An interior space of the processing chamber can be accessed (e.g., by a user) through access ports such as 2348. The access port can be equipped with a flexible material (e.g., rubber) that allows a user disposed in an ambient environment (outside the processing chamber) to manipulate component(s) in the internal space of the processing chamber, while maintaining separation of the user from an internal environment of the processing chamber, e.g., using a glove box type arrangement. The access ports can each be closed using a cover (e.g., flap) such as cover 2349. Primary door 2341 is equipped with windows such as 2350 through which the user standing outside of the processing chamber, can view the processing chamber interior. Lid assembly 2342 is coupled with mechanical arm 2351. Mechanical arm 2351 is coupled with lid assembly 2342 at least in part by lock pin 2343. The mechanical arm can at least in part (e.g., by being coupled with torque hinge 2352) facilitate maneuvering lid assembly 2342 from a (e.g., substantially) horizontal position to a (e.g., substantially) vertical position, or any other position therebetween and along curved arrow 2353 indicating partially rotation (e.g., pivot) of mechanical arm 2352 with lid assembly 2342 towards floor 2344 of the processing chamber. Torque hinge 2352 is coupled with sliding bar 2354 of a railing assembly that extends into a casing and through casing opening 2355. An opening in floor 2344 is engaged with a build module having an opening 2356, which build module houses a material bed (e.g., powder bed) 2357.

Portion 2360 shows an example of primary door 2361 shown from an interior of a processing chamber. In the example of portion 2360, lid assembly 2362 is disposed horizontally in a processing chamber having floor 2364. The processing chamber is equipped with lower gas ingress port 2366. The processing chamber comprises a side railing system. A layer dispensing mechanism (not shown) can be reversibly translated at least in party by using the side railing system, e.g., by being coupled with carriage 2367 disposed on a side railing system having covers such as cover 2378. The side railing system can couple (e.g., using carriage 2367) to a layer dispensing machines (not show) to dispense material bed 2377. The side railing system is disposed on a side wall of the processing chamber. An interior space of the processing chamber can be accessed (e.g., by a user) through access ports such as 2368. The access port can be equipped with a flexible material (e.g., rubber) that allows a user disposed in an ambient environment (outside the processing chamber) to manipulate component(s) in the internal space of the processing chamber, while maintaining separation of the user from an internal environment of the processing chamber, e.g., using a glove box type arrangement. The access ports can each be closed using a cover (e.g., flap) such as cover 2369. Primary door 2361 is equipped with windows such as 2350 (showing a portion of a window) through which the user standing outside of the processing chamber, can view the processing chamber interior. Lid assembly 2362 is coupled with mechanical arm 2371. Mechanical arm 2371 has a stopping portion 2363 shown in its bottom position. The mechanical arm can at least in part (e.g., by being coupled with torque hinge 2372) facilitate maneuvering lid assembly 2362 from a (e.g., substantially) horizontal position to a (e.g., substantially) vertical position, or any other position therebetween and along curved arrow 2373 designating the partial rotation, e.g., pivot. Torque hinge 2372 is coupled with sliding bar 2374 of a railing assembly that extends into a casing and through casing opening 2375. An opening in floor 2364 is engaged with a build module having an opening 2376, which build module houses a material bed (e.g., powder bed) 2377.

Portion 2380 shows an example of primary door 2381 shown from an interior of a processing chamber. In the example of portion 2380, lid assembly 2382 is disposed (e.g., substantially) horizontally in a processing chamber having floor 2384. The processing chamber is equipped with lower gas ingress port 2386. The processing chamber comprises a side railing system. A layer dispensing mechanism (not shown) can be reversibly translated at least in party by using the side railing system, e.g., by being coupled with a carriage disposed on a side railing system having covers such as cover 2398. The side railing system can couple (e.g., using the carriage) to a layer dispensing machines (not show) to dispense material bed 2397. The side railing system is disposed on a side wall of the processing chamber. An interior space of the processing chamber can be accessed (e.g., by a user) through access ports such as 2388. The access port can be equipped with a flexible material (e.g., rubber) that allows a user disposed in an ambient environment (outside the processing chamber) to manipulate component(s) in the internal space of the processing chamber, while maintaining separation of the user from an internal environment of the processing chamber, e.g., using a glove box type arrangement. The access ports can each be closed using a cover (e.g., flap) such as cover 2389. Lid assembly 2382 is decoupled from mechanical arm 2391. Mechanical arm 2391 is coupled with torque hinge 2392 that is coupled with sliding bar 2394 of a railing assembly that extends into a casing and through casing opening 2395. An opening in floor 2384 is engaged with a build module having an opening 2396, which build module houses material bed (e.g., powder bed) 2397. Mechanical arm 2391 can slide in the direction 2383 into the opening 2395 of the casing, and into the casing, e.g., for storage. Mechanical arm in portion 2380 is shown in a vertical position, with its stopping portion 2384 being lifted to its top position.

In some embodiments, the lid assembly is maneuvered to close a top opening of a build module. Such closure of the build module may be required after printing of the 3D object, after removal of starting material for the 3D object, after removal of remainder material used to print 3D object(s), or any combination thereof. Closure of the build module with the lid assembly may be done fully manually, partially manually, or fully automatic such as using one or more controllers. The maneuver may be fully manual, partially manual, and partially automatic, or fully automatic. In some embodiments, the maneuver is fully manual. or fully automatic such as using one or more controllers. The one or more controllers can be any controller disclosed herein. The maneuver can be accomplished without disrupting the internal environment of the enclosure. The maneuver can be accomplished without exposing the internal environment of the enclosure to an ambient environment external to the enclosure. The maneuver may be done using a lid assembly that is disposed in the enclosure. The enclosure may comprise (i) a chamber (ii) a build module, or (iii) the build module and the chamber. The chamber may comprise a processing chamber or an unpacking chamber. The maneuver can be accomplished without exposing the starting material, the remainder material, and/or the 3D object, to the ambient environment. The maneuver may comprise (a) engaging engagers of the lid assembly with respective top openings of engager receptables disposed in a rim of the build module; (b) causing the engagers to pivot into respective portions of the engager receptacles having covered top; (c) compress a seal in the lid assembly at least in part by pivoting a first portion of the lid assembly with respect to a second portion of the lid assembly, the seal being disposed between the first portion of the lid assembly and the second portion of the lid assembly; or (d) any combination of (a)-(c). The maneuver may initiate with a lid assembly that is decoupled from a mechanical arm. The maneuver may comprise using handles to place the lid assembly (e.g., manually) on the top opening of the build module. The handles may or may not be collapsible. The handles may swivel about an axis. The handles may each be connected to the lid assembly using a hinge. The handles by be configured to allow the lid assembly to reversibly exit and enter an interior space of the casing. The handles by be configured to allow the lid assembly to be stored in the casing in a manner sufficient to allow operation in a chamber that are not associated with (e.g., not related to, or do not require) the lid assembly, e.g., beam alignment, deposition of pre-transformed material, removal of pre-transformed material, unpacking three-dimensional object(s) from a build module, and/or three-dimensional printing. The first portion of the lid assembly may be a locking plate. The second portion of the lid assembly may be a lid base plate.

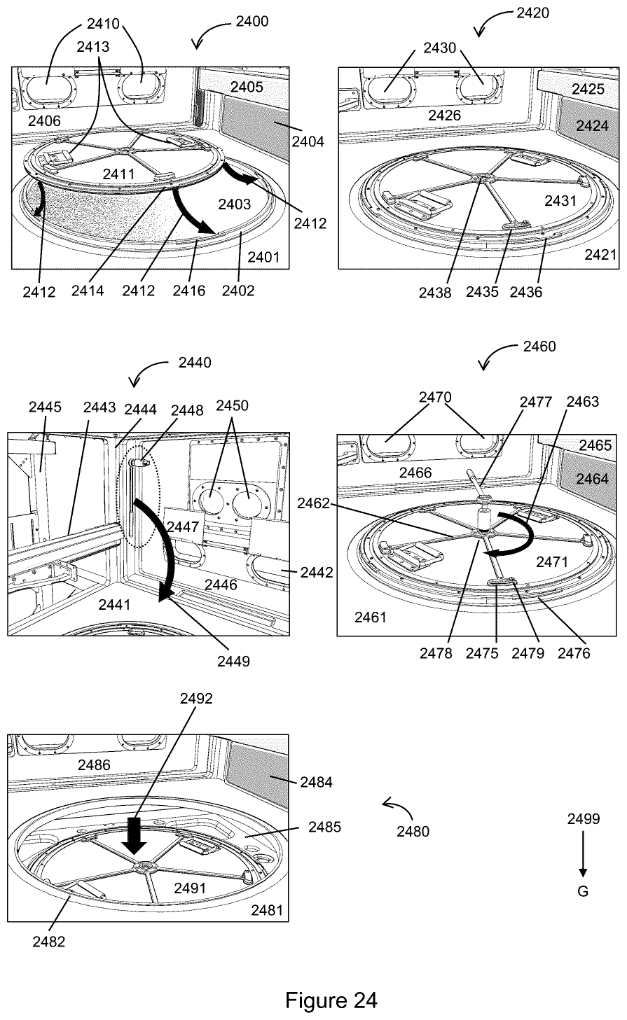

FIG. 24 shows an example of various portions of a 3D printing system shown with respect to gravitational vector 2499 pointing towards the gravitational center of the ambient environment external to the 3D printer. Portions 2400, 2420, 2440, 2460, and 2480 each show the processing chamber interior, in a direction that generally faces a primary door of the processing chamber.

Portion 2400 shows an example of a processing chamber portion having floor 2401 having a hole engaged with a build module having wall 2402. Material (e.g., powder) bed 2403 is disposed in the build module. The processing chamber has a lower gas ingress port 2404 on a side wall having a railing system including cover 2405. The side railing system can facilitate at least in part translation of a layer dispensing mechanism (not shown) that generates material bed 2403. The processing chamber includes primary door 2406 that comprises two viewing windows 2410. A lid assembly 2411 is positioned substantially horizontally in the processing chamber. The lid assembly can be lowered to close the opening of the build module. The lid assembly can be lowered along arrows 2412. The lid assembly can be lowered by a user (e.g., manually) at least in part by using handles 2413. Lid assembly 2411 includes a locking ring having engagers in the form of protrusions (e.g., latches, or tabs) such as 2414, the protrusions pointing away from the center of the lid assembly. Build module 2402 includes engager receptables such as 2416. Lid assembly 2411 can be lowered to a position in which its engagers are coupled with the receptables. Such coupling can take place at least in part by lowering lid assembly 2411 along arrows 2412.

Portion 2420 shows an example of a processing chamber portion having floor 2421 having a hole engaged with a build module having an opening along which engager receptacles are disposed, such as engager receptable 2436. The processing chamber has a lower gas ingress port 2424 on a side wall having a railing system including cover 2425. The processing chamber includes primary door 2426 that comprises two viewing windows 2430. A lid assembly 2431 is positioned (e.g., substantially) horizontally to close a top opening of the build module. Lid assembly 2431 can be secured to the build module at least in part by pressing a seal example that is an O-ring (now shown) disposed between the lid assembly and the build module, e.g., by engaging a rotating tool (e.g., a drive spinner such as a ratchet) at a center 2438 of lid assembly 2431. Lid assembly 2431 has five distal openings such as 2435, each having a guiding post, e.g., to guide movement of a locking plate of the lid assembly facing the interior of the processing chamber and having an exposed surface being exposed to the internal space of the processing chamber. The processing chamber has floor 2421 comprising a hole in which the build module opening (e.g., port) and the lid assembly are disposed in the example of portion 2420.

Portion 2440 shows an example of a processing chamber portion having floor 2441. The processing chamber includes primary door 2446 that comprises two viewing windows 2450. An interior space of the processing chamber can be accessed (e.g., by a user) through access ports such as 2442, the access ports being disposed in primary door 2446. The access port can be equipped with a flexible material (e.g., rubber) that allows a user disposed in an ambient environment (outside the processing chamber) to manipulate component(s) in the internal space of the processing chamber, while maintaining separation of the user from an internal environment of the processing chamber, e.g., using a glove box type arrangement. The access ports can each be closed using a cover (e.g., flap) such as cover 2447. The processing chamber includes side railing 2443. A layer dispensing mechanism may reversibly translate along the side railing, e.g., to dispense a material bed. The processing chamber comprises framing 2444. The processing chamber (including its framing) is supported by external framing 2445. A rotating tool (e.g., drive spinner such as a ratchet) 2448 is hanging on a side of primary door 2446. The rotating tool can be utilized to fasten the lid assembly to the build module, e.g., to shut and/or seal the build module. For example, the rotating tool can be lowed along arrow 2449.

Portion 2460 shows an example of a processing chamber portion having floor 2461 comprising a hole engaged with a build module having an opening along which engager receptacles are disposed, such as engager receptable 2476. The processing chamber has a lower gas ingress port 2464 on a side wall having a railing system including cover 2465. The processing chamber includes primary door 2466 that comprises two viewing windows 2470. A lid assembly 2471 is positioned (e.g., substantially) horizontally to close a top opening (e.g., port) of the build module. Lid assembly 2471 can be secured to the build module at least in part by pressing a seal (now shown) disposed between the lid assembly and the build module, e.g., at least in part by engaging rotating tool 2477 (e.g., a drive spinner such as a ratchet) at a center 2478 of the lid assembly 2471 along rotational direction 2463. Lid assembly 2471 comprises five distal openings such as 2475, each having a guiding post such as 2479, e.g., to guide movement of a locking plate of the lid assembly facing the interior of the processing chamber and having an exposed surface being exposed to the internal space of the processing chamber. Five skeletal posts such as 2462 are spaced equally on a top surface of the lid assembly, each skeletal post spanning a distance from a central area of the lid assembly to the distal opening. The central area of the lid assembly can be configured to accommodate the rotating tool and/or the lock pin. The processing chamber has floor 2421 comprising a hole in which the build module opening and the lid assembly are disposed in the example of portion 2420. The opening may be referred to as a port.

Portion 2480 shows an example of a processing chamber portion having floor 2481 comprising hole 2482. The processing chamber has a lower gas ingress port 2484 on a side wall. The processing chamber includes primary door 2486. Lid assembly 2491 closes a top opening of a build module engaged with platform 2485. The closed build module with the lid assembly and the platform are disposed lower than floor 2481 of the processing chamber. After closing (e.g., shutting) the build module with the lid assembly, the closed build module can be separated from the processing chamber, lowered (e.g., in a direction along 2492) and maneuvered away from the processing chamber. maneuvering away from the processing chamber can be to a storage location or to an unpacking station.

In some embodiments, the removed pre-transformed material (e.g., the remainder) is conditioned to be used in the 3D printing process. The remainder may be recycled and used in the 3D printing process. The unpacking station may further comprise a unit that allows conditioning of the pre-transformed material that was removed from the 3D object. Conditioning may comprise sieving of the pre-transformed material that was removed from the 3D object. Conditioning may be to allow recycling of the pre-transformed material and usage in a 3D printing cycle. Conditioning may be chemical conditioning (e.g., removal of oxide layer). Conditioning may be physical conditioning (e.g., such as sieving, e.g., removal of transformed material).

In some embodiments, the 3D printing system comprises a recycling mechanism. The recycling mechanism may be housed in a modular chamber and form the recycling module. The recycling module may comprise a pump, or a (e.g., physical, and/or chemical) conditioning mechanism. Physical conditioning may comprise a sieve. The recycling module may be operatively coupled with at least one of (i) the processing chamber (e.g., to the layer dispensing mechanism such as to the material dispensing mechanism) and (ii) the unpacking station. For example, the same recycling module may be coupled with (i) the processing and (ii) the unpacking station. For example, a first recycling module may be coupled with the processing chamber and a second (e.g., different) recycling module may be coupled with the unpacking station. Coupled may be physically connected. The recycling module may be reversibly coupled. The recycling module can be extracted and/or exchanged from the (i) the processing and/or (ii) the unpacking station before, during, or after the 3D printing.

In some examples, while the build module (housing the 3D object) travels outside of the 3D printer enclosure (e.g., between the 3D printer enclosure and the unpacking station enclosure), the build module is sealed. Sealing may be sufficient to maintain the atmosphere within the build module. Sealing may be sufficient to prevent influence of the atmosphere outside of the build module to the atmosphere within the build module. Sealing may be sufficient to prevent exposure of the pre-transformed material (e.g., powder) to reactive atmosphere. Sealing may be sufficient to prevent leakage of the pre-transformed material from the build module. Sufficient may be in the time scale in which the build module transfers from one enclosure to another (e.g., through an ambient atmosphere). Sufficient may be to maintain 3D object surface requirements. Sufficient may be to maintain safety requirements prevailing in the jurisdiction.

Examples. The following are illustrative and non-limiting examples of methods of the present disclosure.

Example 1: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 600 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen as at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with eight optical windows made of sapphire in a configuration similar to the one depicted in FIG. 6, e.g., 695. Each laser beam was guided by an optical setup in an optical system enclosure, the optical system enclosure disposed above the processing chamber, the optical chamber comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. A user was able to view the laser beams during printing using a rectangular viewing window assembly that was tilted with respect to the floor of the processing chamber. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater. After the printing, the build module was closed using a lid assembly, employing a mechanism similar to the one depicted in FIG. 20, using procedure similar to the one depicted in FIGS. 23 and 24. The build module was separated from the processing chamber and transited (e.g., moved) for unpacking in an unpacking station separate from the 3D printer.

While preferred embodiments of the present invention have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. A device for maneuvering a lid assembly, the device comprising:
a mechanical arm configured to reversibly couple with the lid assembly;
a first connector configured to connect to the mechanical arm to (I) reversibly pivot the mechanical arm about a first axis, and (II) reversibly pivot the mechanical arm about a second axis;
a second connector coupled with the mechanical arm, the second connector being configured to reversibly couple and uncouple the mechanical arm and the lid assembly; and
a translation mechanism configured to operatively couple to the first connector to reversibly translate the mechanical arm along a direction,
the device being configured to:
(A) facilitate closing an opening at least in part by engaging the lid assembly with the opening, the opening being of a build module of a three-dimensional printer, the build module configured to accommodate at least one three-dimensional object during the printing;
(B) facilitate closing the opening in an enclosure having an internal environment different from an ambient environment external to the enclosure, the enclosure comprising (i) a processing chamber of the three-dimensional printer or (ii) an unpacking chamber configured to unpack the at least one three-dimensional object from the build module, or
(C) a combination of (A) and (B).

2. The device of claim 1, wherein the internal environment is different from the ambient environment external to the enclosure by at least one environmental characteristic comprising an internal pressure of the internal environment, or an internal environment composition of the internal environment; and optionally wherein (I) the internal pressure is a positive pressure relative to an ambient pressure of the ambient environment, (II) the internal environment composition comprises a lower level of reactive agent relative to the ambient environment, (III) a higher concentration of debris relative to the ambient environment, or (IV) any combination of (I) (II) or (III).

3. The device of claim 1, wherein the mechanical arm comprises a stopping portion configured to limit an extent of pivoting the mechanical arm about the first axis, the stopping portion being configured to limit the extent of pivoting the mechanical arm about the first axis at least in part by being configured to contact a floor of a chamber, the enclosure comprising the chamber.

4. The device of claim 1, wherein the first connector is configured to pivot along the first axis and along the second axis, the first connector being configured to generate friction to provide resistance to prevent the mechanical arm from pivoting unwantedly at least about the second axis.

5. The device of claim 1, wherein the first axis is perpendicular, or substantially perpendicular, to the second axis.

6. The device of claim 1, wherein the first connector (I) comprises bearing configured to facilitate pivoting the mechanical arm about the first axis, the bearing comprising a circular bearing, (II) is configured to pivot the mechanical arm about the second axis to cause the mechanical arm to translate from a vertical position or from a substantially vertical position, toward or to, a horizontal position, (III) comprises a hinge comprising a torque hinge, or (V) any combination of (I) (II) (III) and (IV).

7. The device of claim 1, wherein the second connector (I) is configured to reversibly alter its configuration to couple and to decouple the lid assembly and the mechanical arm, (II) can reversibly alter its configuration at least in part by being configured (i) to latch to the lid assembly and (ii) to be released from the lid assembly.

8. The device of claim 1, wherein the second connector is configured to reversibly alter its configuration at least in part by being configured to (i) pivot in a first direction and in a second direction opposing the first direction and/or (ii) compress in a third direction and release in a fourth direction opposing the first direction.

9. The device of claim 1, wherein the translation mechanism comprises a railing system, and wherein a cover is configured to fasten the translation mechanism to a casing comprised in, or being operatively coupled with, the enclosure.

10. The device of claim 9, wherein the direction extends from an interior of the casing to an exterior of the casing, through an opening of the casing, the exterior of the casing comprising a floor of the enclosure; and optionally the casing is operatively coupled with a door of the enclosure.

11. The device of claim 9, wherein the translation mechanism is configured to reversibly translate at least one component through an opening of the casing, the at least one component comprising the mechanical arm, the lid assembly, or a portion of the translation mechanism; and optionally the casing is operatively coupled with a door of the enclosure.

12. The device of claim 9, wherein the translation mechanism is configured to reversibly translate at least one component out of the casing, and inwards towards an internal space of the casing, the at least one component comprising (a) the mechanical arm, (b) the lid assembly, or (c) a portion of the translation mechanism; and optionally the casing is operatively coupled with a door of the enclosure.

13. The device of claim 9, wherein the cover is configured to shield one or more other components of the translation mechanism from gas borne material in the environment in which the translation mechanism is configured to operate; and optionally the casing is operatively coupled with a door of the enclosure.

14. The device of claim 9, wherein the translation mechanism in its contracted state is at least in part disposed in the casing; and optionally the casing is operatively coupled with a door of the enclosure.

15. The device of claim 1, wherein the translation mechanism is configured to operate using a force source, the force source comprising (i) an electric force source, (ii) a pneumatic force source, (iii) a hydraulic force source, (iv) a magnetic force source, or (v) a mechanical force source.

16. The device of claim 1, wherein the device is configured to facilitate maneuvering the lid assembly to close the opening of the build module in the internal environment of the enclosure; and wherein at least a portion of the device is configured to operate in the internal environment, the at least a portion of the device comprising the mechanical arm, the first connector, and at least a portion of the translation mechanism.

17. A method of maneuvering the lid assembly, the method comprising: (a) providing the device of claim 1, and (b) using the device to maneuver the lid assembly in the enclosure.

18. A method of servicing, the method comprising: (a) providing the device in claim 1; and (b) performing one or more operations associated with the device; optionally wherein the one or more operations comprise (i) coupling the translation mechanism with a casing comprised in, or operatively coupled with, the enclosure, the casing being configure to accommodate at least in part the mechanical arm and being configured to accommodate at least in part the lid, (ii) coupling the lid assembly with the mechanical arm, or (iii) servicing the device; and optionally wherein selected operations are executed in the enclosure, the selected operations or of the one or more operations, the selected operations comprising (i) or (ii).

19. An apparatus for maneuvering the lid assembly, the apparatus comprising at least one controller configured to (i) operatively couple to the device of claim 1, and (ii) control, or direct control of, one or more operations associated with the device, the at least one controller being configured to connect to a power source; optionally wherein the one or more operations comprise (i) coupling the translation mechanism with a casing comprised in, or operatively coupled with, the enclosure, the casing being configured to accommodate at least in part the mechanical arm and being configured to accommodate at least in part the lid, (ii) coupling the lid assembly with the mechanical arm, or (iii) servicing the device; and optionally wherein selected operations are executed in the enclosure, the selected operations or of the one or more operations, the selected operations comprising (i) or (ii).

20. Non-transitory computer readable program instructions, the program instructions, when read by one or more processors operatively coupled with the device of claim 1, cause the one or more processors to execute, or direct execution of, one or more operations associated with the device, the program instructions are inscribed in one or more media; optionally wherein the one or more operations comprise (i) coupling the translation mechanism with a casing comprised in, or operatively coupled with, the enclosure, the casing being configured to accommodate at least in part the mechanical arm and being configure to accommodate at least in part the lid, (ii) coupling the lid assembly with the mechanical arm, or (iii) servicing the device; and optionally wherein selected operations are executed in the enclosure, the selected operations or of the one or more operations, the selected operations comprising (i) or (ii).
